(19) United States
(12) Patent Application Publication
(10) Pub. No.: US 2012/0208119 A1
(43) Pub. Date: Aug. 16, 2012

(54) TONER FOR ELECTROPHOTOGRAPHY AND TONER SET

(75) Inventors: Ryohei Iwamoto, Hachioji-shi (JP); Kimihiko Ookubo, Hachioji-shi (JP)

(73) Assignee: KONICA MINOLTA BUSINESS TECHNOLOGIES, INC., Tokyo (JP)

(21) Appl. No.: 13/503,484

(22) PCT Filed: Oct. 25, 2010
(86) PCT No.: PCT/JP2010/068819

§ 371 Date: Apr. 23, 2012

Related U.S. Application Data
(66) Substitute for application No. PCT/JP2010/068819, filed on Oct. 25, 2010.

(30) Foreign Application Priority Data
Nov. 5, 2009 (JP) 2009-253808

(51) Int. Cl. G03G 9/16; C09B 47/00; C09B 47/30

(52) U.S. Cl. 430/108.21; 540/128; 540/127; 540/121

(57) ABSTRACT

A toner for electrophotography characterized in that, when a monochromatic image of the toner for electrophotography is formed and the reflection absorption spectrum thereof is measured, said reflection absorption spectrum shows a maximum density within a range of 600-700 nm, and, excluding the light absorption by a substrate, the maximum density (Dm) of said reflection absorption spectrum, the density thereof at 570 nm (D(570)) and the density thereof at 530 nm (D(530)) satisfy the following requirements, and a toner set for electrophotography: 1.4≦Dm≦3.5, D(570)≧0.55 and 4.5≦D(570)/D(530)≦12.

### TECHNICAL FIELD

The present invention related to a toner for electrophotography exhibiting excellent color reproducibility and durability, and to a toner set.

### BACK GROUND ART

Recently, color copying was put to practical use, in which electrostatic latent images of an original image are formed through spectral light exposure and are developed with an individual color toner, thereby respective color copy images are superimposed to obtain a full color copy image. As color toners used therein, there are manufactured color toners of yellow, magenta, cyan and the like, formed of an individual colorant and/or dye dispersed in a binder resin.

According to the wide spread of apparatuses for electrophotographic color image formation, their use has also been variously spread in various ways. Demand for the quality of such apparatus has also becoming hard. When copying common photographs, catalogues or maps, high resolution and faithful reproduction even to a minute portion of the image is desired. Accompanying with this, demand for vividness of color has also become higher, whereby expansion of the range of color reproduction has been desired. Specifically, resolution as high as or higher than that of printing has come to be required in the field of electrophotography.

Commonly known organic pigments and dyes have been used as colorants used for electrophotographic toners but they exhibit various defects.

For instance, organic pigments, compared to oil-soluble dyes, are generally superior in heat resistance and light resistance, however, since a pigment exists in a toner in the form of a particle dispersion, covering power is enhanced, and transparency is lower. Dispersibility of a pigment is generally poor so that transparency is vitiated and chroma is lowered, resulting in deteriorated color reproduction of images. To make it possible to visually recognize color of the lowest layer of overlaid toner layers without being concealed by upper toner layers, transparency of a fixed toner is required, and dispersibility or coloring power of a coloring agent is needed to maintain color reproducibility of the original image.

To overcome the defect of a pigments as described above, there has been proposed, for example, a means to enhance transparency by attaining a pigment dispersion diameter of the sub-micrometer order corresponding to a primary particles diameter without forming aggregated secondary particles, via a flashing method as a means for dispersing a pigment. or a means to improve an electrostatic-charging property, fixability and image uniformity by covering pigment particles with a binding resin or a shelling resin (for example, refer to Patent Documents 1 and 2).

However, even when an image is output using a toner proposed as above, it is still difficult for a toner in which only a pigment is used to obtain sufficient color hue and transparency.

Although, in a color image forming apparatus, in principle, all colors can be reproduced via subtractive color mixing of three primary colors of yellow, magenta and cyan, in practice, the color reproducible range and the chroma are reduced by the spectroscopic property when a pigment is dispersed in a thermoplastic resin, or a color mixing nature when toners of different colors are juxtaposed. Accordingly, there are still many problems remained to faithfully reproduce the color of an original image.

For a full color image, it is necessary to obtain a well balanced color hue since the color is formed by juxtaposing two or more color toners. Therefore, for example, a color toner set in which the pigment of each color of yellow, magenta and cyan and the content thereof are appropriately selected (for example, refer to Patent Document 3). Also proposed has been a method in which an image is obtained by forming a solid image portion with a toner having a dark color (a dark color) and forming a high-light portion with a toner having a lighter color (a lighter toner, for example, refer to Patent Document 4).

However, even if these methods are used, the color reproduction nature at the time of mixed colors is still inadequate.

Further, as a specific problem which occurs when toners of each color are mixed but when a single toner is used, for example, when a magenta toner and a cyan toner is mixed, the light resistance may be deteriorated. This is caused by the transfer of the light energy absorbed by the magenta toner to the cyan toner. In general, this problem tends not occur when a phthalocyanine pigment is used as a cyan pigment due to its high light resistant nature. However, a phthalocyanine pigment has a poor ozone resistance. Accordingly, it is difficult to be compatible with respect to the light resistance and the ozone resistance when a printed substance is obtained by mixing a magenta toner and a cyane toner. Thus, development of a toner set which meets both the natures has been desired.

As a phthalocyanine colorant, copper phthalocyanine pigment has been widely used. A toner using such a copper phthalocyanine pigment is versatile and exhibit superior light stability, however, it shows an increased base line on the longer wavelength side of a reflection spectrum of the image and tends to form color images with slight color contamination. Therefore, such copper phthalocyanine pigments have been regarded not to be suitable for image formation demanding high color reproduction, as typified by prints of company logos.

Accordingly, there has been studied development of a toner not causing color contamination via improvement of a copper phthalocyanine pigment (for example, refer to Patent Documents 5 and 6), however, it did not result in sufficient reduction of color contamination.

A toner using a pigment such as a copper phthalocyanine pigment exhibits versatility achieving image quality at the level of images prepared in printing inks but were difficult to attain a hue angle suited for color reproduction of photographic images. Accordingly, there were studied toners containing a colorant capable of achieving a hue angle suitable for color reproduction of a photographic image, instead of a copper phthalocyanine colorant (for example, refer to Patent Document 7).

Specifically, in recent years, demands to print an image on a display device have been rapidly expanded in the cases of image processing of a picture on a CRT display or a liquid crystal display, electronic data input, or a personal use. In such fields, a toner set which enables excellent correspondence to sRGB which is a standard color space in the field concerned (for example, refer to Non-Patent Document 1) and high color reproducibility.

A method to replace C. I pigment blue 15.3 which has been conventionally used with zinc phthalocyanine has been proposed (for example, refer to Patent Document 8). However, since the transparency of the image provided by the zinc phthalocyanine concerned is inadequate, it cannot be avoided to say that its color reproducibility is inadequate. Accordingly, improvement in color reproducibility, specifically improvement in chrome under a mixed color condition which results in improvement in color reproducibility under a low brilliance condition has been desired.

### PRIOR ART DOCUMENTS

### Patent Documents

Patent Document 1: Japanese Patent Application Publication Open to Public Inspection (hereafter referred to as JP-A) No. 9-26673
Patent Document 2: JP-A No. 11-160914
Patent Document 3: JP-A No. 2004-126248
Patent Document 4: JP-A No. 2000-347476
Patent Document 5: JP-A No. 2005-215013
Patent Document 6: JP-A No. 2005-220253
Patent Document 7: JP-A No. 2006-63171
Patent Document 8: JP-A No. 2003-302792

### Non-Patent Document

Multimedia Systems and Equipment-Colour Measurement and Management-Part 2-1: Color Management-Default RGB Colour Space-sRGB IEC 61966-2-1

### SUMMARY OF THE INVENTION

### Problems to be Solved by the Invention

In view of the foregoing problems, the present invention was achieved. An object of the present invention is to provide a toner set for electrophotography which enables an excellent correspondence to sRGB of the image when a display image of a CRT display device or a liquid crystal display device is printed, and enables high color reproducibility even in a low luminance region by improving the chroma. A second object of the present invention is to provide a toner and a toner set for electrophotographic exhibiting an excellent color reproducibility, light resistance and ozone resistance when toners of each color are mixed.

### Means to Solve the Problems

The above objects of the present invention are achieved by the following structures.

1. An electrophotographic toner, wherein, when a monochromatic image of the toner is formed and reflection absorption spectrum of the monochromatic image is measured,

the reflection absorption spectrum shows a maximum density within a range of 600-700 nm, and

the maximum density (Dm) of the reflection absorption spectrum, a density thereof at 570 nm (D₍₅₇₀₎) and a density thereof at 530 nm (D₍₅₃₀₎) meet the following conditions, Dm, D₍₅₇₀₎ and D₍₅₃₀₎ each being determined by excluding light absorption of a substrate,

1.4≦Dm≦3.5

D₍₅₇₀₎≧0.55

4.5≦D₍₅₇₀₎/D₍₅₃₀₎≦12.

2. The electrophotographic toner of Item I comprising a silicon phthalocyanine compound as a colorant.
3. The electrophotographic toner of Item 2, wherein the silicon phthalocyanine compound is a compound represented by Formula (1),

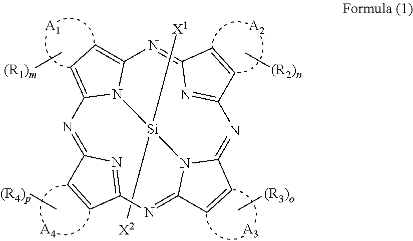

(In the formula, A₁, A₂, A₃ and A₄ each independently represent a 5-6 membered aromatic ring or a 5-6 membered heterocycle. R₁, R₂, R₃ and R₄ each independently represent a hydrogen atom, a halogen atom, an alkyl group, an alkenyl group, an alkynyl group, an aryl group, a heterocycle group, an acyl group, an alkoxycarbonyl group, an aryloxycarbonyl group, a carbamoyl group, a carboxy group or a salt thereof, a sulfonyl carbamoyl group, an acylcarbamoyl group, a sulfamoylcarbamoyl group, a carbamoyl group, an oxalyl group, an oxamoyl group, a cyano group, a thiocarbamoyl group, a hydroxy group, an alkoxy group, an aryl oxy group, a heterocycleoxy group, an acyloxy group, a carbonyloxy group, a carbamoyloxy group, a sulfonyloxy group, an amino group, an amino group, an acylamino group, a sulfonamide group, an ureido group, a thioureido group, an imido group, a carbonylamino group, a sulfamoylamino group, a semicarbazide group, a thiosemicarbazide group, a hydrazino group, an ammonio group, an oxamoilamino group, a sulfonylureido group, an acylureido group, an acylsulfamoylamino group, a nitro group, a mercapto group, a thio group, a sulfonyl group, a sulfinyl group, a sulfo group or a salt thereof a sulfamoyl group, an acylsulfamoyl group, a sulfonylsulfamoyl group and a salt thereof, or a group containing a phosphoric acid amide or a phosphoric acid ester structure. m, n, o and p each represent an integer of 1-4. X¹ and X² each independently represent an ether linkage, a halogen atom, a hydroxy group, an alkyl group, an alkynyl group, an alkoxy group, a siloxy group, an aryl group, an aryloxy group, an acyloxy group, a carbamoyloxy group, or a sulfamoyloxy group.

4. The electrophotographic toner of Item 2 or 3 comprising at least two colorants, wherein

one of the at least two colorants is a silicon phthalocyanine compound represented by above Formula (1).

5. A toner set for electrophotography comprising the electrophotographic toner of any one of Items 1-4.

### Effect of the Invention

The toner set of the present invention exhibits an excellent color hue adjusting property regardless of a manufacturing method of the toner when an image on a variety of display device is printed, and exhibits high color reproducibility specifically in a low luminance region.

Further, it exhibits an excellent color hue in a mixed color state, and has an excellent effect in light resistance and ozone resistance of the image.

### BRIEF DESCRIPTION OF THE DRAWINGS

FIG. 1 is a schematic figure illustrating an example of a tandem full color image forming apparatus which enables image formation via a two component developing method.

FIG. 2 is a schematic figure illustrating a 4-cycle full color image forming apparatus which enables image formation via a non-magnetic one component developing method.

FIG. 3 is a schematic figure illustrating an example of a “toner cartridge”.

FIG. 4 is a schematic figure illustrating an example of a belt fixing type fixing device employing a belt and a heating roller.

### EMBODIMENTS TO CARRYOUT THE INVENTION

As the results of intensive examinations in view of the foregoing problems, the present inventors have found that an electrophotographic toner exhibits an extremely excellent correspondence to sRGB when a silicon phthalocyanine compound is used as a colorant of a cyan toner and the cyan toner meets a necessary condition at a specific wavelength when a reflection density of the cyan toner is measured.

Best modes to carry out the present invention will be explained below, however, the present invention is not limited thereto.

The electrophotographic toner of the present invention is a cyan toner characterized in that the spectrum profile obtained when a monochromatic image of the toner is formed and a reflection density of the monochromatic image is measured shows a maximum density at a maximum absorption wavelength within a range of 600-700 nm in the visible light region.

Further, the maximum density (Dm) meets 1.4≦Dm≦3.5 and shows a high chromatic nature in the cyan toner coloring region.

The electrophotographic toner of the present invention is characterized in that, in the aforementioned spectrum profile, the density at 570 nm (D₍₅₇₀₎) is 0.55 or more, and a ratio of (D₍₅₇₀₎) and the density at 530 nm (D₍₅₃₀₎) meets 4.5≦(D₍₅₇₀₎)/(D₍₅₃₀₎)≦12.

By having these characteristics, the toner can realize a highly chromatic green together with a yellow toner having a high intensity. Also in the case when blue is realized together with a magenta toner exhibiting a relatively low intensity, a blue color exhibiting a high chroma can be realized, since dots of cyan toner do not hide the magenta image, because the cyan toner has an excellent transparency, and, sometimes, a blue color having a delicate tone can be obtained.

The toner of the present invention is characterized in that a silicon phthalocuanine compound is contained as a colorant in order to realize the aforementioned spectrum profile.

A silicon phthalocyanine compound has higher transparency and higher intensity when compared with currently often used copper phthalocyanine compound or zinc phthalocyanine compound, whereby color reproducibility of a toner image can be achieved from a high density portion to a low density portion.

The silicon phthalocyanine compound of the present invention is preferably a compound which has a structure represented by aforementioned Formula (1).

In Formula (1), examples of an aromatic ring or a heterocycle represented by A₁, A₂, A₃ and A₄ include a benzene ring, a naphthalene ring, a pyridine ring, a pyridazine ring, a pyrimidine ring, an imidazole ring and a pyrazole ring. Of these, a benzene ring and pyridine ring are preferably used, and most preferably used is a benzene ring.

In Formula (1), R₁-R₄ each independently represent a halogen atom (a fluorine atom, a chlorine atom, a bromine atom or a iodine atom), an alkyl group (including, for example, an aralkyl group, a cycloalkyl group and an activated methane group), an alkenyl group, an alkynyl group, an aryl group, a heterocycle group (the position to be substituted is not limited), a heterocycle group including a quatemarized nitrogen atom (for example, a pyridinio group, an imidazolio group a quinolinio group or a isoquinolinio group), an acyl group, an alkoxycarbonyl group, an aryloxycarbonyl group, a carbamoyl group, a carboxy group or a salt thereof, a sulfonylcarbamoyl group, an acylcarbamoyl group, a sulfamoylcarbarnoyl group, a carbazoyl group, an oxalyl group, an oxamoyl group, a cyano group, a thiocarbamoyl group, a hydroxy group, an alkoxy group (including a group which contains a repeat uniₜ of an ethyleneoxy group or a propyleneoxy group), an aryloxy group, a heterocycleoxy group, an acyloxy group, a (alkoxy or aryloxy) carbonyloxy group, a carbamoyloxy group, a sulfonyloxy group, an amino group, a (alkyl, aryl or heterocyclic) amino group, an acylamino group, a sulfonamide group, an ureido group, a thioureido group, an imido group, a (alkoxy or aryloxy) carbonylamino group, a sulfamoylamino group, a semicarbazide group, a thiosemicarbazide group, a hydrazino group, an ammonio group, an oxamoilamino group, a (alkyl or aryl) sulfonylureido group, an acylureido group, an acylsulfamoylamino group, a nitro group, a mercapto group, a (alkyl, aryl or heterocyclic) thio group, a (alkyl, aryl or heterocyclic) sulfonyl group, a (alkyl or aryl) sulfinyl group, a sulfo group or a salt thereof, a sulfamoyl group, an acylsulfamoyl group, a sulfonylsulfamoyl group and a salt thereof; a group containing a phosphoric acid amide or a phosphoric acid ester structure, a silyloxy-group (for example, trimethylsilyloxy and t-butyldimethylsilyloxy), and a silyl group (for example, trimethylsilyl, t-butyldimethylsilyl, or phenyldimethylsilyl).

As R₁-R₄, preferably used are a hydrogen atom, a halogen atom, an alkyl group, an aryl group, an alkoxy group, an aryloxy group, a nitro group, an alkylthio group and an arythio group, and more preferably used are a hydrogen atom, a chlorine atom, an alkyl atom, an alkoxy group and a nitro group.

In Formula (1), m, n, o and p are 0-4, preferably 0-2 and more preferably 0 or 1.

X¹ and X² each independently represent an ether linkage, a halogen atom, a hydroxy group, an alkyl group, an alkynyl group, an alkoxy group, a siloxy group, an aryl group, an aryloxy group, an acyloxy group, a carbamoyloxy group, or a sulfamoyloxy group. These groups may be substituted with a group represented by aforementioned R₁-R₄.

Examples of X₁ and X₂ include an alkyl group, an alkoxy group, a siloxy group, an aryloxy group, a carbamoyloxy group, and a sulfamoyloxy group, and more preferably include an alkoxy group, a siloxy group, a carbamoyloxy group, and a sulfamoyloxy group.

Also, X₁ and X₂ may be another molecule of a silicon phthalocyanine compound represented by Formula (1) through an ether bond to form a dimmer.

Concrete structures of a silicon phthalocyanine compound represented by Formula (1) will be shown below, however, the present invention is not limited thereto. Specifically, with respect to structural isomers due to the difference in the position of a substituent, only one example is shown, however, the present invention is not limited thereto.

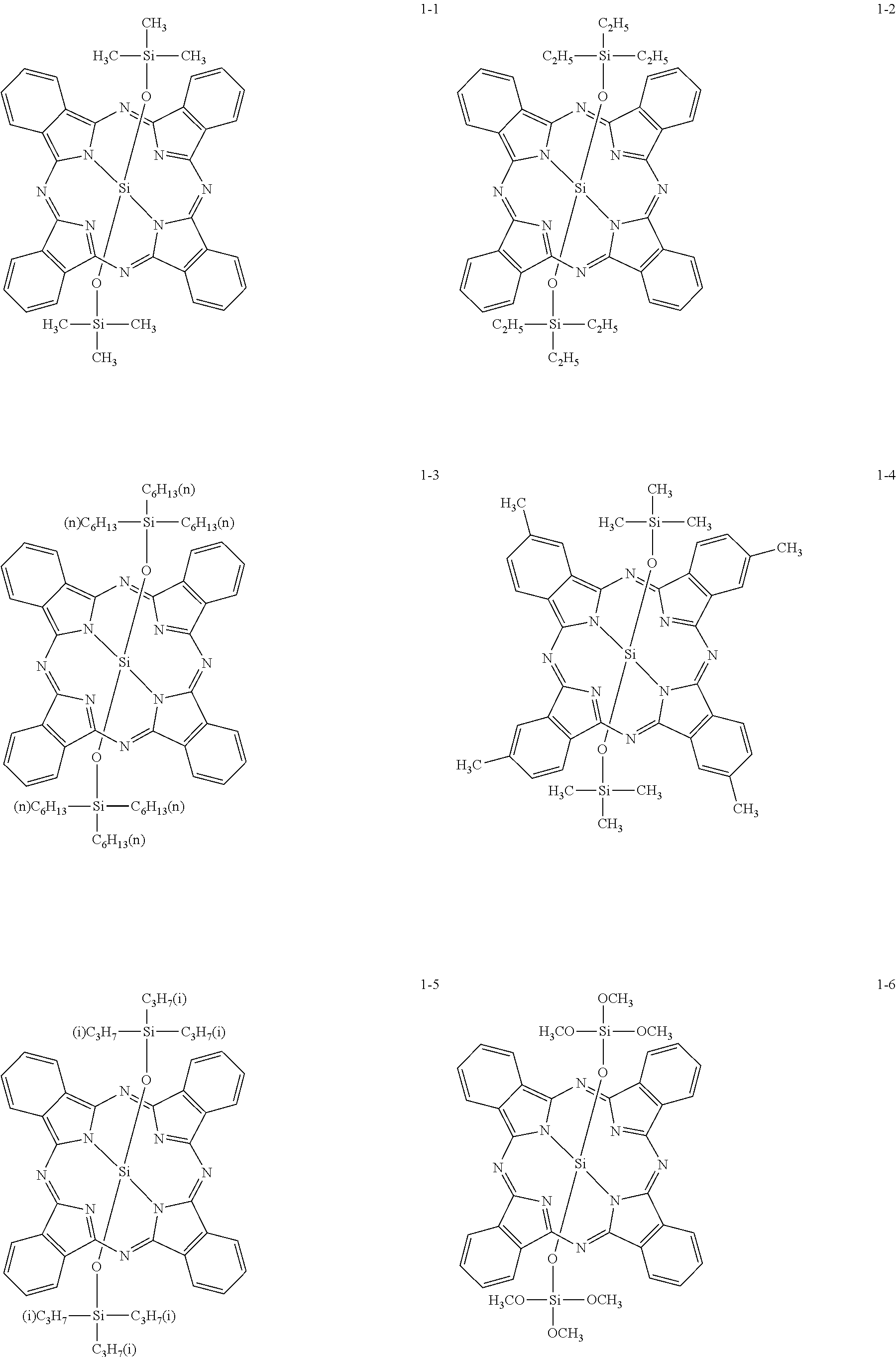

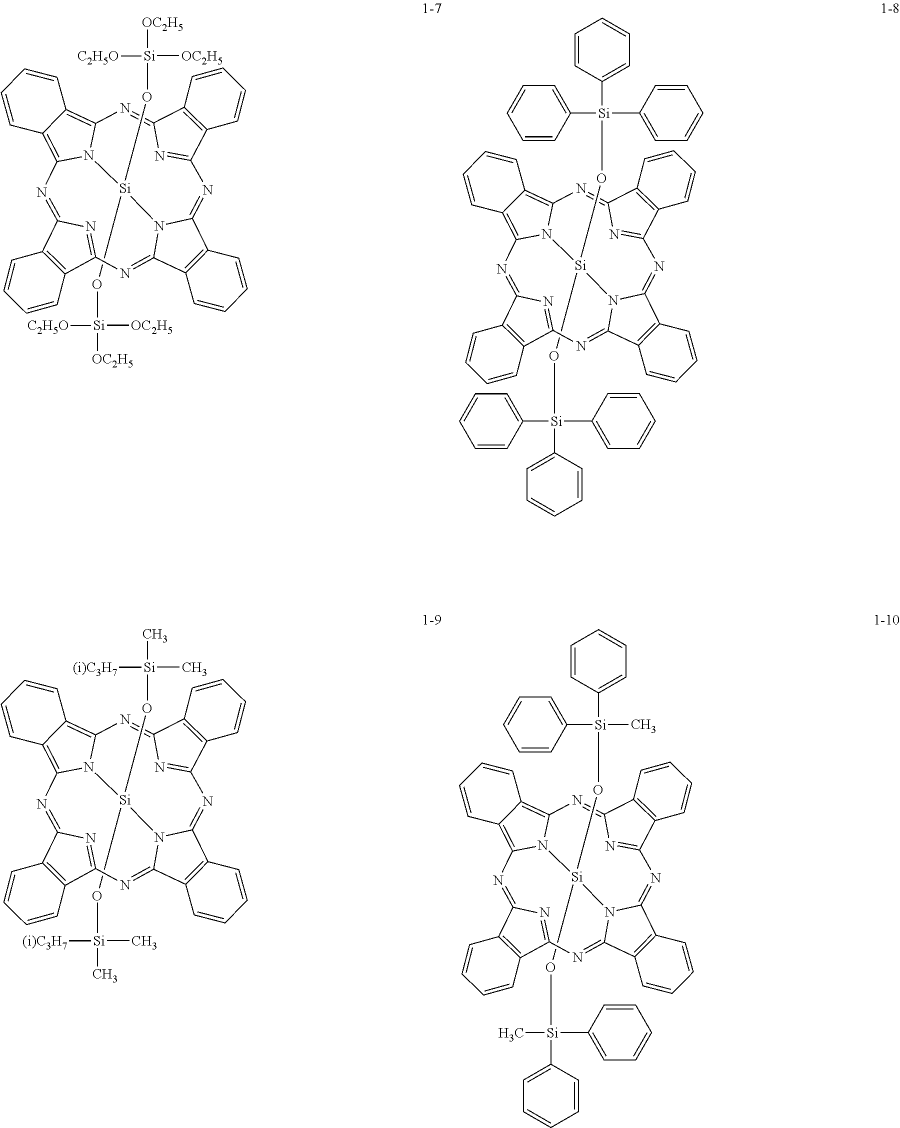

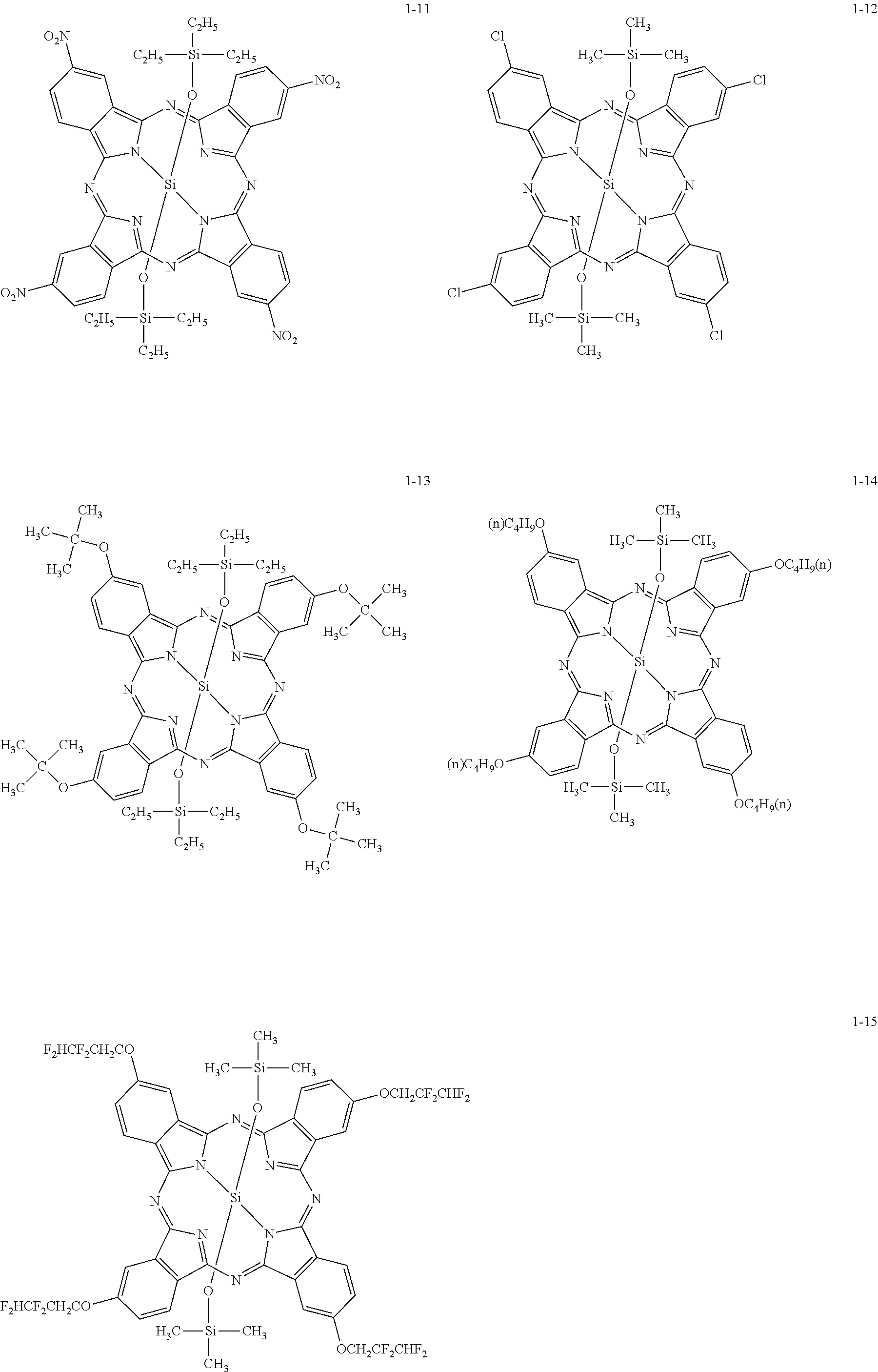

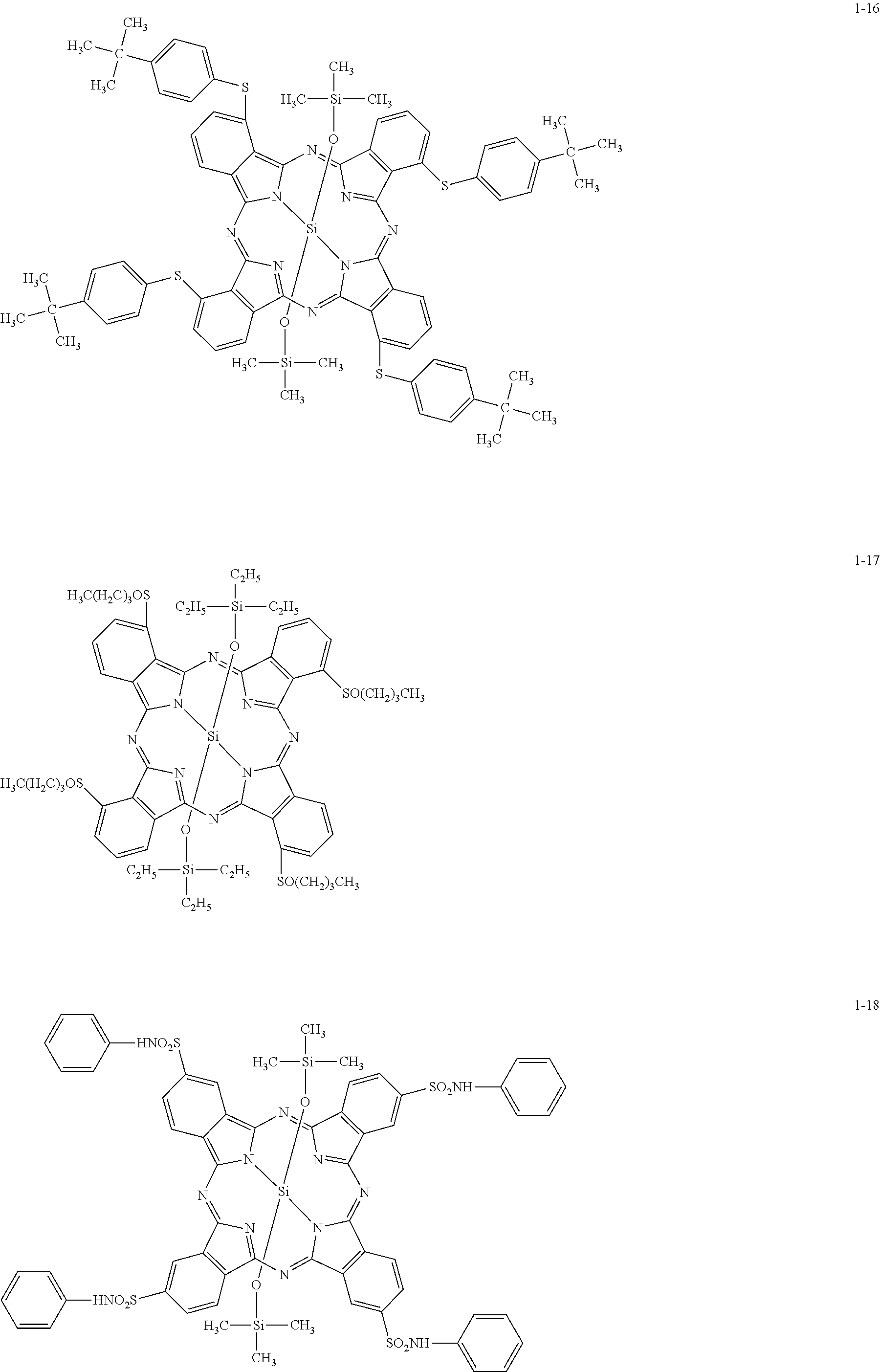

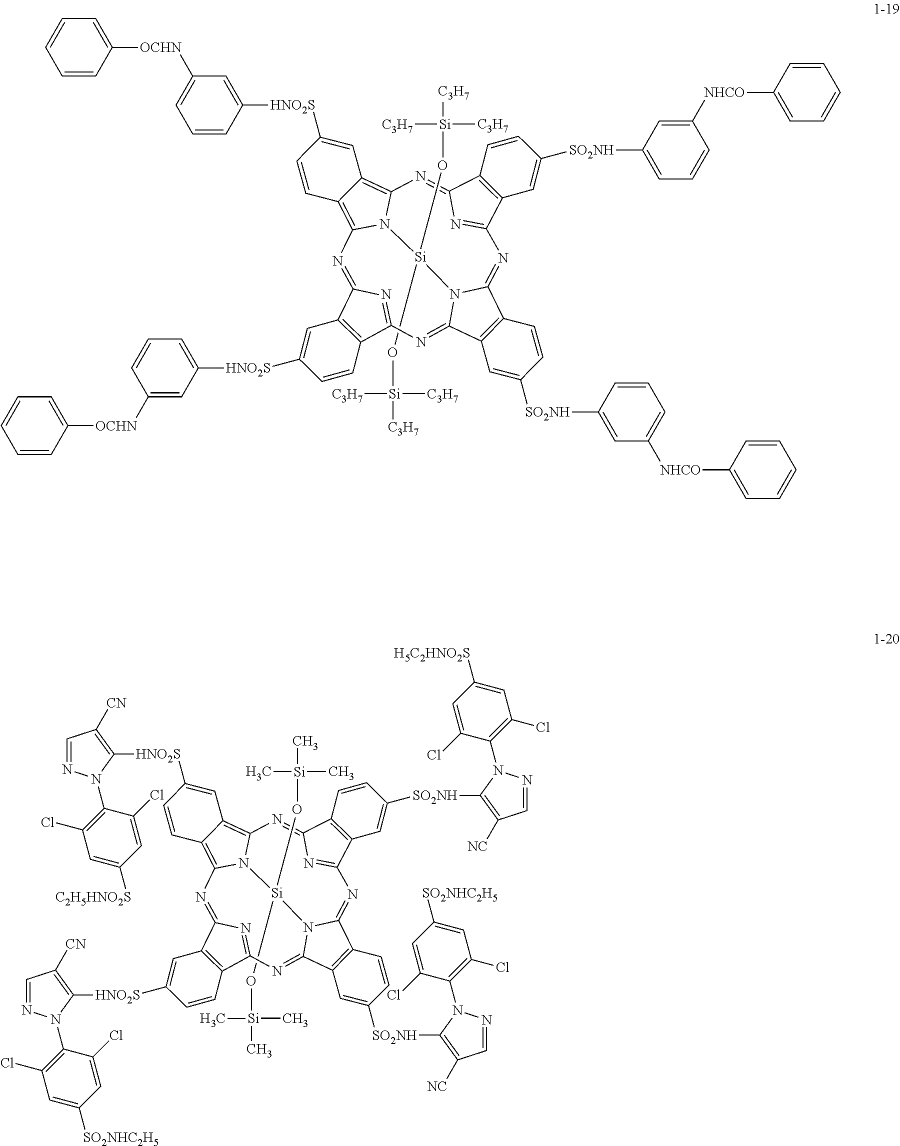

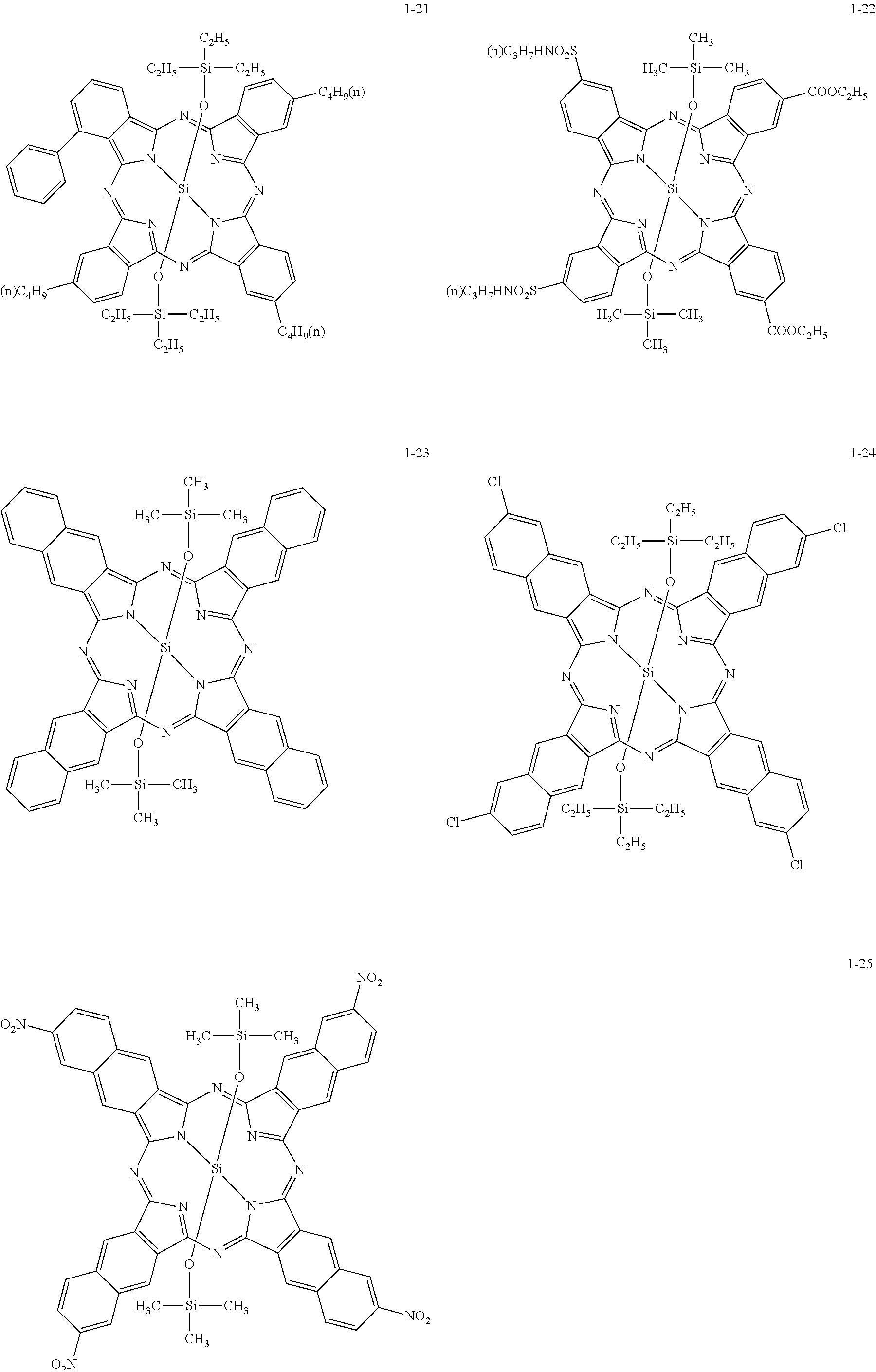

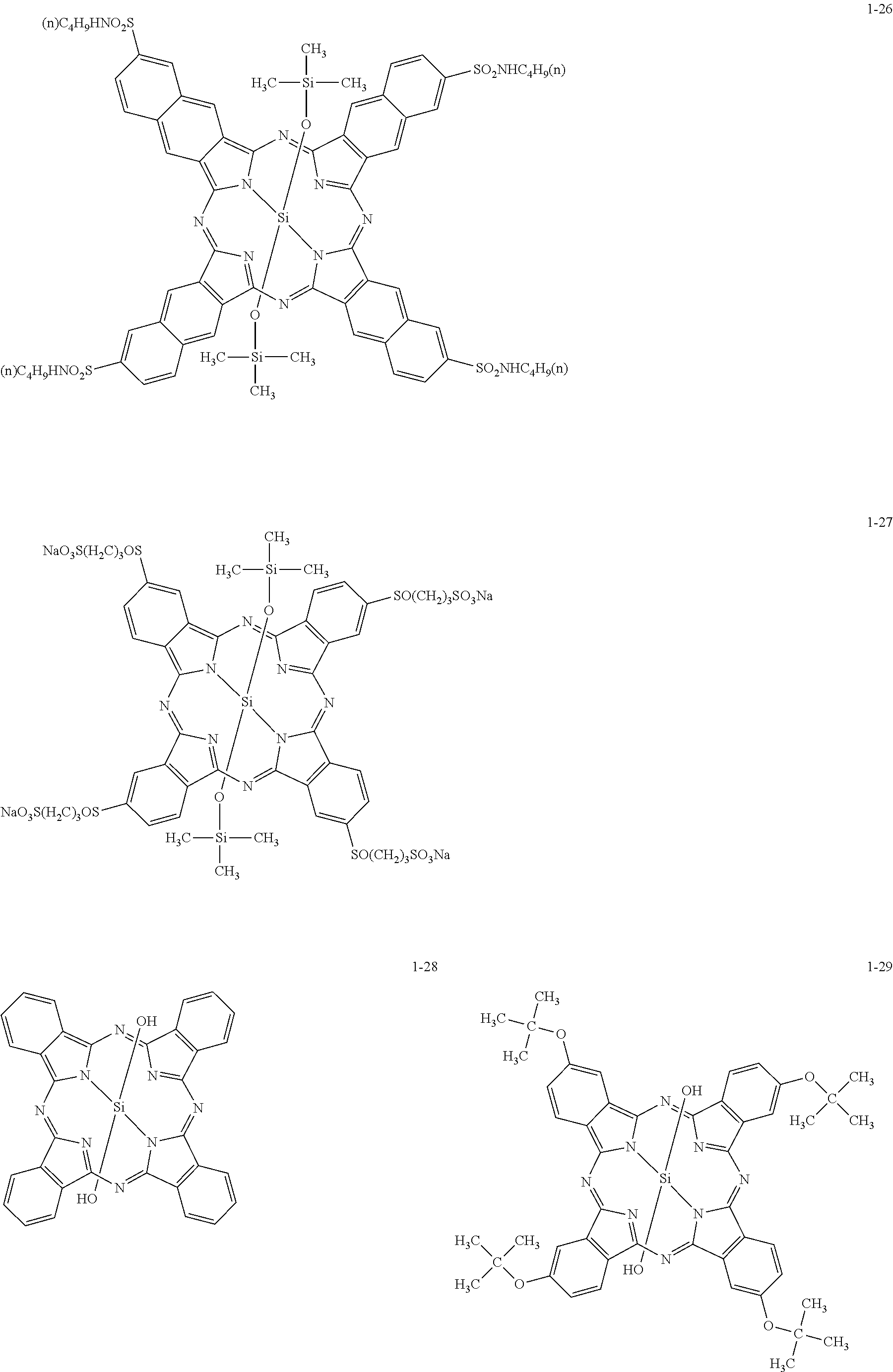

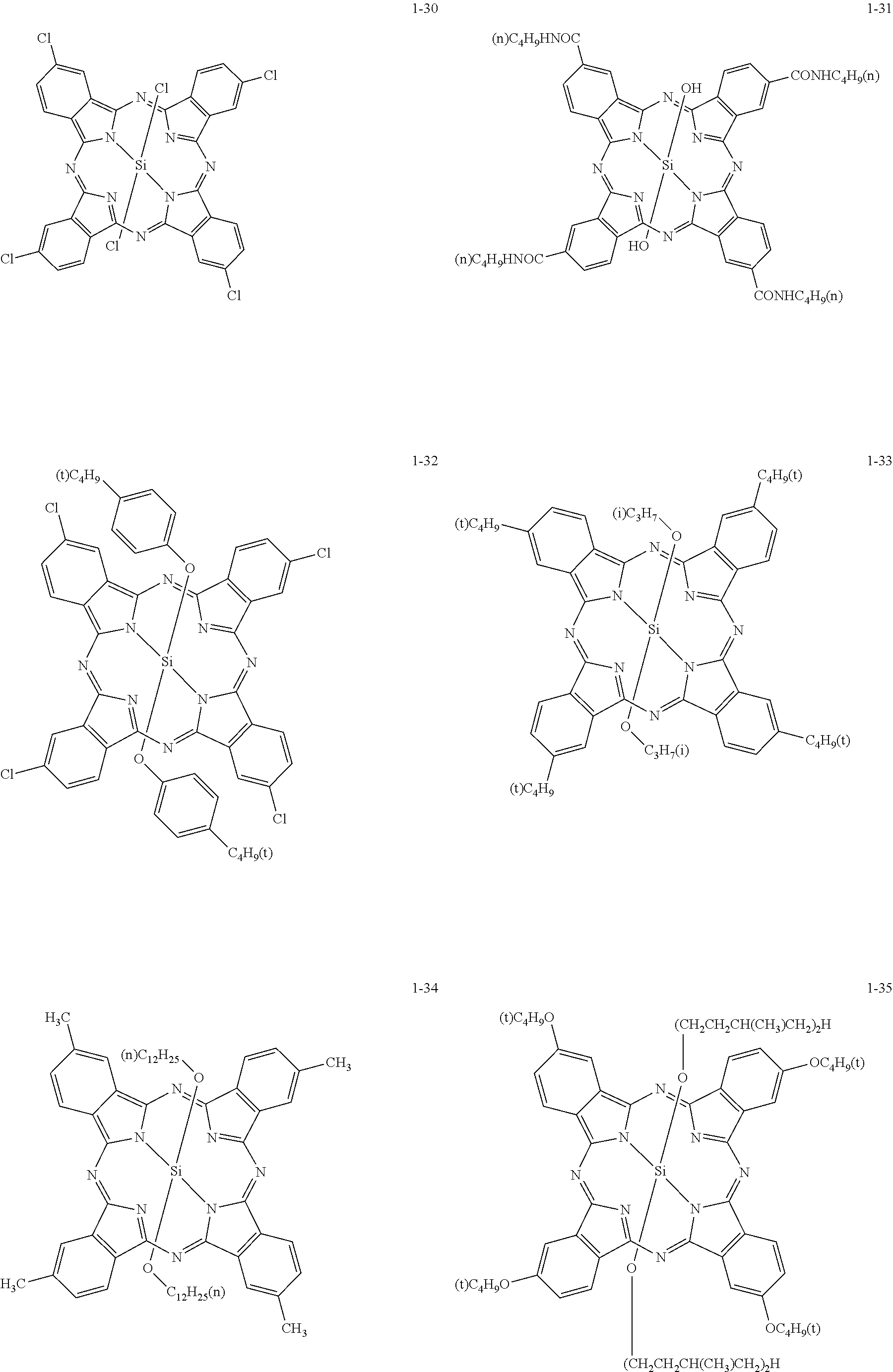

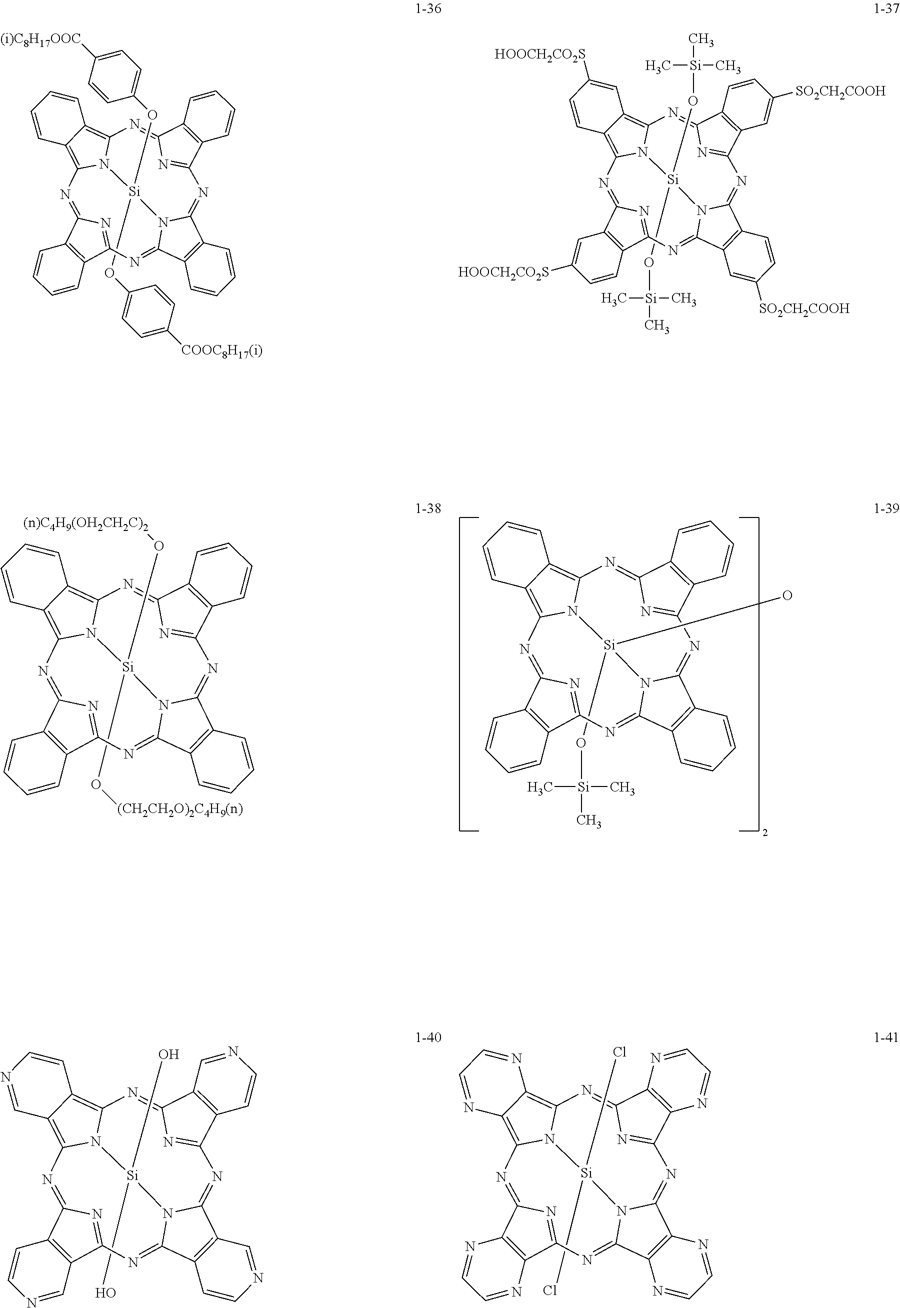

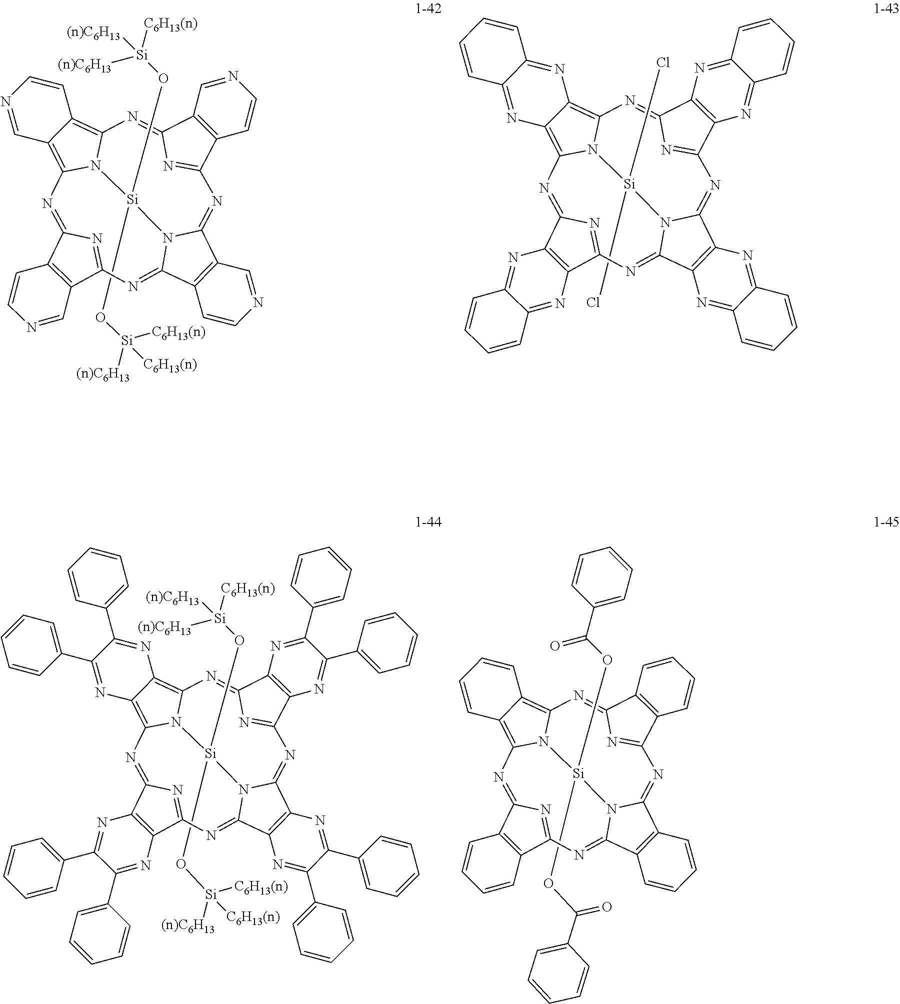

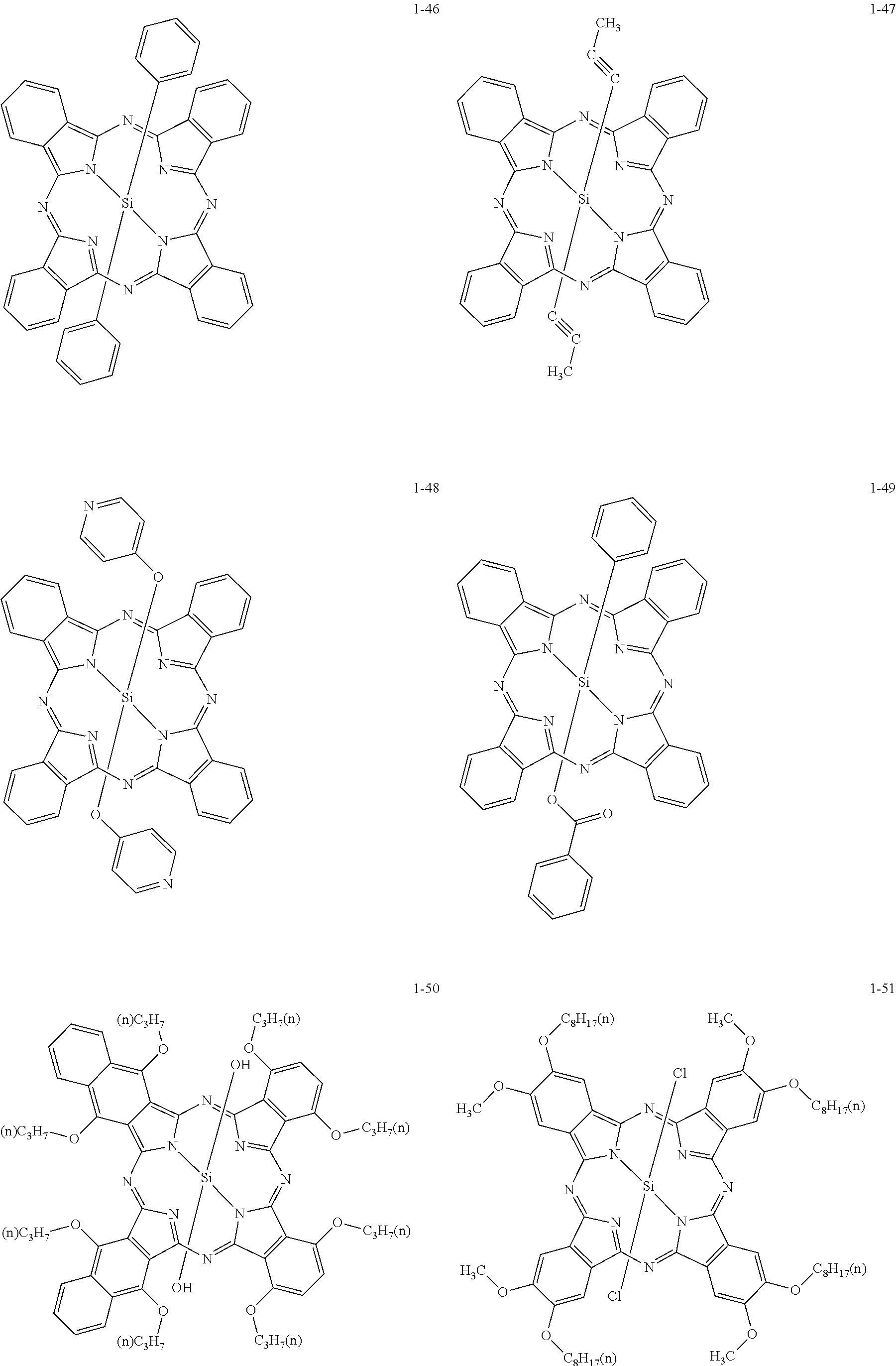

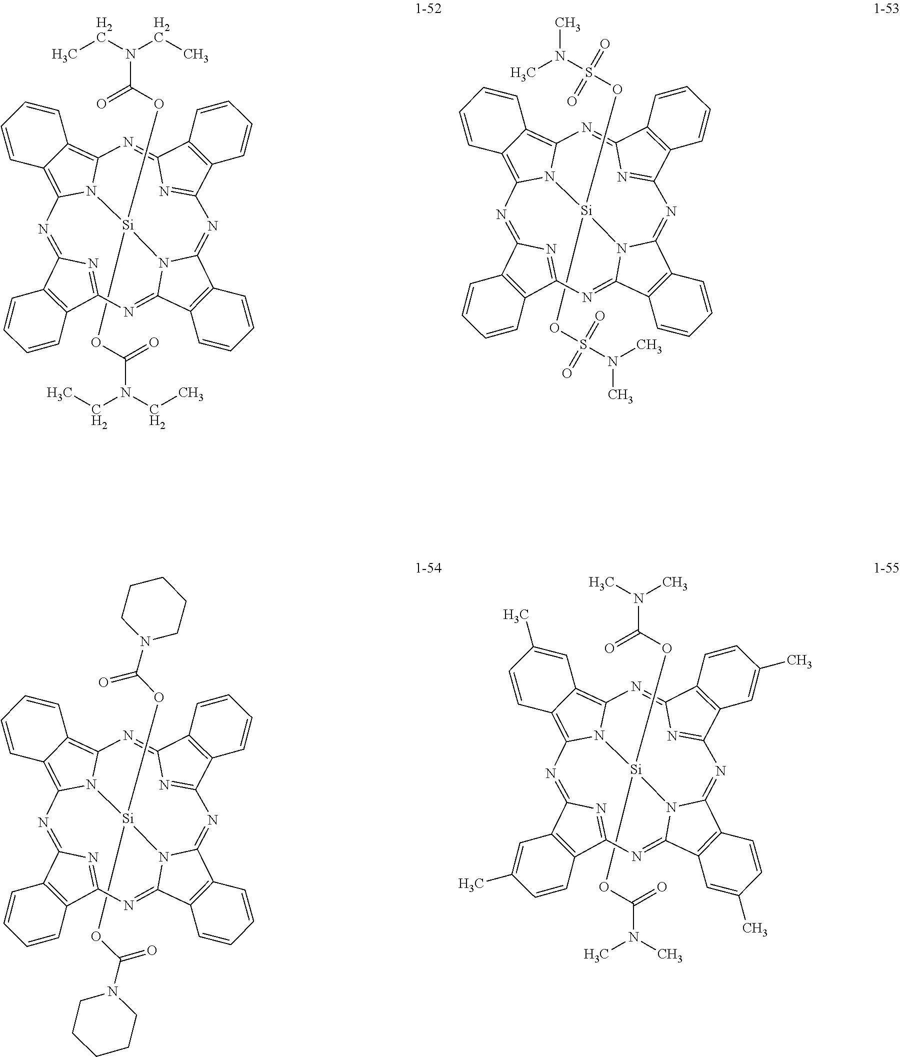

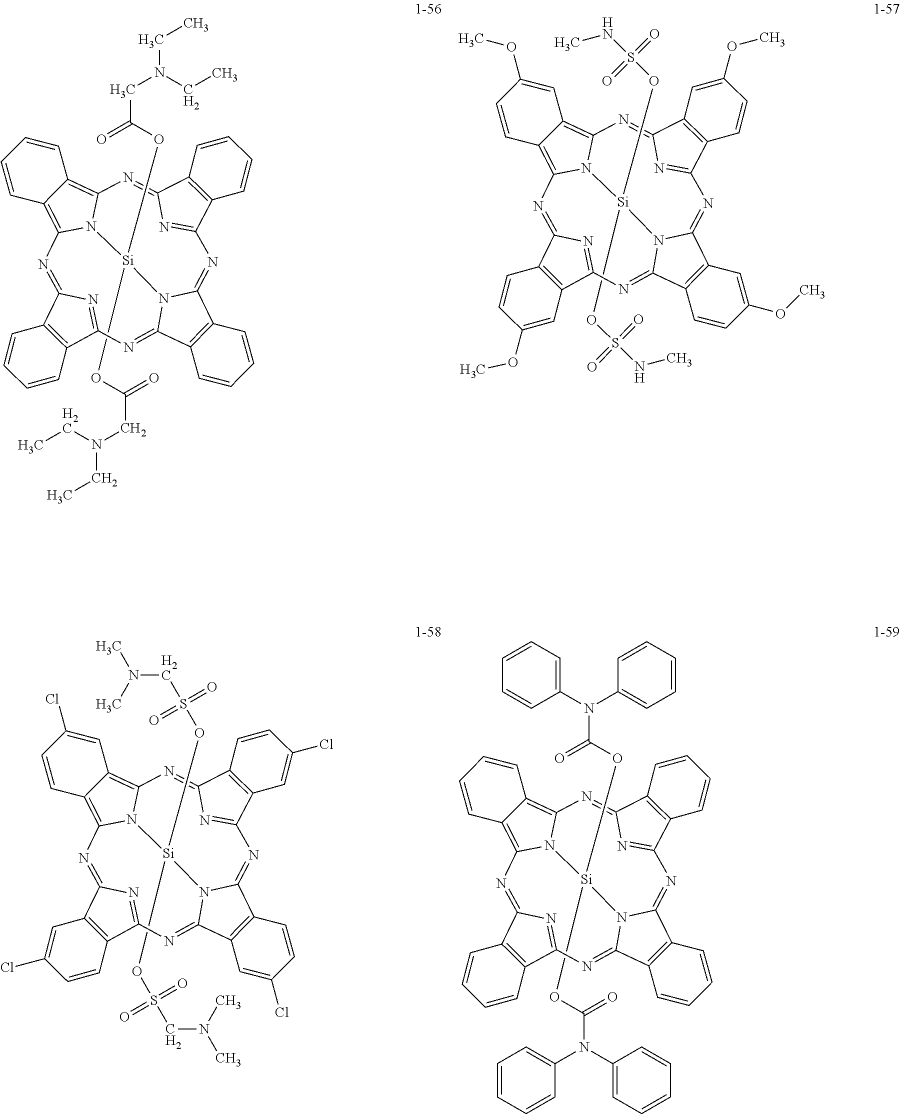

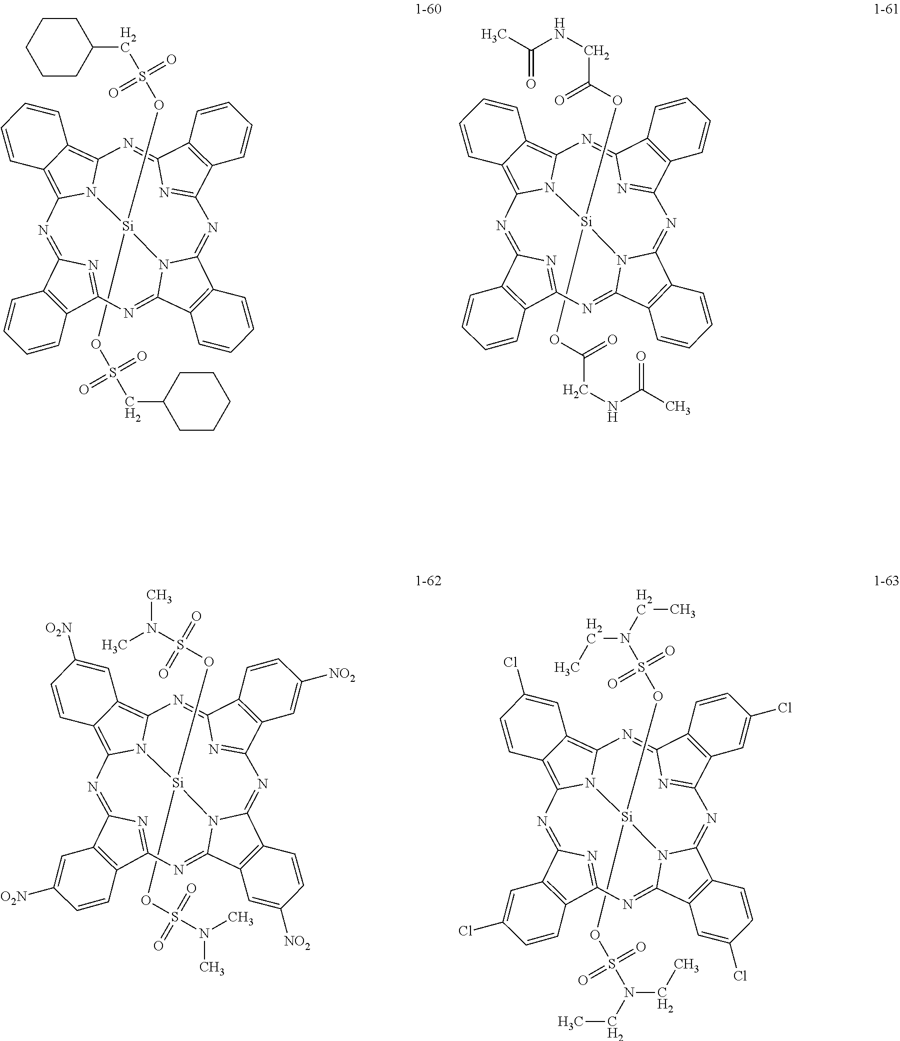

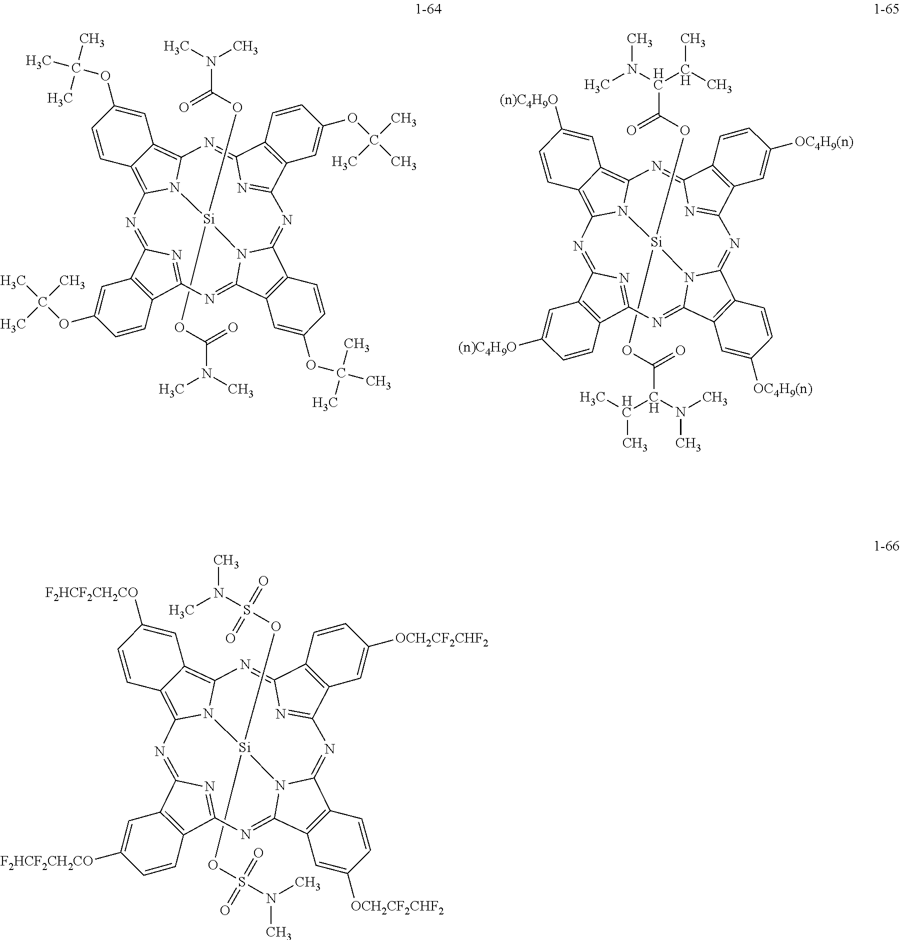

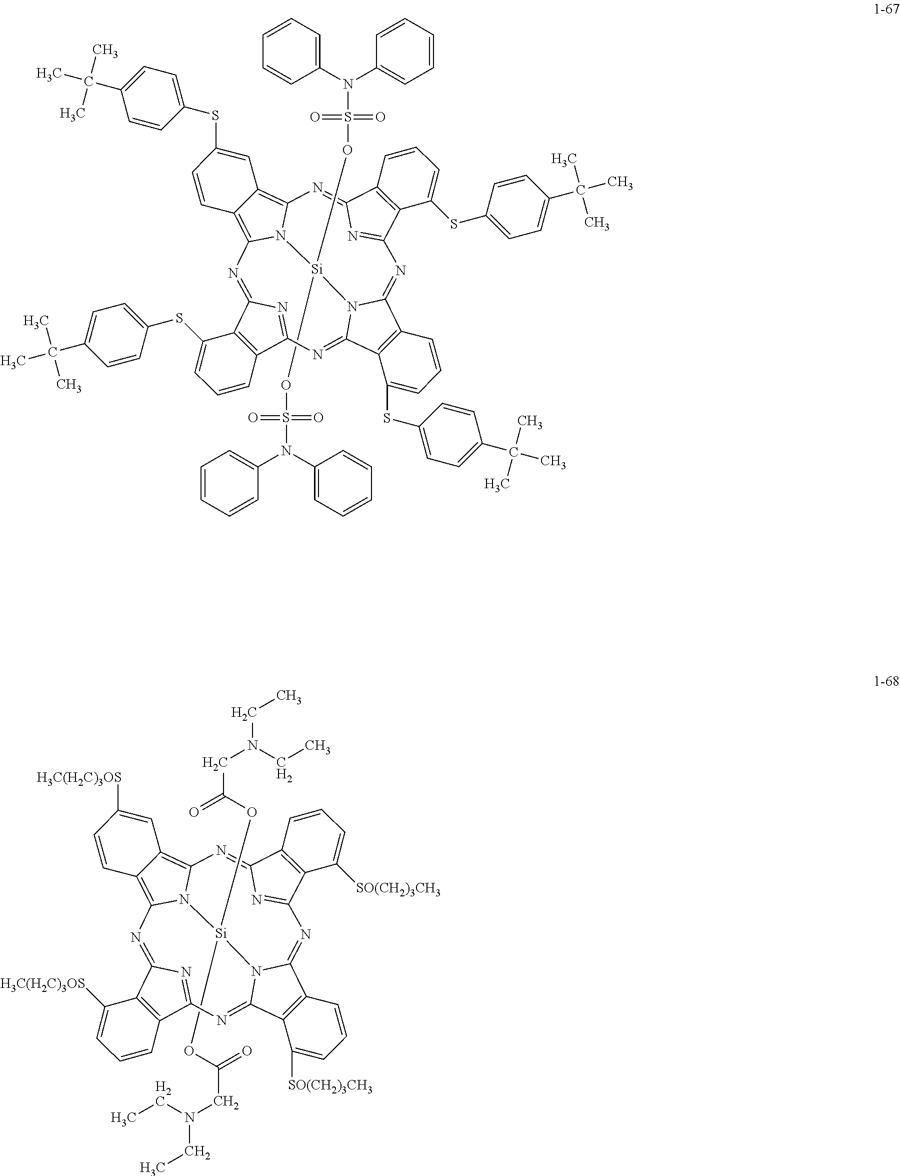

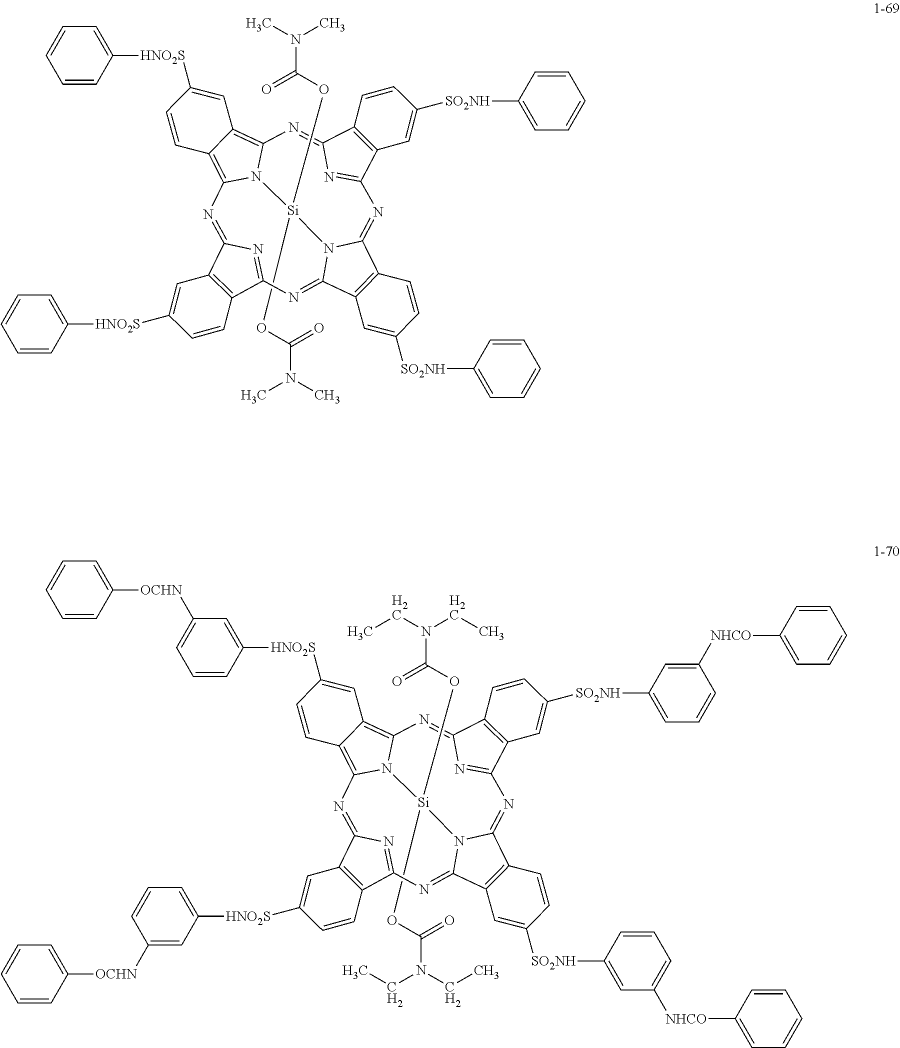

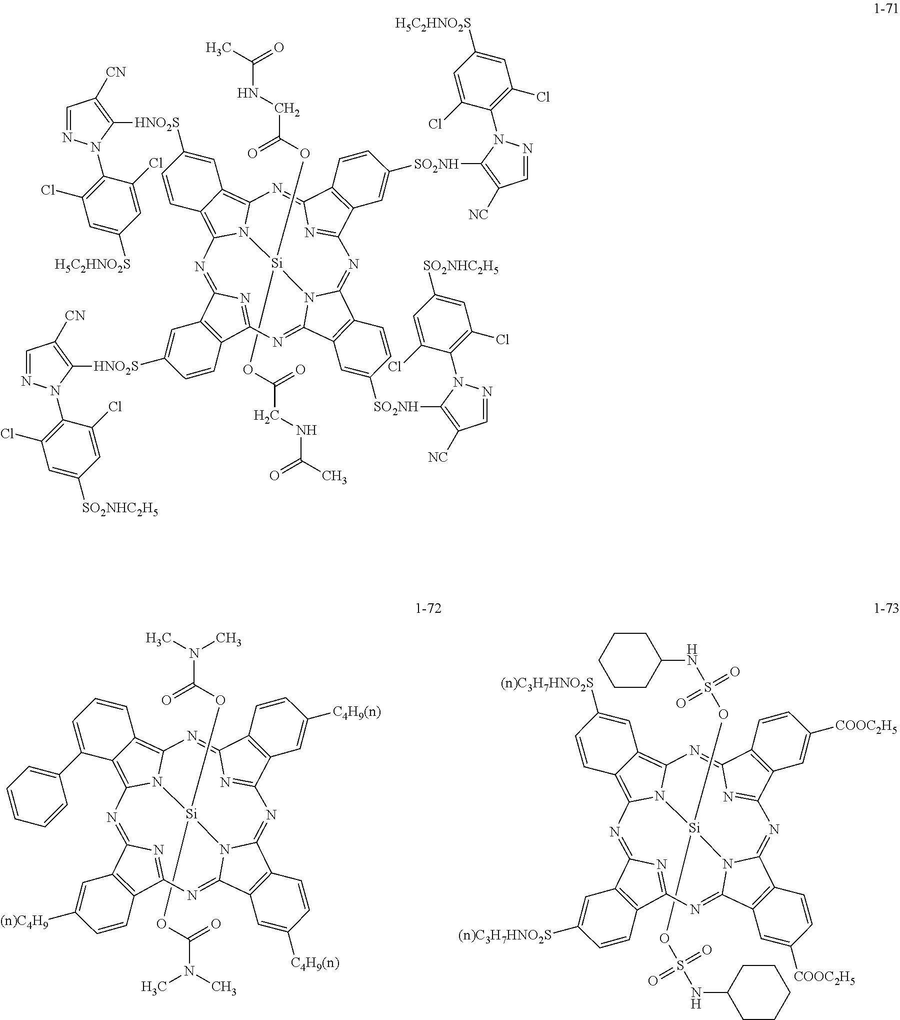

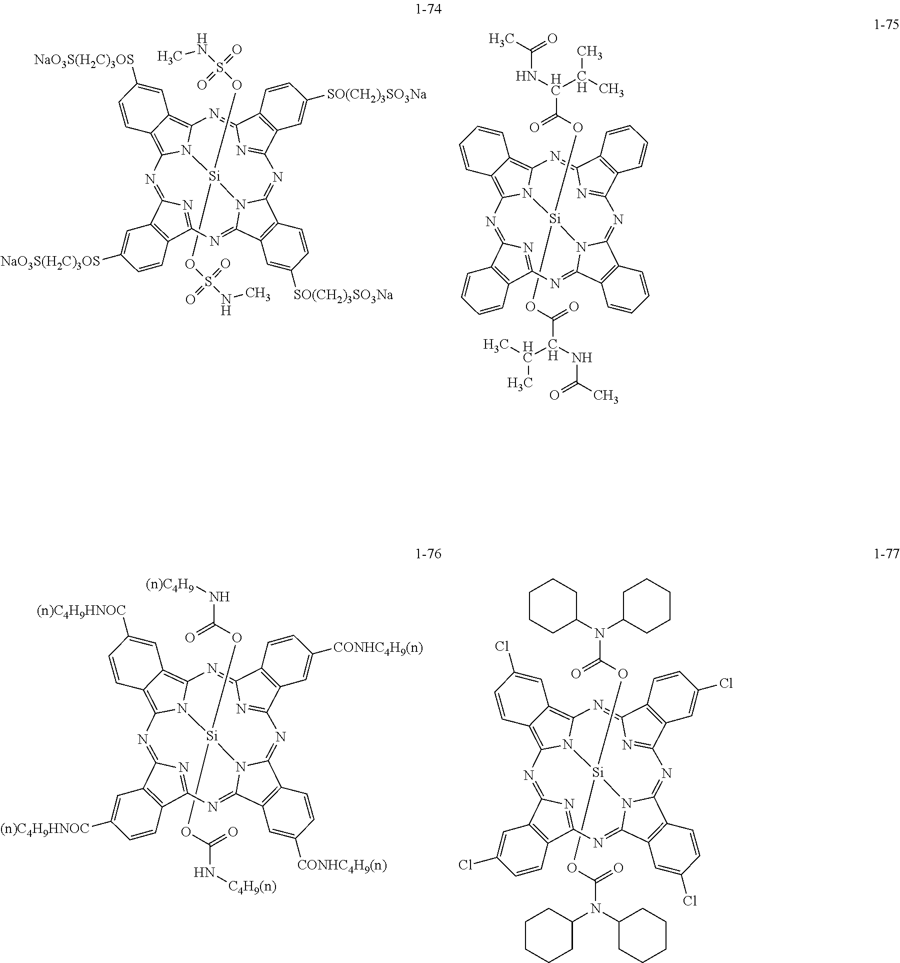

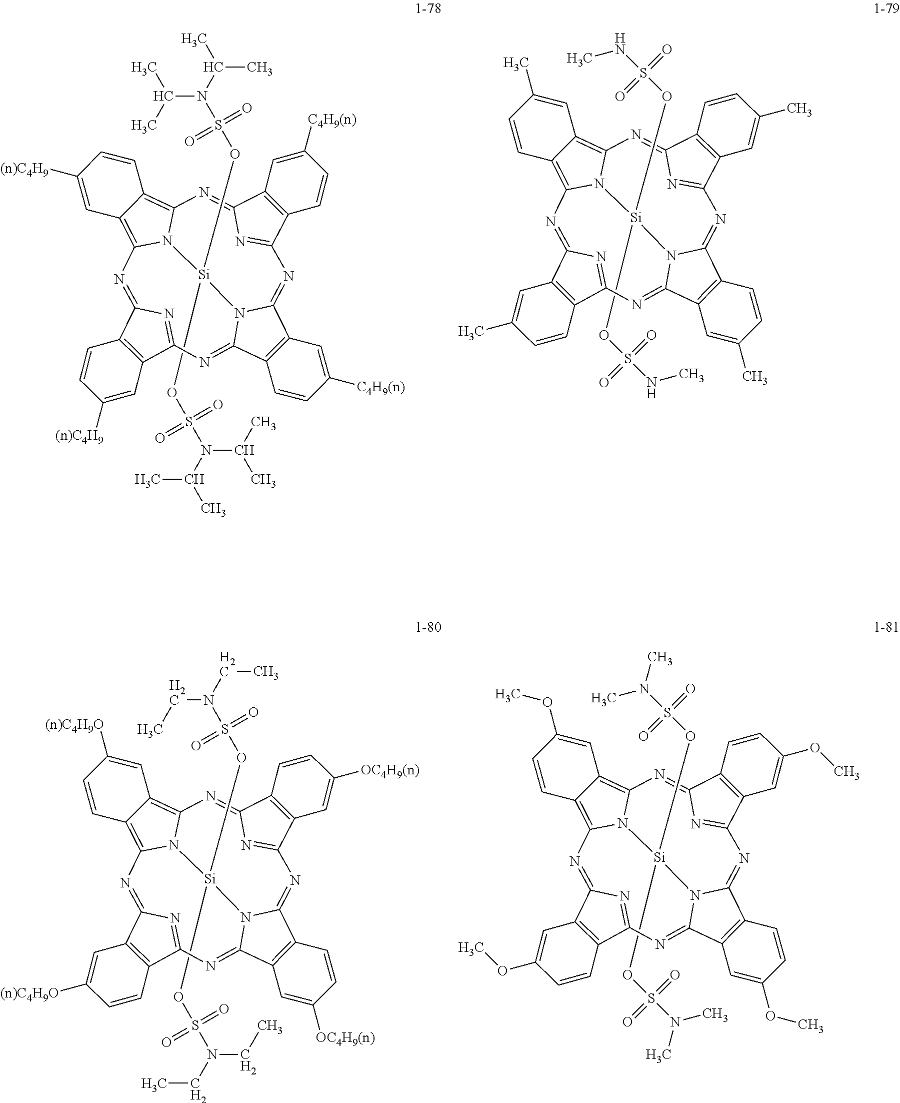

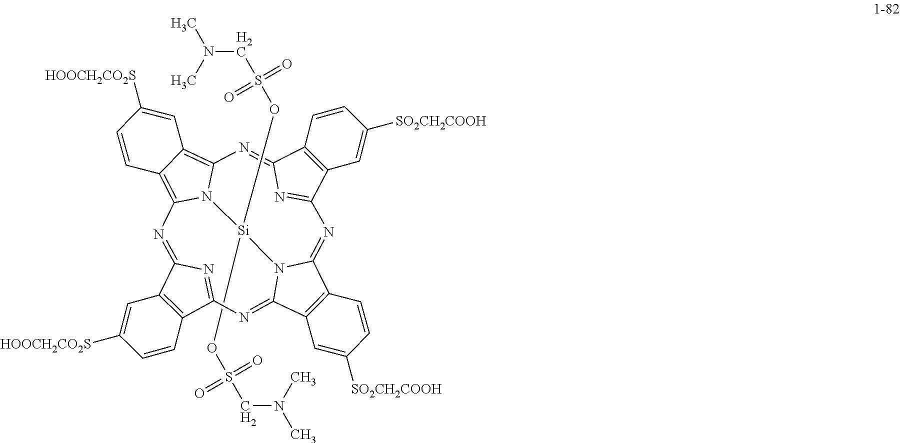

The aforementioned compounds represented by Formula (1) can be synthesized according to a method known in the art.

A compound having a desired ring structure or a substituent can be synthesized using a phthalonitrile or isoindoline similar compound, a metal salt, metal powder or metal carbonyl of silicon which is the central metal. Also, in “Synthesis of Functional Dyes and Application Technologies Thereof” (C.M.C. publishing Co., Ltd.), a wide range of synthesis example are presented.

In order to realize the spectrum profile which is characteristic in the present invention, a colorant is preferably used simultaneously, in addition to the compound represented by Formula (1).

### (Colorant Used Simultaneously)

The colorant used simultaneously is not specifically limited and one commonly available in the market may be used, however, it is preferable to use colorants represented by the following general formula.

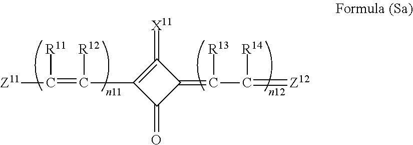

In the formula, R¹¹-R¹⁴ each independently represent an alkyl group, a cycloalkyl group, an alkenyl group, an alkynyl group, an aryl group, a heteroaryl group, a heterocycle group, an alkoxy group, a cyclo alkoxy group, an aryloxy group, an alkylthio group, a cycloalkylthio group, an arylthio group, an alkoxycarbonyl group, an aryloxycarbonyl group, a sulfamoyl group, an acyl group, an acyloxy group, an acylamino group, a sulfonylamino group, a carbamoyl group, an ureido group, a sulfinyl group, an alkylsulfonyl group, an arylsulfonyl group, an amino group, a cyano group, a nitro group, a halogen atom, or a halogenized alkyl group, n11 and n12 each independently represent 0 or 1, X¹¹ represents a hydroxy group or a hydroxy anion, Z¹¹ represents a 5-membered heterocycle containing at least one of an oxygen atom and a sulfur atom, and Z¹² represents a 5-membered heterocycle containing at least one of an oxygen atom and a sulfur atom, a 6-membered carbon ring or heterocycle. ring of 6 members, or heterocycle.

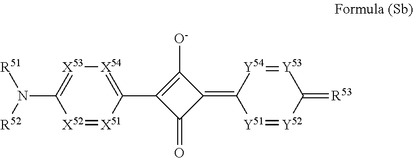

In the formula, R⁵¹ and R⁵² each represent a hydrogen atom or a substituent, R⁵³ represents ═N⁺(R⁵⁴)R⁵⁵ or ═O⁺R⁵⁶, R⁵⁴ and R⁵⁵ each have the same meaning as R⁵¹ and R⁵², R⁵⁶ represents a hydrogen atom or a substituent, X⁵¹-X⁵⁴, Y⁵¹-Y⁵⁴ each represent —C(R⁵⁷)═ or —N═, and R⁵⁷ represents a hydrogen atom or a substituent.

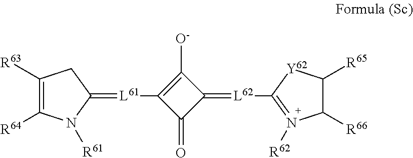

In the formula, R⁶¹-R⁶⁶ each independently represent a hydrogen atom or a substituent, R⁶³ and R⁶⁴ or R⁶⁵ and R⁶⁶ each may form a 5- or 6-membered ring and may further have a substituent. L⁶¹ and L⁶² each independently represent a methine group having no substituent or having a substituent. Y⁶¹ and Y⁶² each represent an oxygen atom, a sulfur atom, —CR⁶⁷R⁶⁸— or —NR⁶⁹—, and R⁶⁷, R⁶⁸, and R⁶⁹ each represent a hydrogen atom or a substituent.

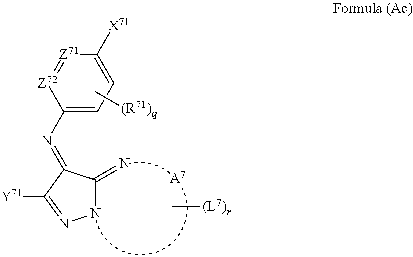

In the formula, Y⁷¹ represents a substituent of 0.2≦σp≦0.9, Z⁷¹ and Z⁷² each represent —CR⁷²═ or —N═, A⁷ represents a group of atoms necessary to form a nitrogen-containing 5-membered ring, L⁷ represents a substituent or a group represented by following Formula (Ac-1), X⁷¹ represents a substituted or non-substituted alkylamino group, R⁷¹ represents a substituted or non-substituted alkyl group, q represents an integer of 0 or more, and r represents 1 or 2. R⁷² represents a hydrogen atom or a substituent.

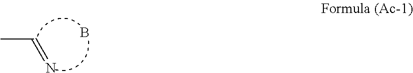

In the formula, B represents a group of non-metal atoms necessary to form a heterocycle.

The compound represented by Formula (Sa) will be explained in detail.

In Formula (Sa), examples of R¹¹-R¹⁴ independently include a hydrogen atom, an alkyl group (for example, a methyl group, an ethyl group, a propyl group, an isopropyl group, a t-butyl group, a pentyl group, a hexyl group, an octyl group, a dodecyl group, a tridecyl group, a tetradecyl group and a pentadecyl group), a cycloalkyl group (for example, a cyclopentyl group and a cyclohexyl group), an alkenyl group (for example, a vinyl group and an allyl group), an alkynyl group (for example, an ethynyl group and a propargyl group), a aryl group (for example, a phenyl group and a naphthyl group), a heteroaryl group (for example, a furyl group, a thienyl group, a pyridyl group, a pyridazyl group, a pyrimidyl group, a pyrazyl group, a triazyl group, an imidazolyl group, a pyrazolyl group, a thiazolyl group, a benzimidazolyl group, a benzoxazolyl group, a quinazolyl group and a phthalazyl group), a heterocyclic group (for example, a pyrrolidyl group, an imidazolidyl group, a morpholyl group and an oxazolidyl group), an alkoxy group (for example, a methoxy group, an ethoxy group, a propyloxy group, a pentyloxy group, an hexyloxy group, an octyloxy group and a dodecyloxy group), a cycloalkoxyl group (for example, as a cyclopentyloxy group and a cyclohexyloxy group), an aryloxyl group (for example, a phenoxy group and a naphthyloxy group), an alkylthio group (for example, a methylthio group, an ethylthio group, a propylthio group, a pentylthio group, a hexylthio group, an octylthio group and a dodecylthio group), a cycloalkylthio group (for example, a cyclopentylthio group and cyclohexylthio group), an arylthio group (for example, a phenylthio group and a naphthylthio group), an alkoxycarbonyl group (for example, a methyloxycarbonyl group, an ethyloxycarbonyl group, a butyloxycarbonyl group, an octyloxycarbonyl group and dodecyloxycarbonyl group), an aryloxycarbonyl group (for example, a phenyloxycarbonyl group and a naphthyloxycarbonyl group), a sulfamoyl group (for example, an aminosulfonyl group, a methylaminosulfonyl group, a dimethylaminosulfonyl group, a butylaminosulfonyl group, a hexylaminosulfonyl group, a cyclohexylaminosulfonyl group, an octylaminosulfonyl group, a dodecylaminosulfonyl group, a phenylaminosulfonyl group, a naphthylaminosulfonyl group and a 2-pyridylaminosulfonyl group), an acyl group (for example, an acetyl group, an ethylcarbonyl group, a propylcarbonyl group, a pentylcarbonyl group, a cyclohexylcarbonyl group, an octylcarbonyl group, a 2-ethylhexylcarbonyl group, a dodecylcarbonyl group, a phenylcarbonyl group, a naphthylcarbonyl group and a pyridylcarbonyl group), an acyloxy group (for example, an acetyloxy group, an ethylcarbonyloxy group, a butylcarbonyloxy group, an octylcarbonyloxy group, a dodecylcarbonyloxy group and a phenylcarbonyloxy group), an acylamido group (for example, a methylcarbonylamino group, an ethylcarbonylamino group, a dimethylcarbonylamino group, a propylcarbonylamino group, a pentylcarbonylamino group, a cyclohexylcarbonylamino group, a 2-ethylhexylcarbonylamino group, an octylcarbonylamino group, a dodecylcarbonylamino group, a phenylcarbonylamino group and a naphthylcarbonylamino group), a sulfonylamino group (for example, a methylsulfonylamino group, an ethylsulfonylamino group, a hexylsulfonyl amino group, a decylsulfonylamino group and a phenylsulfonylamino group), a carbamoyl group (for example, an aminocarbonyl group, a methylaminocarbonyl group, a dimethylaminocarbonyl group, propylaminocarbonyl group, a pentylaminocarbonyl group, cyclohexylaminocarbonyl group, an octylaminocarbonyl group, a 2-ethylhexylaminocarbonyl group, a dodecylaminocarbonyl group, a phenylaminocathonyl group, a naphthylaminocarbonyl group and a 2-pridylaminocarbonyl group), a ureido group (for example, a methylureido group, an ethylureido group, a pentylureido group, a cyclohexylureido group, an octylureido group, a dodecylureido group, a phenylureido group, a naphthylureido group and a 2-pyridylaminoureido group), a sulfinyl group (for example, a methylsulfinyl group, an ethylsulfinyl group, a butylsulfinyl group, a cyclohexylsulfinyl group, a 2-ethylhexylsulfinyl group, a dodecylsulfinyl group, a phenylsulfinyl group, a naphthylsulfinyl group and a 2-pyridylsulfinyl group), an alkylsulfonyl group (for example, a methylsulfonyl group, an ethylsulfonyl group, a butylsulfonyl group, a cyclohexylsulfonyl group, a 2-ethylhexylsulfonyl group and a dodecylsulfonyl group), an arylsulfonyl group (for example, a phenylsulfonyl group, a naphthylsulfonyl group and a 2-pyridylsulfonyl group), an amino group (for example, an amino group, an ethylamino group, a dimethylamino group, a butylamino group, a cyclopentylamino group, a 2-ethylhexylamino group, a dodecylamino group, an anilino group, a naphthylamino group and a 2-pyridylamino group, a cyano group, a nitro group, a halogen atom (for example, a fluorine atom, a chlorine atom and a bromine atom), an alkyl halide group (for example, a fluoromethyl group, a trifluoromethyl group, a chloromethyl group, a trichloromethyl group, a perfluoropropyl group). These substituents may further have a substituent mentioned above.

Preferable examples of R¹¹-R¹⁴ include a hydrogen atom, a halogen atom, an alkyl group and alkoxycarbonyl group.

Each of n11 and n12 dependently represents 0 or 1.

X¹¹ represents a hydroxy group or a hydroxy anion.

Z¹¹ represents a 5-membered heterocycle containing at least one of an oxygen atom and a sulfur atom. Concrete examples of Z¹¹ include thiol, furan, thiazole, isothiazole, oxazole, isoxazole, thiadiazole and oxathiadiazole. Z¹¹ may have a condensed ring. Z¹¹ preferably has a structure represented by one of Formulas (Sa-1) (Sa-4).

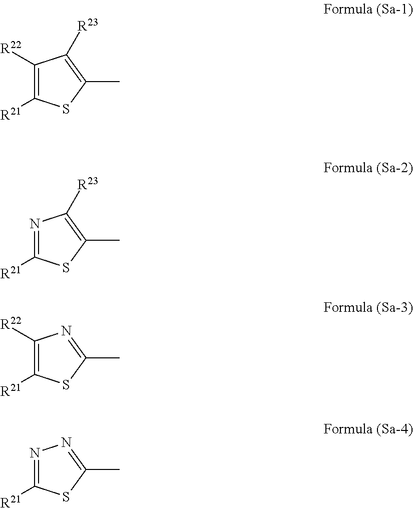

In Formulas (Sa-1)-(Sa-4), R²¹-R²³ each independently represent a hydrogen atom, an alkyl group, an aryl group, an amino group, an alkoxy group, a carbamoyl group or a sulfanomyl group, and more preferably represent an amino group or an alkoxy group.

Among Formulas (Sa-1)-(Sa-4), further preferable are Formulas (Sa-1) and (Sa-2).

Z¹² represents a 5-membered heterocycle containing at least one of an oxygen atom and a sulfur atom, or 6-membered carbon ring or a heterocycle, may have a condensed ring.

When Z¹¹ is a hydroxyl anion, Z¹² preferably has a structure represented by one of following Formulas (Sa-5)-(Sa-11).

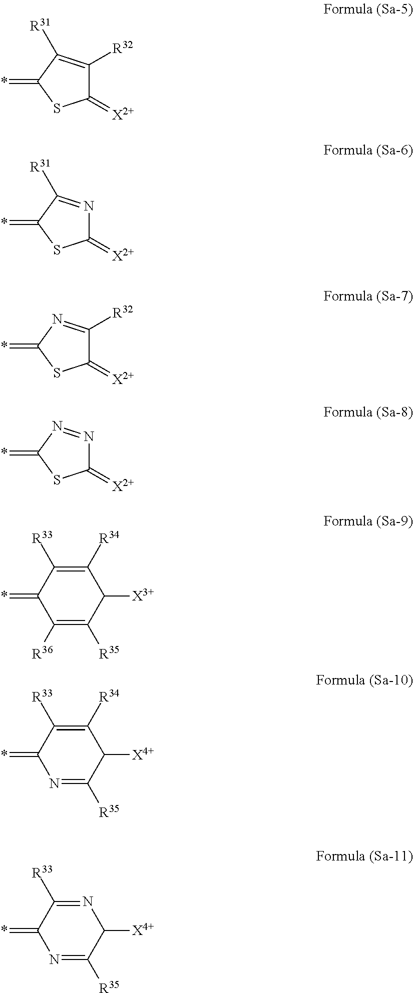

R³¹ and R³⁶ each independently represent a hydrogen atom or a substituent. As the substituent, the aforementioned groups cited as the substituent for R¹¹ and R¹⁴ may be cited. R³⁴-R³⁶ each are preferably an alkyl group, an aryl group, a halogen atom, a hydroxyl group or an alkoxy group. R³³ is preferably a hydroxyl group, a carbamoyl group, or a sulfamoyl group.

X²⁺ and X⁴⁺ each represent ═N⁺R⁶R⁷ or ═O⁺R⁸, and X³⁺ represents ═N⁺R⁶R⁷ or ═O⁺R⁹.

R⁶ and R⁷ each represent a hydrogen atom, an alkyl group or an aryl group, and preferably represent an alkyl group or an aryl group.

R⁸ represents a hydrogen atom, an alkyl group, or an aryl group, and preferably represents an alkyl group.

R⁹ represents an alkyl group or an aryl group, and preferably represents an alkyl group.

The symbol * represents a bond with a squarylium structure.

Z12 is more preferably one of Formulas (Sa-5)-(Sa-8).

Concrete examples a colorant represented by Formula (Sa) will be shown below, however, the present invention is not limited thereto. Moreover, when there is a tautomer, the tautomers are represented by only one kind of description, however, it is not limited to the tautomer, and also a mixture of the tautomers are included.

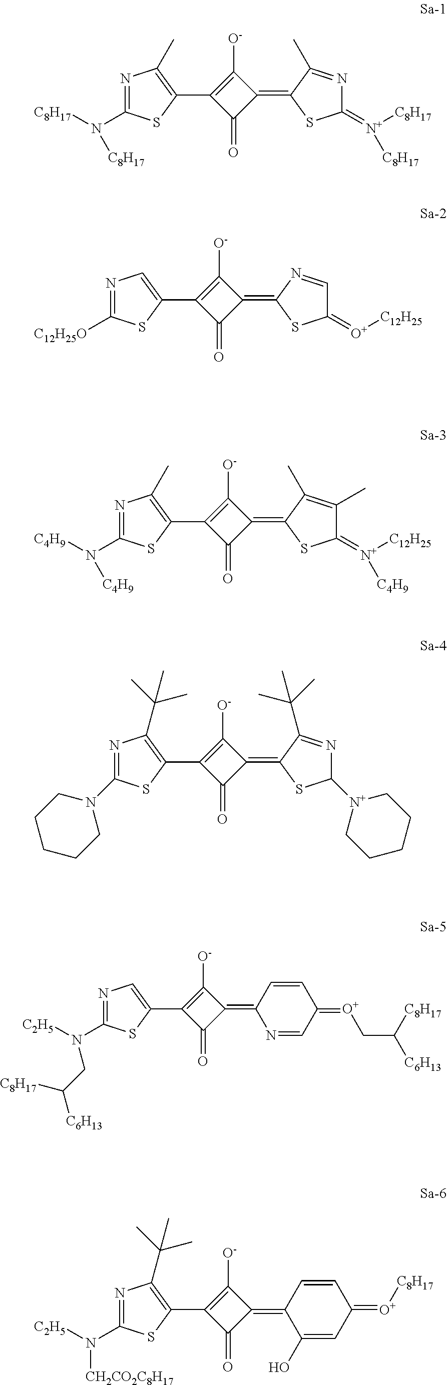

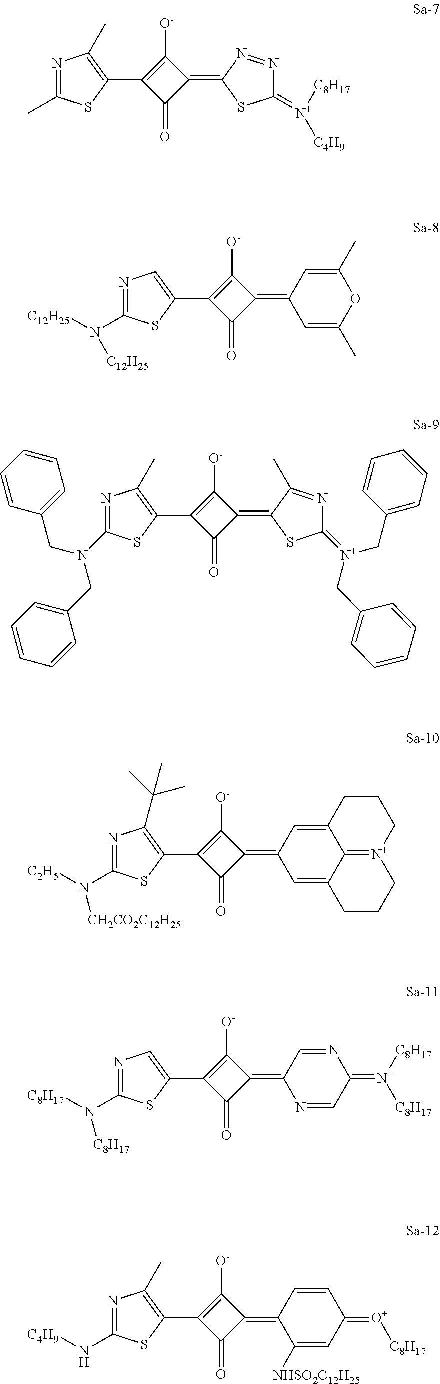

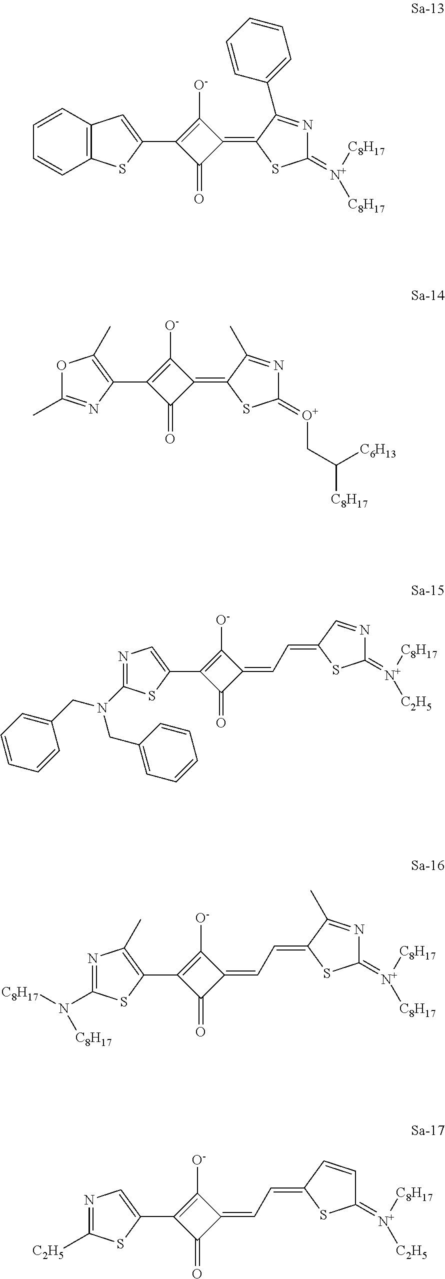

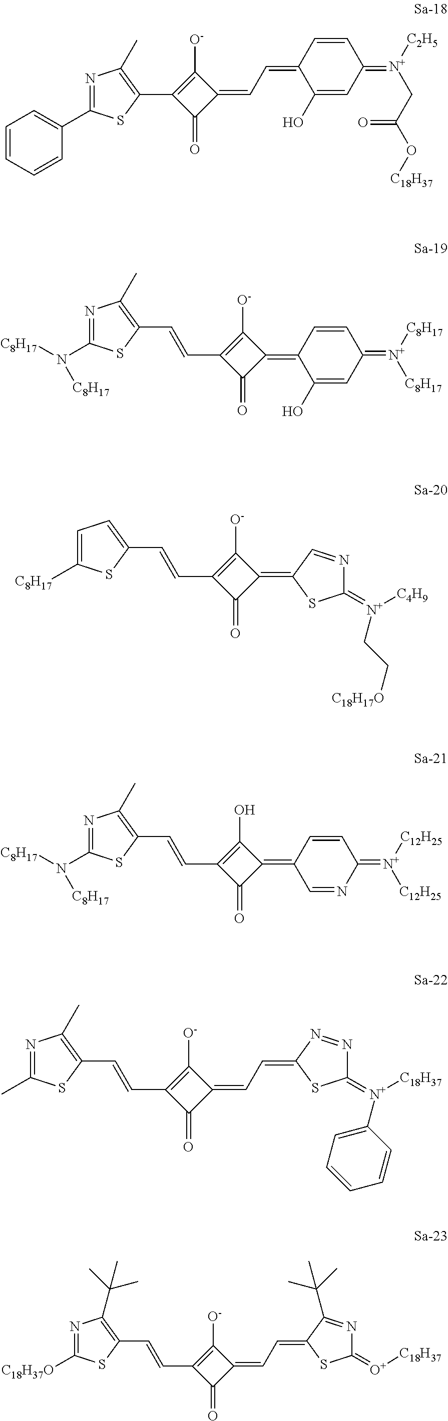

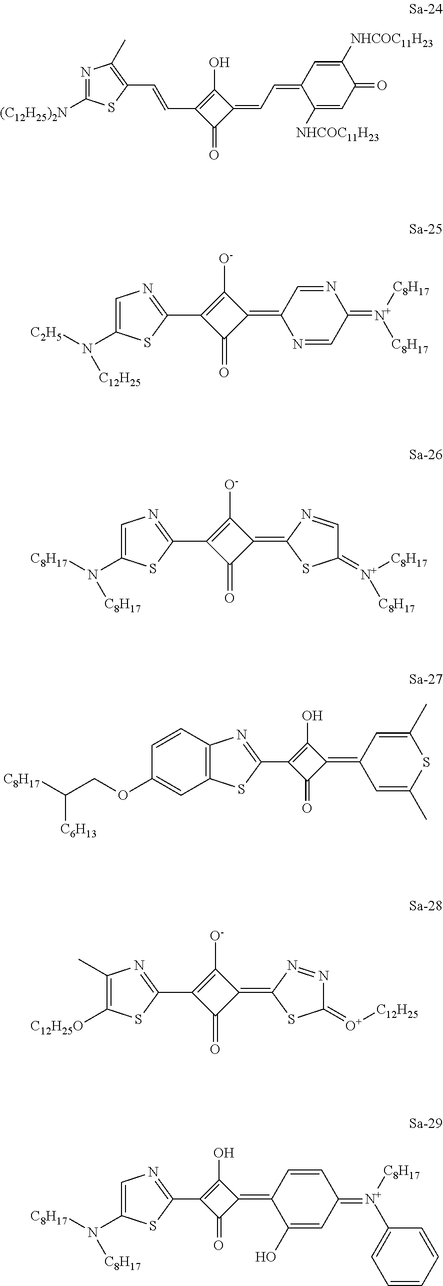

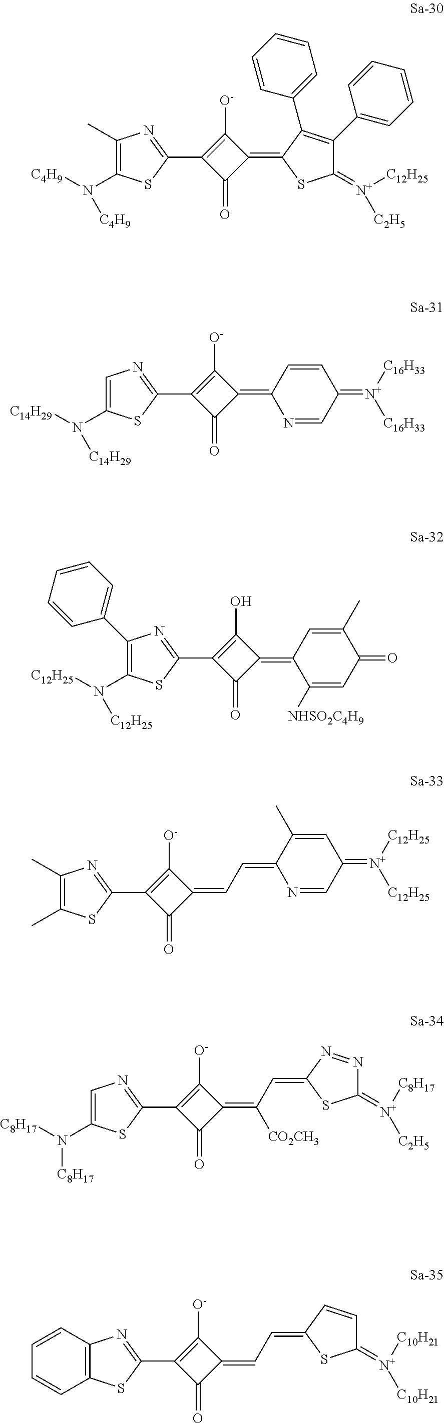

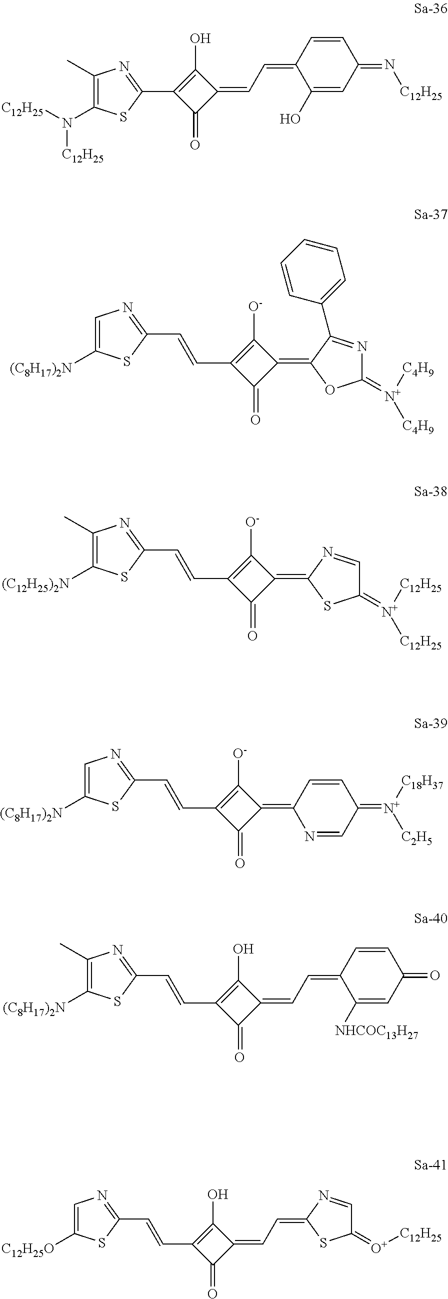

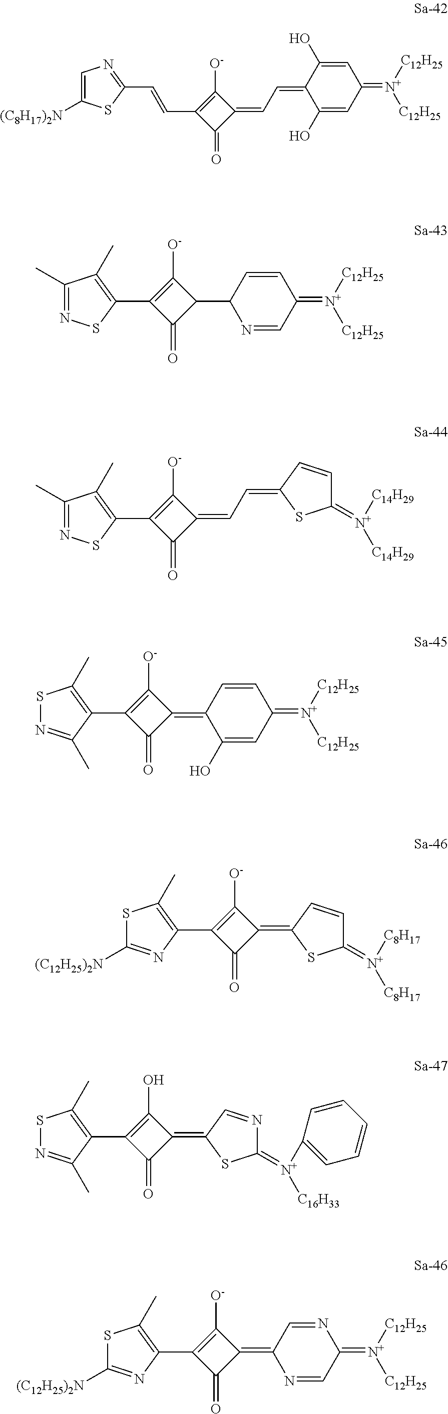

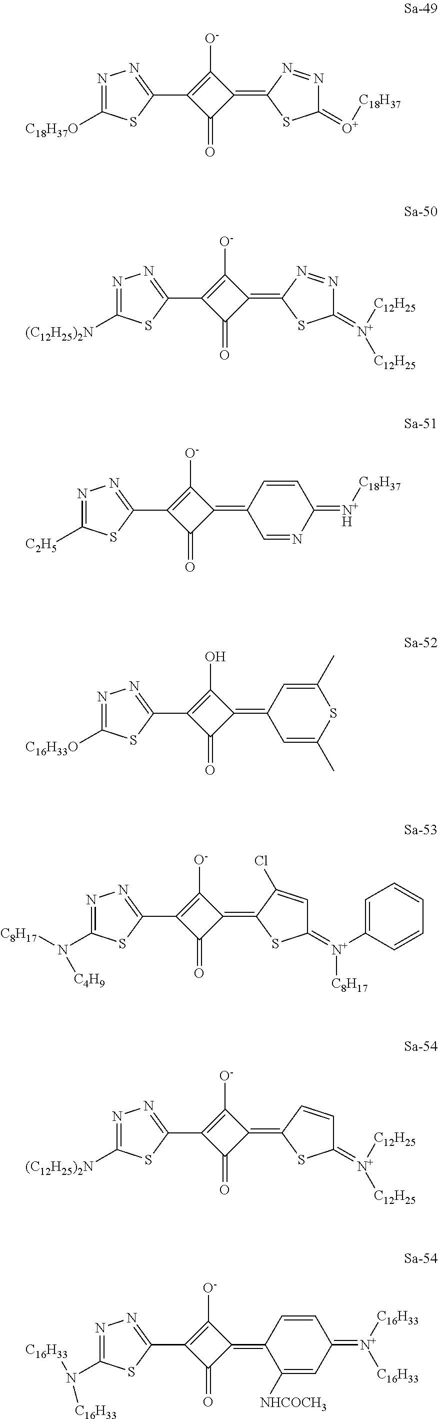

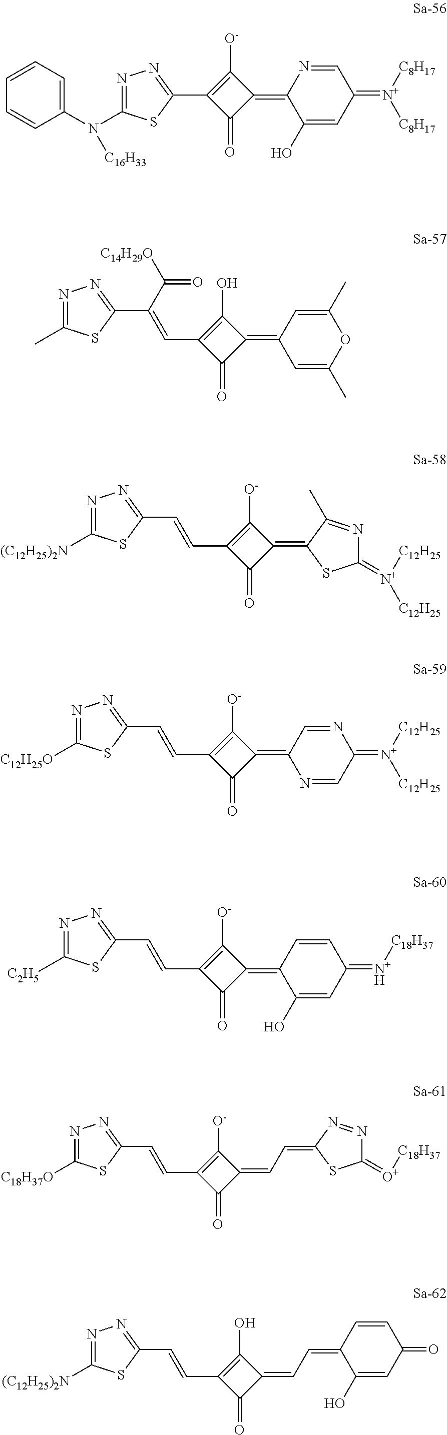

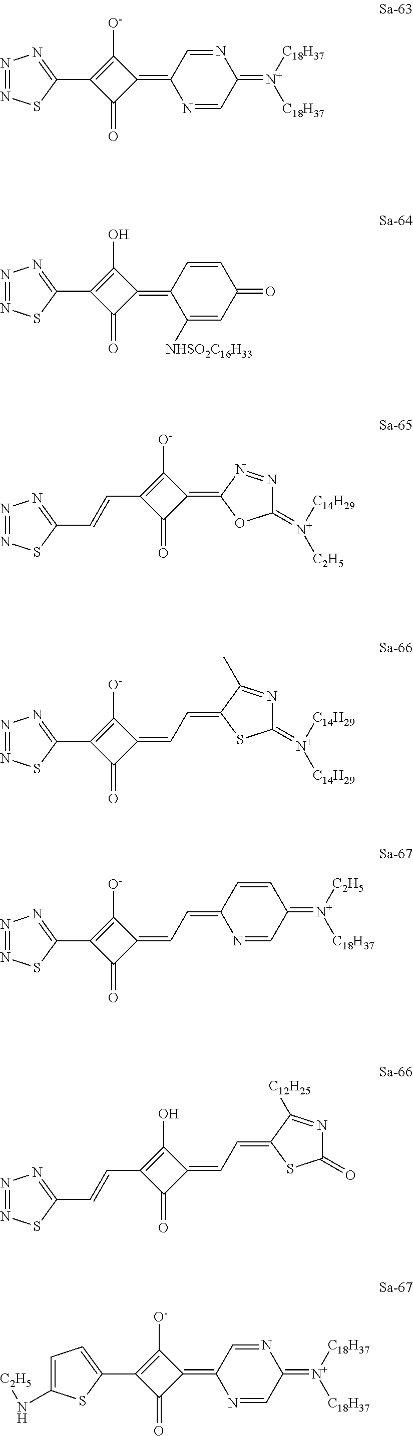

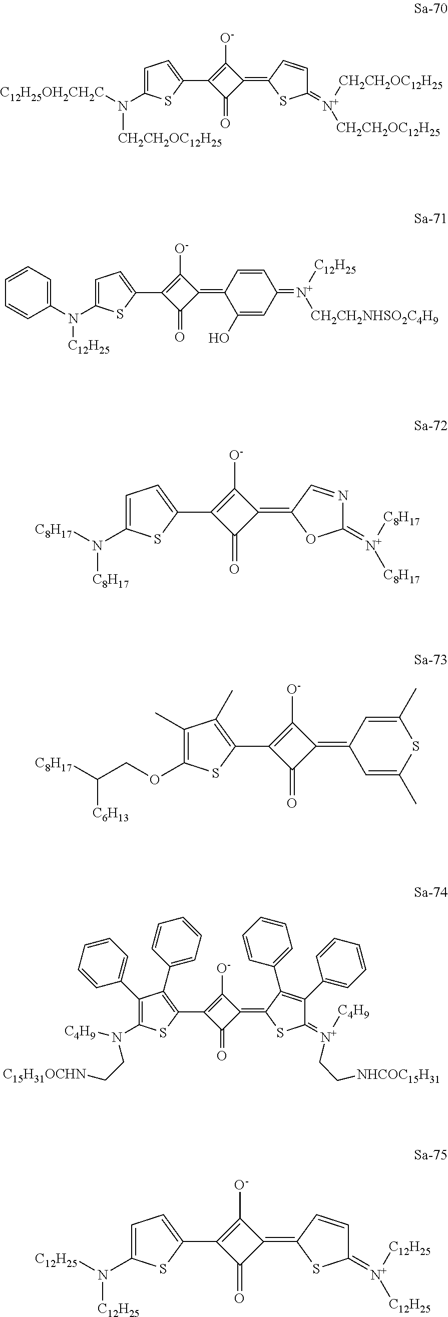

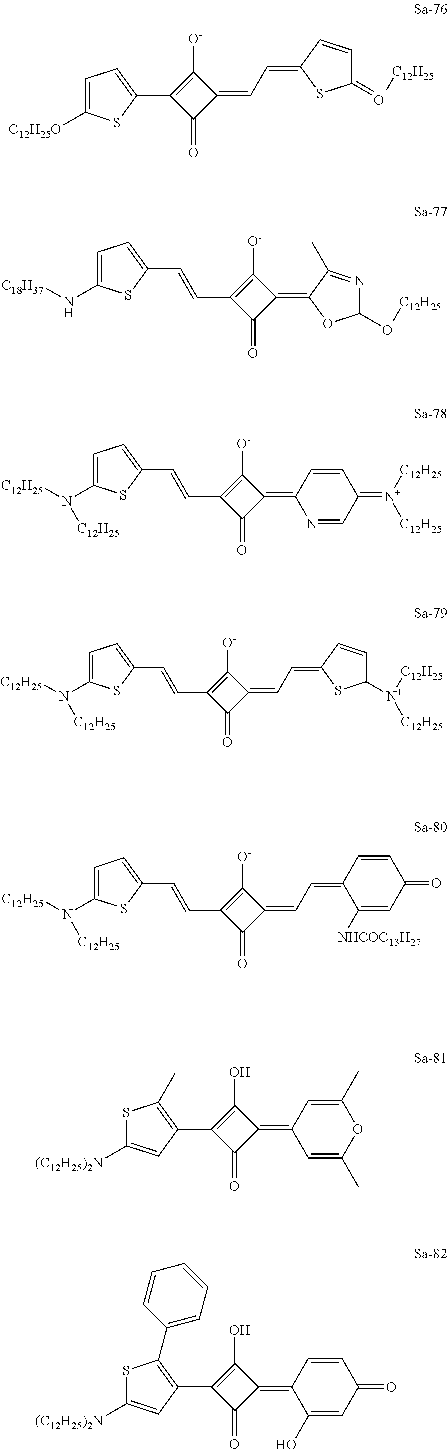

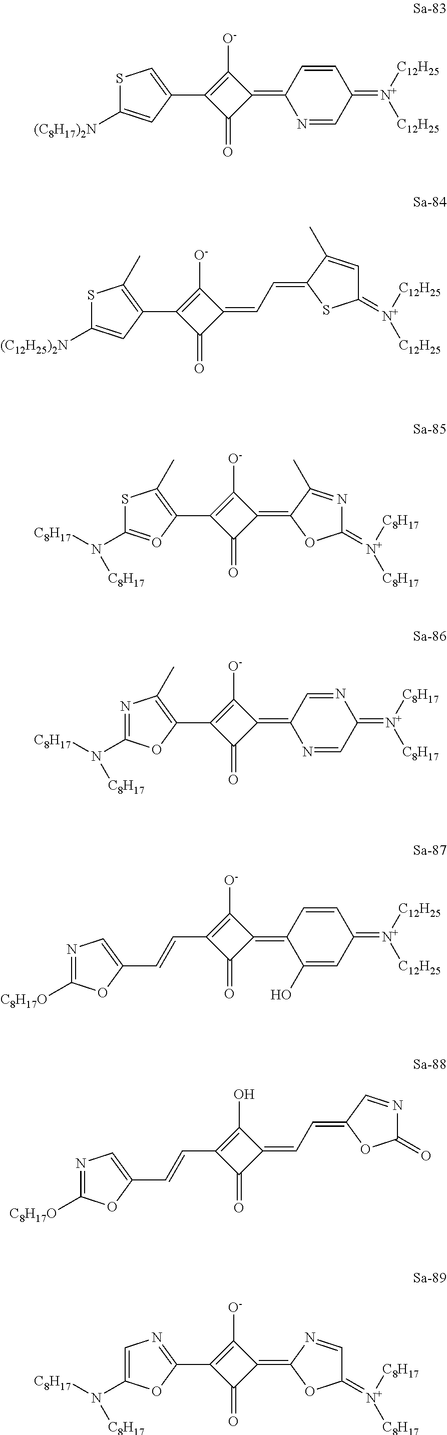

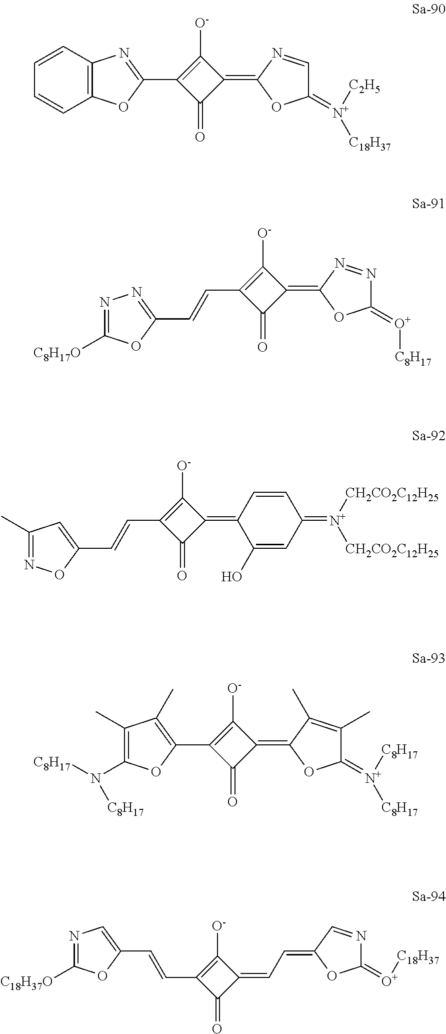

When using a compound represented by Formula (Sa) as a colorant, it is preferable to contain a compound represented by following Formula (2).

M(X⁵)ₙ₅ Formula (2)

In the formula, M represents a metal ion, X⁵ represents an anion, n5 represents an integer of 0-3, and when n is plurality, X⁵ may be the same or different.

The metal ion represented by M is selected from the metal atoms of groups VIII, Ib, IIb, IVa, Va, VIa, and VIIa of the periodic table, and it is preferably a divalent transition metal ion.

Concrete examples of the metal ion include divalent metal ions of Ni, Cu, Co, Cr, Zn, Fe, Pd, and Pt, more preferably include divalent metal ions of Cu, Co and Zn, and specifically preferably include divalent metal ion of Cu.

Examples of the anion represented by X⁵ include an enolate (acetylacetonato and hexafluoroacetylacetonato), a halogen ion (for example, fluoride, chloride and iodide), a hydroxyl ion, a sulfite ion, a sulfate ion, an alkylsulfonic acid ion, an arylsulfonic acid ion, a nitrate ion, a nitrite ion, a carbonate ion, a perchloric acid ion, an alkylcarboxylate ion, an arylcarboxylate ion, tetraalkylborate, salicylate, benzoate, PF₆⁻, BF₄⁻, SbF₆⁻, and preferably include an enolate anion.

The compound represented by Formula (2) is preferably a compound represented by Formula (3)

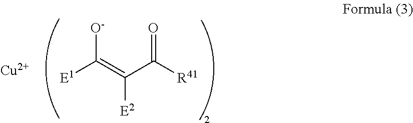

In the formula, R⁴¹ represents an alkyl group, an aryl group, a heterocycle group, an alkoxy group, or an amino group. E¹ and E², each represent an electron withdrawing group exhibiting a Hammett's substituent constant (σp value) of 0.1 or more but 0.9 or less.

In Formula (3), R⁴¹ represents an alkyl group, an aryl group, a heterocycle group, an alkoxy group and an amino group, and may further be substituted with a substituent which is the samen as the aforementioned substituent cited for R¹-R⁴.

R⁴¹ is preferably an alkoxy group.

The substituents represented by E¹ and E² exhibiting a σp value of 0.1 or more but 0.9 or less will now be explained. The values of Hammett's substituent constant σp as referred to herein are preferably those described in the report of Hanach, C. Leo et al. (for example, in J. Med. Chem. 16, 1207 (1973); and ibid 20, 304 (1977)).

Examples of a substituent or an atom exhibiting a σp value of 0.10 or more include a chlorine atom, a bromine atom, iodine atoms, a carboxyl group, a cyano group, a nitro group, an alkylhalide group (for example, trichloromethyl, trifluoromethyl, chloromethyl, trifluoromethylthiomethyl, trifluoromethanesulfonylmethyl and perfluorobutyl), an aliphatic, aromatic or a heterocyclicacyl group (for example, formyl, acetyl and benzoyl), an aliphatic, aromatic or a heterocyclicsulfonyl group (for example, trifluoromethanesulfonyl, methanesulfonyl and benzenesulfonyl), a carbamoyl group (for example, carbamoyl, methylcarbamoyl, and phenylcarbamoyl and 2-chlorophenylcarbamoyl), an alkoxycarbonyl group (for example, methoxycarbonyl, ethoxycarbonyl and diphenylmethylcarbonyl), a substituted aromatic group (for example, pentachlorophenyl and pentafluorophenyl, 2,4-dimetanesulfonylphenyl, 2-trifluoromethylphenyl, a heterocyclic residue (for example, 2-benzoxazolyl, 2-benzthiazolyl, 1-phenyl-2-benzimidazolyl and 1-tetrazolyl), an azo group (for example, phenylazo), a ditrifluoromethylamino group, a trifluoromethoxy group, an alkylsulfonyloxy group (for example, methanesulfonyloxy), an acyloxy group (for example, acetyl oxy and benzoyloxy), an arylsulfonyloxy group (for example, benzenesulfonyloxy), a phosphoryl group (for example, dimethoxyphosphoryl and diphenylphosphoryl), and a sulfamoyl group (for example, N-ethylsulfamoyl, N,N-dipropylsulfamoyl, N-(2-dodecyl oxyethyl) sulfamoyl, N-ethyl-N-dodecylsulfamoyl and N,N-diethysulfamoyl).

Examples of a substituent exhibiting a σp value of 0.35 or more include a cyano group, a nitro group, a carboxyl group, a fluorine substituted alkyl group (for example, trifluoromethyl and perfluorobutyl), an aliphatic, aromatic or a heterocyclicacyl group (for example, acetyl, benzoyl and formyl), an aliphatic, aromatic or a heterocyclicsulfonyl group (for example, trifluoromethanesulfonyl, methanesulfonyl and benzenesulfonyl), a carbamoyl group (for example, carbamoyl, methylcarbamoyl, and phenylcarbamoyl and 2-chlorophenylcarbamoyl), an alkoxycarbonyl group (for example, methoxycarbonyl, ethoxycarbonyl and diphenylmethylcarbonyl), a fluorine or sulfonyl substituted aromatic group (for example, pentafluorophenyl and pentafluorophenyl), a heterocyclic residue (for example, 1-tetrazolyl), an azo group (for example, phenylazo), an alkylsulfonyloxy group (for example, methanesulfonyloxy), a phosphoryl group (for example, dimethoxyphosphoryl and diphenylphosphoryl), and a sulfamoyl group.

Examples of a substituent exhibiting a σp value of 0.60 or more include a cyano group, a nitro group, and an aliphatic, aromatic or a heterocyclicsulfonyl group (for example, trifluoromethanesulfonyl, difluoromethanesulfonyl, methanesulfonyl and benzenesulfonyl).

Preferable examples of E¹ and E² include a halogenated alkyl group (specifically a fluorine substituted alkyl group), a carbonyl group, a cyano group, an alkoxycarbonyl group, an alkylsulfonyl group, and an alkylsulfonyloxy group).

Concrete examples a metal-containing compound represented by Formula (3) will be shown below, however, the present invention is not limited thereto.

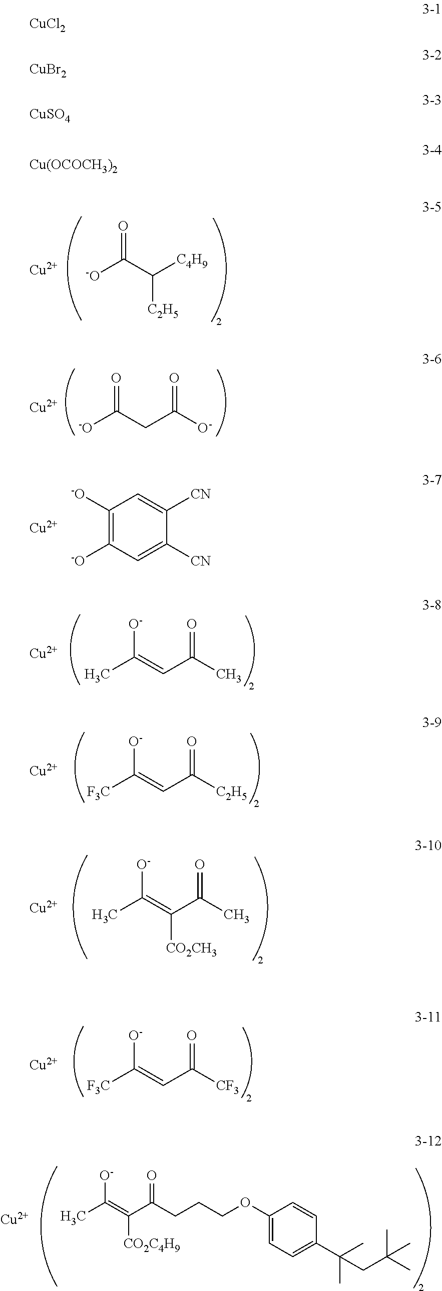

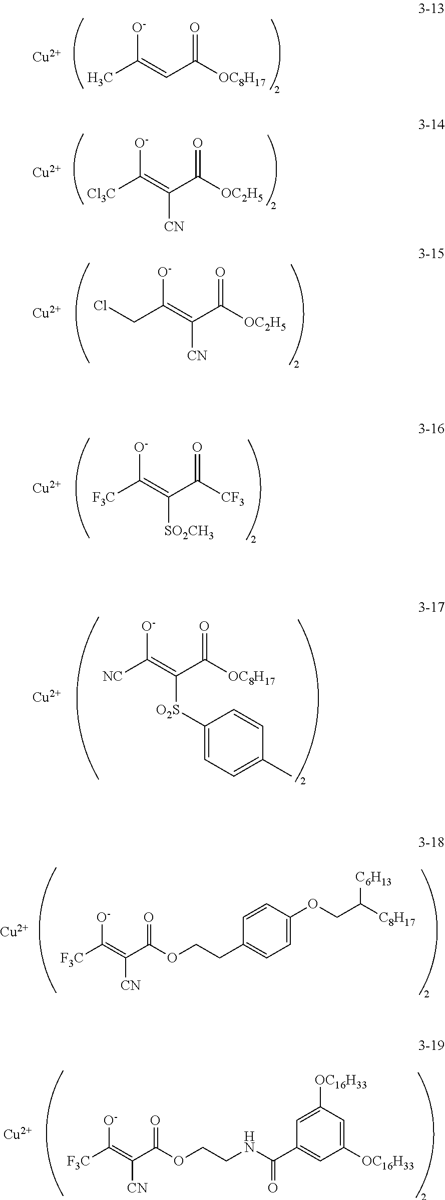

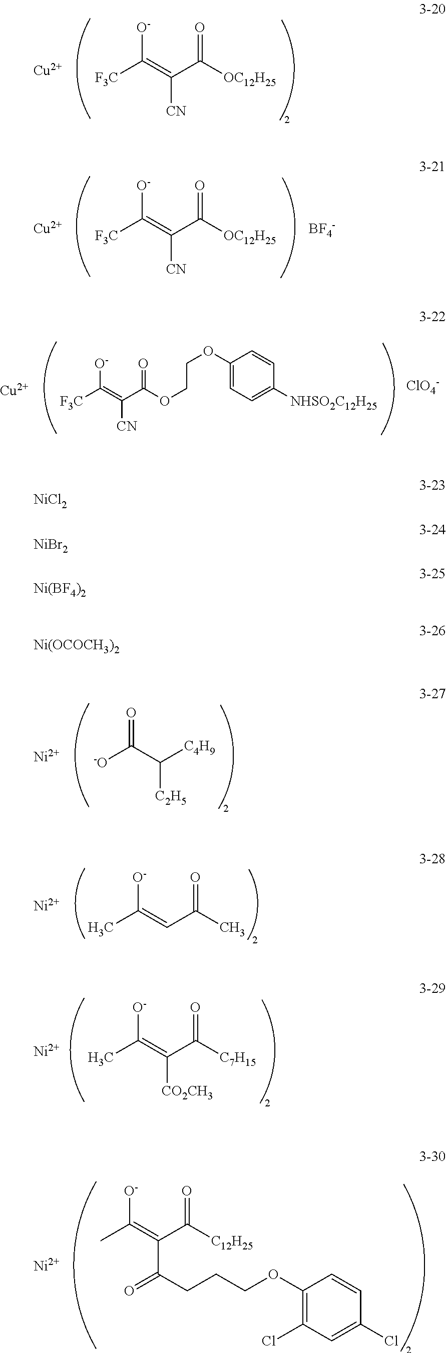

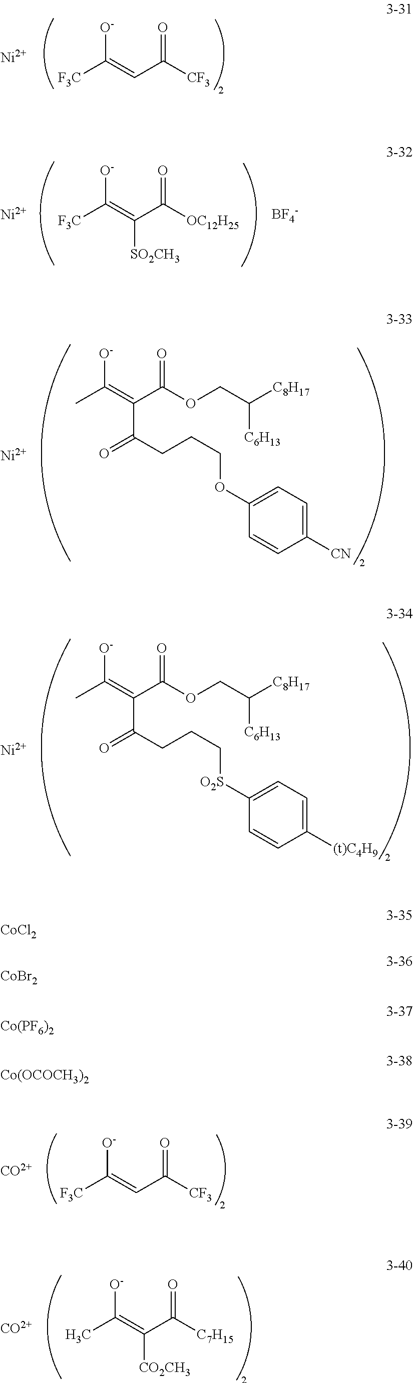

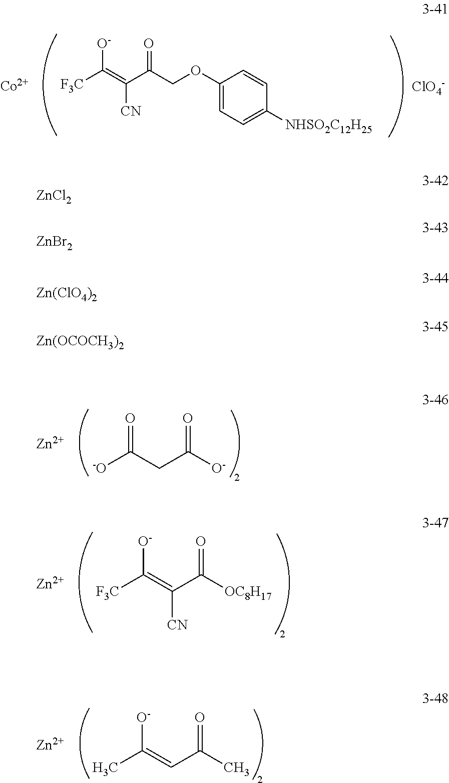

Next, a compound represented by Formula (Sb) will be explained.

In Formula (Sb), R⁵¹ and R⁵² each independently represent a hydrogen atom, an alkyl group, a cycloalkyl group, an alkenyl group, an alkynyl group, an aryl group, a heteroaryl group, a heterocycle group, an alkoxycarbonyl group, an aryloxycarbonyl group, an acyl group, a carbamoyl group, an alkylsulfonyl group and an arylsulfonyl group. As concrete examples, the examples described for aforementioned R¹¹-R¹⁴ may be cited.

These groups may further be substituted, and examples of such a substituent include, in addition to the above examples, an alkoxy group, a cycloalkoxy group, an aryl oxygroup, an alkylthio group, a cycloalkylthio group, an arylthio group, a sulfamoyl group, an acyloxy group, an acylamino group, a sulfonylamino group, an ureido group, a sulfinyl group, an amino group, a cyano group, a nitro group, a halogen atom and a halogenized alkyl group. As concrete examples of the above groups, the examples described for aforementioned R¹¹-R¹⁴ may be cited.

Preferable examples of R⁵¹ and R⁵² include a hydrogen atom, an alkyl group, a cycloalkyl group, an aryl group, a heteroaryl group, an acyl group and a sulfonyl group. R⁵¹ and R⁵² may be the same of different as far as these groups are those which are capable of being substituted.

R⁵³ represents ═N⁺(R⁵⁴) R⁵⁵ or ═O⁺R⁵⁶, and R⁵⁴ and R⁵⁵ each have the same meaning as aforementioned R⁵¹ and R⁵², respectively and may be the same as R⁵¹ and R⁵², or may be different.

R⁵⁶ represents a hydrogen atom or a substituent, R⁵⁶ is preferably a hydrogen atom, an alkyl group, a cycloalkyl group, an aryl group or an acyl group, and more preferably a hydrogen atom, an alkyl group or an aryl group.

X⁵¹-X⁵⁴ and Y⁵¹-Y⁵⁴ each represent —C(R⁵⁷)═ or and R⁵⁷ represents a hydrogen atom or a substituent. Preferable examples of R⁵⁷ include a hydrogen atom, a halogen atom, an alkyl group, an aryl group, an acyl group, an alkoxy group, an acylamino group, a sulfonylamino group, an alkylsulfonyl group, a hydroxyl group and an amino group, and more preferably include a hydrogen atom, an alkyl group, a hydroxyl group, an acylamino group and a sulfonylamino group. When a plurality of groups are —C(R⁵⁷)═, the plurality of R⁵⁷ may be the same or different.

When a colorant represented by Formula (Sb) is a compound represented by following Formula (Sb-1) or (Sb-2), it is preferable since light resistance and heat-moisture resistance are further improved.

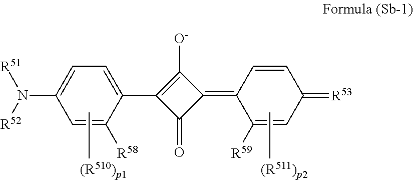

In the formula, R⁵¹-R⁵³ have the same meaning as R⁵¹-R⁵³ in aforementioned Formula (Sb). R⁵⁸ and R⁵⁹ each represent a hydroxyl group, an alkoxy group, an acylamino group or a sulfonylamino group, R⁵¹⁰ and R⁵¹¹ each represent a substituent, and p1 and p2 each represent an integer of 0-3.

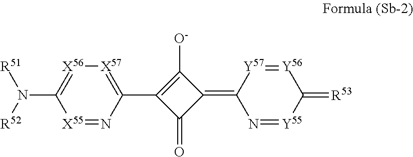

In the formula, R⁵¹-R⁵³ have the same meaning as R⁵¹-R⁵³ in aforementioned Formula (Sb). X⁵⁵-X⁵⁷ and Y⁵⁵-Y⁵⁷ each represent —C(R⁵¹²)═ or —N═, and R⁵¹² represents a hydrogen atom or a substituent.

In Formula (Sb-1), R⁵¹⁰ and R⁵¹¹ each represent a substituent. examples of which include a halogen atom, an alkyl group, an aryl group, an acyl group, an alkoxy group, an acylamino group, a sulfonylamino group, an alkylsulfonyl group, a hydroxyl group and an amino group, and preferably include a halogen atom, an alkyl group, an acyl group, an alkoxy group, an acy amino group, a sulfonylamino group and a hydroxyl group.

Each of p1 and p2 represents an integer of 0-3. When p1 or p2 is two or more, a plurality of R⁵¹⁰ or R⁵¹¹ may be the same or different p1 or p2 each are preferably 0 or 1.

In Formula (Sb-2), as examples of R⁵¹², the groups described for R⁵¹⁰ and R⁵¹¹ may be cited. In X⁵⁵-X⁵⁷, —N═ is preferably 0 or 1, and, also in Y⁵⁵—Y⁵⁷, —N═ is preferably 0 or 1.

Concrete examples a colorant represented by Formula (Sb) will be shown below, however, the present invention is not limited thereto. Moreover, when there is a tautomer, the tautomers are represented by only one kind of description, however, it is not limited to the tautomer, and also a mixture of the tautomers are included.

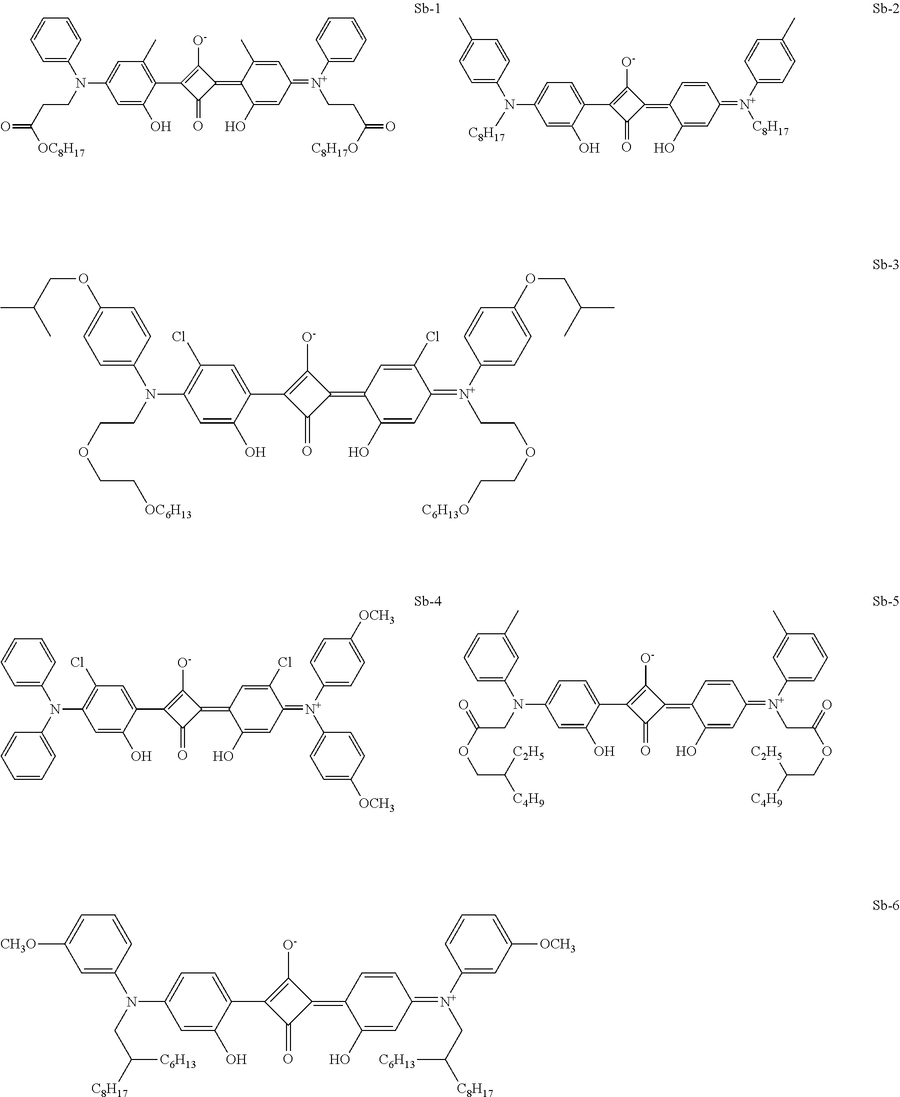

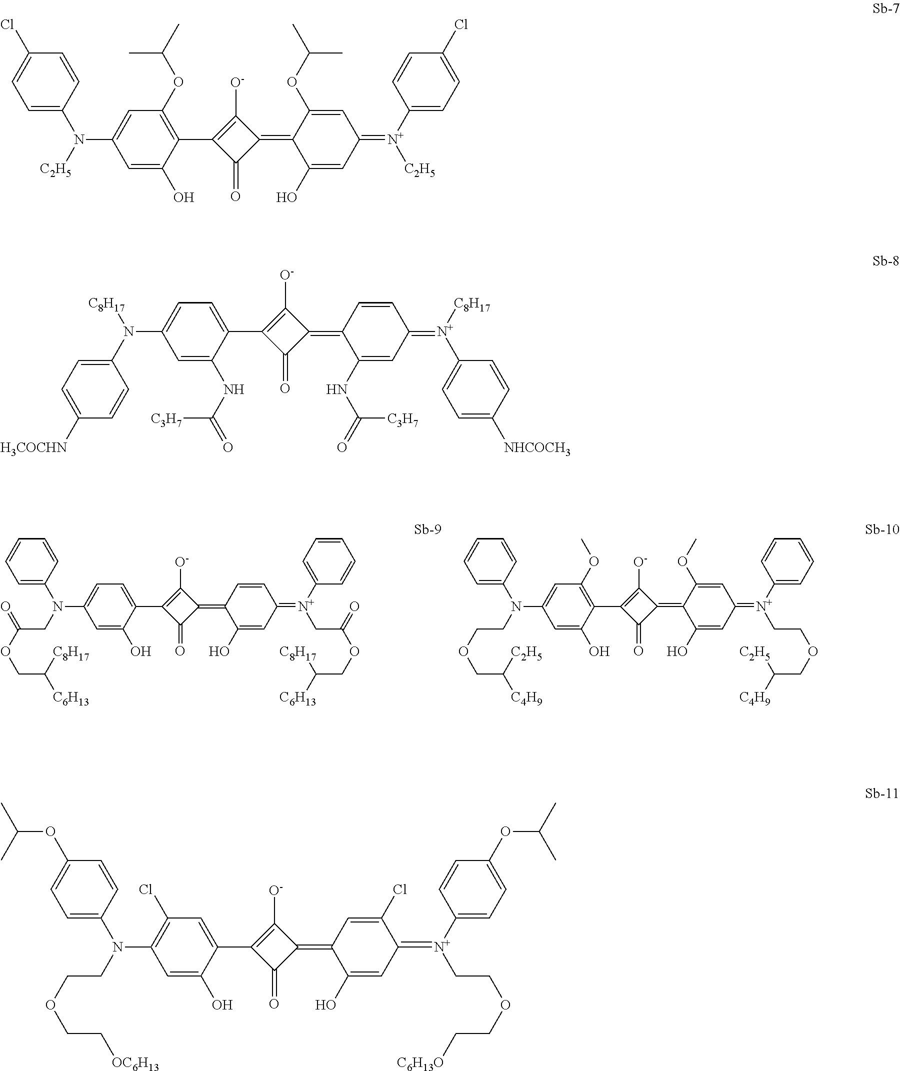

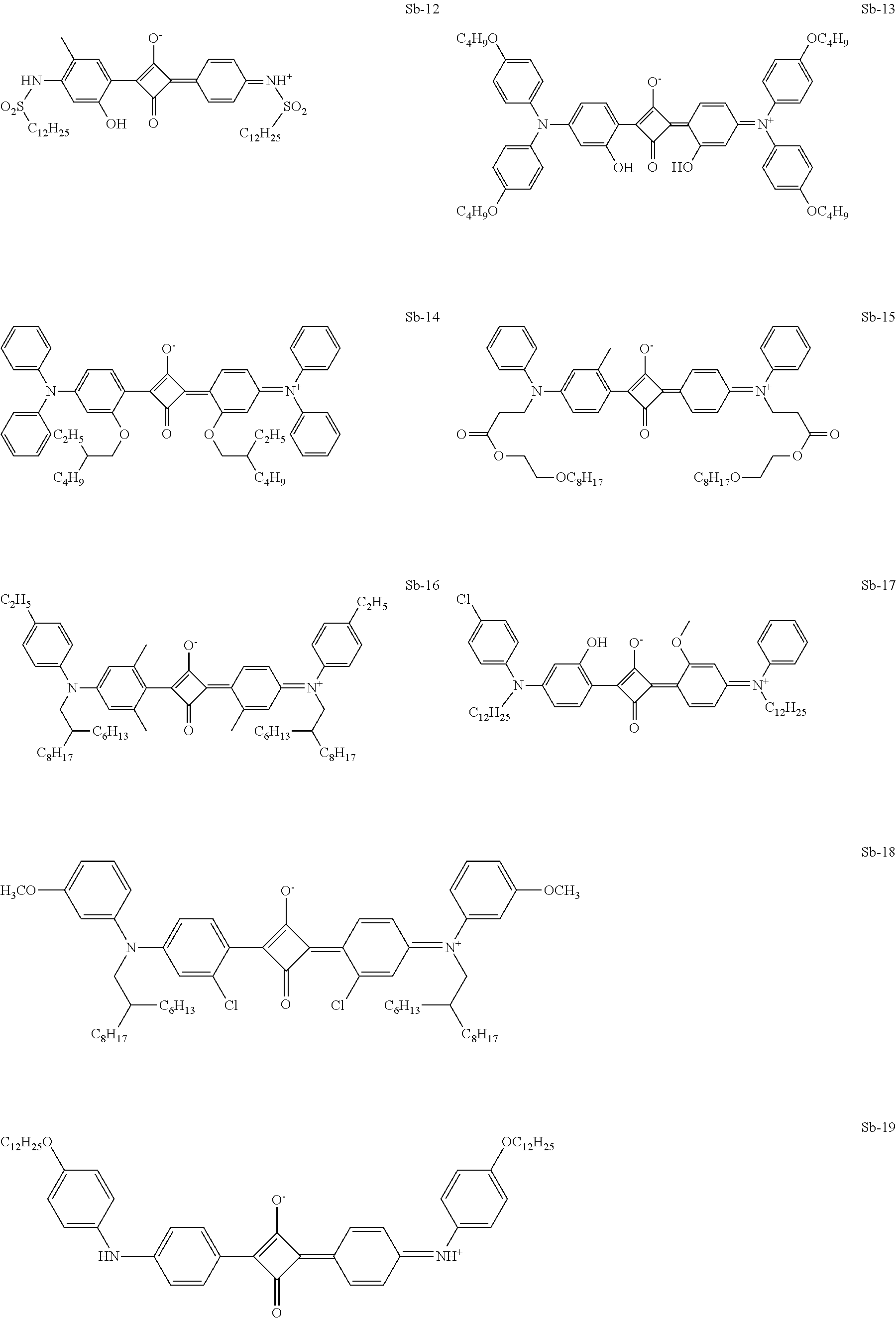

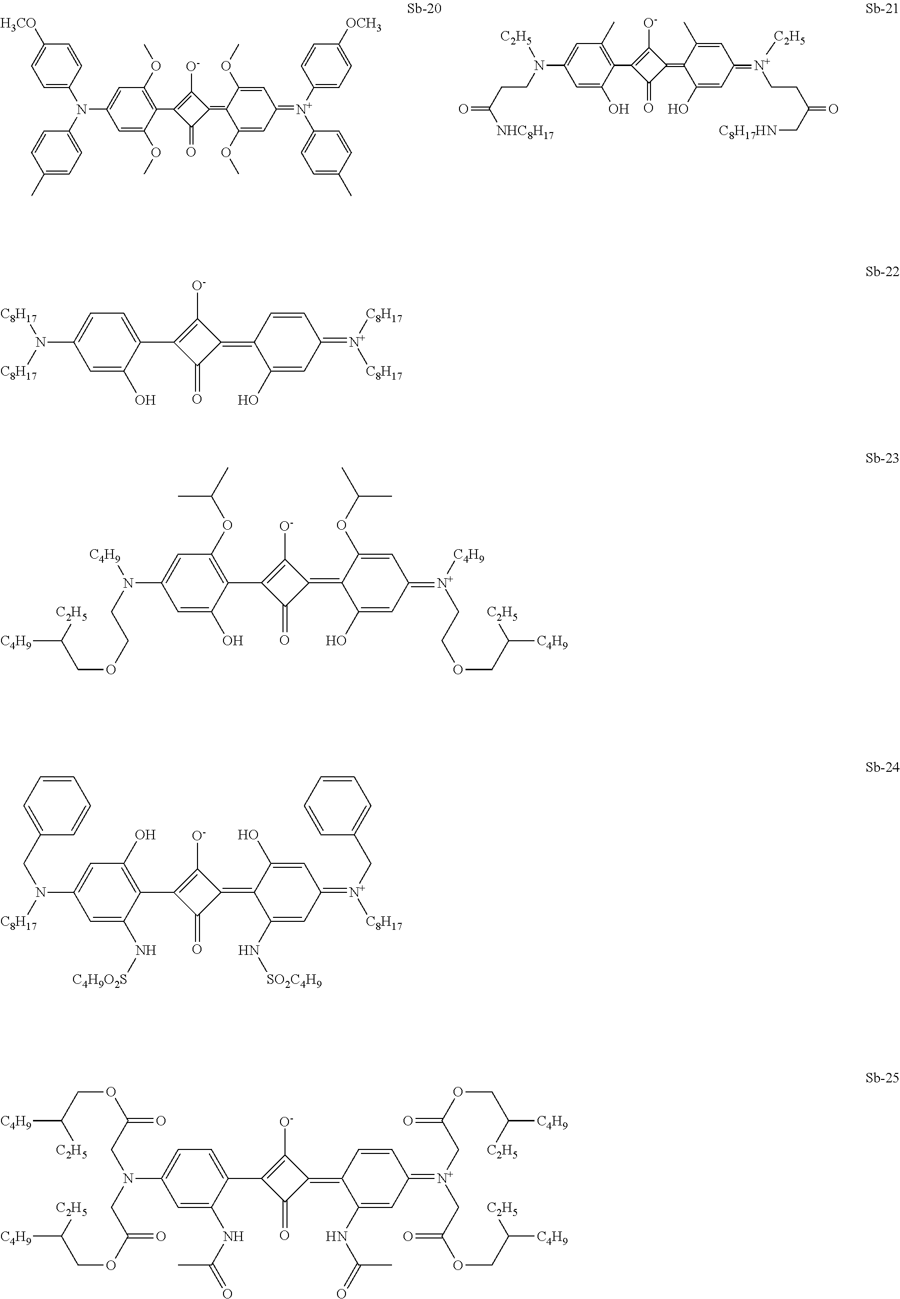

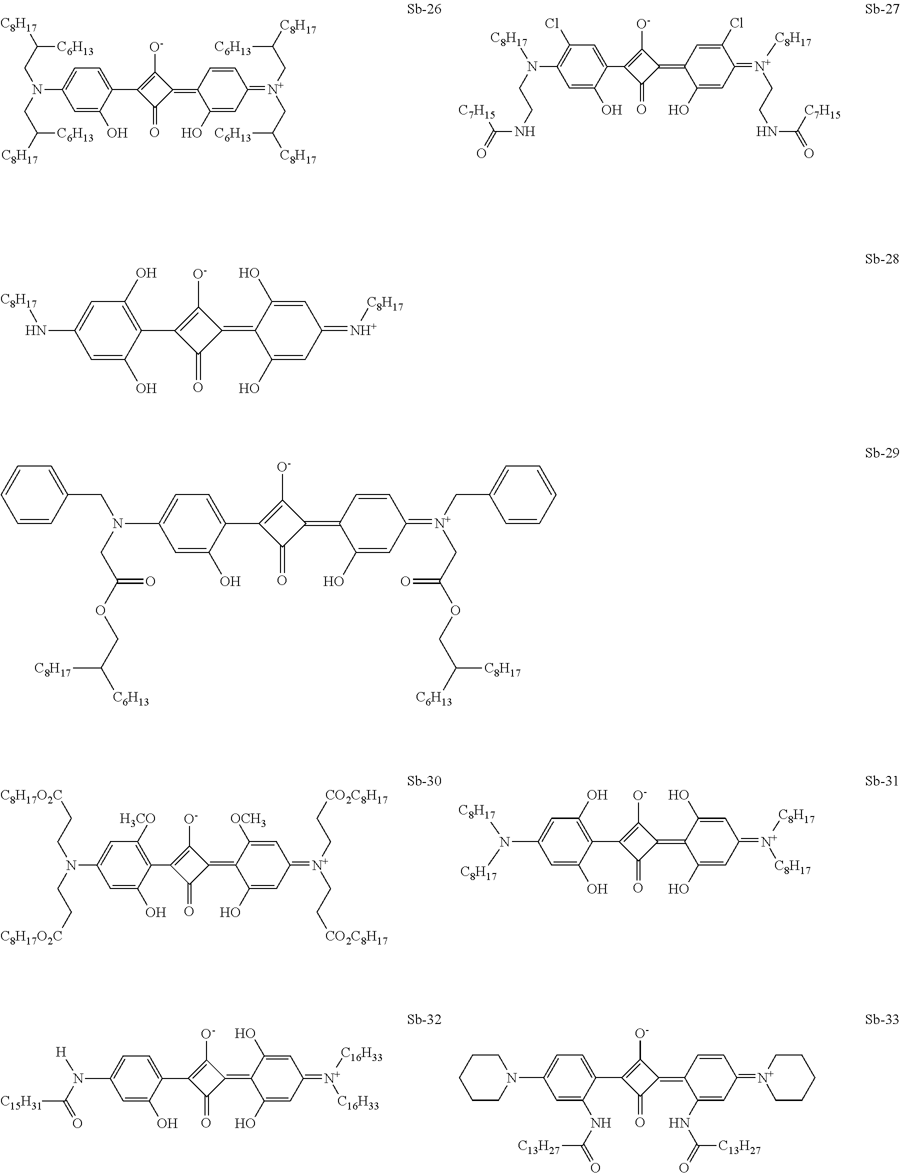

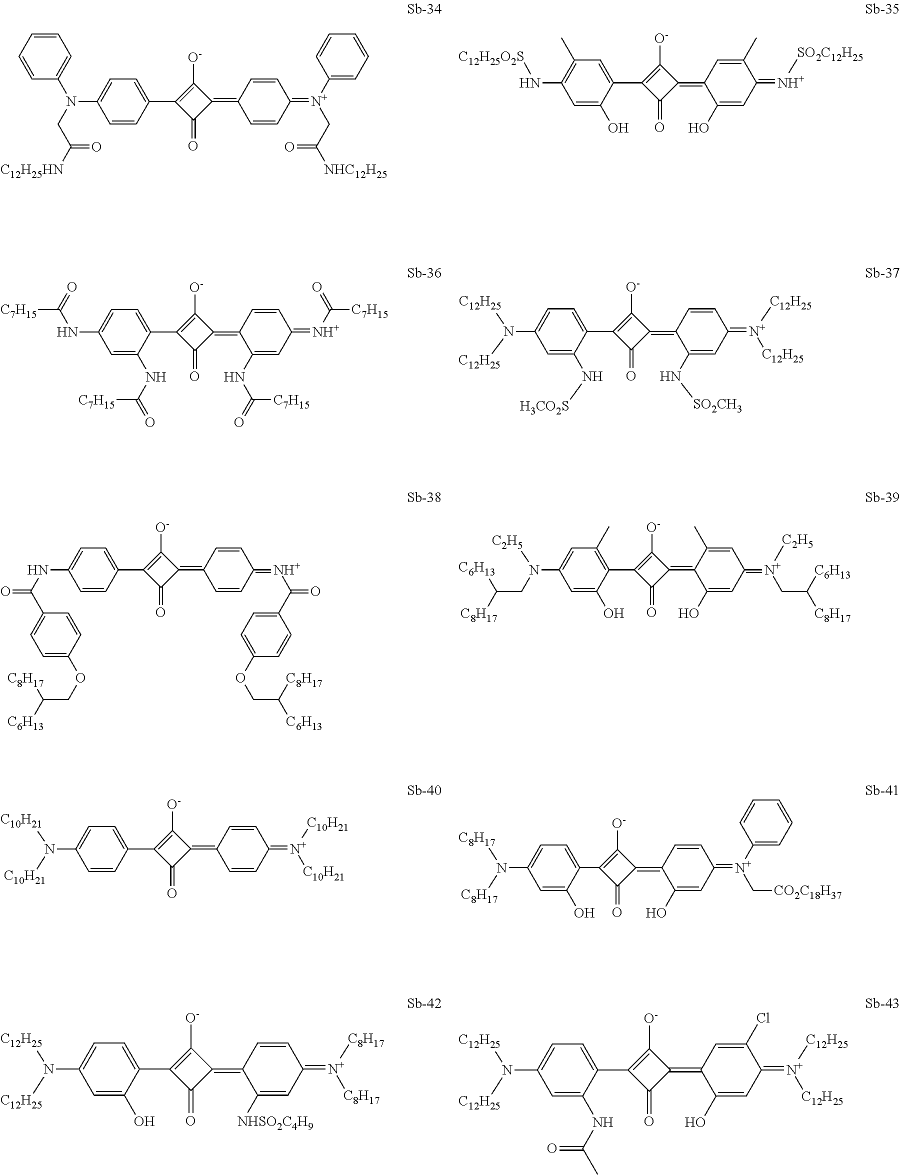

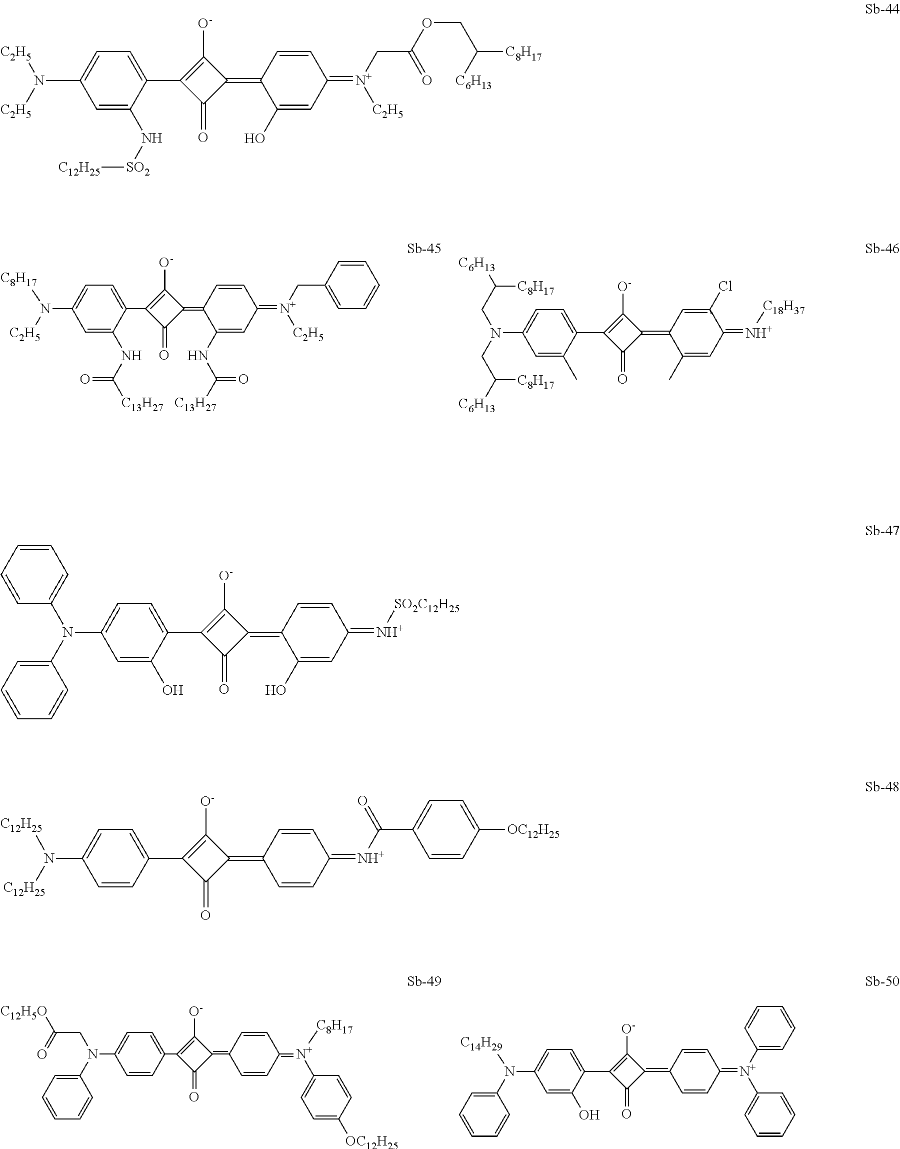

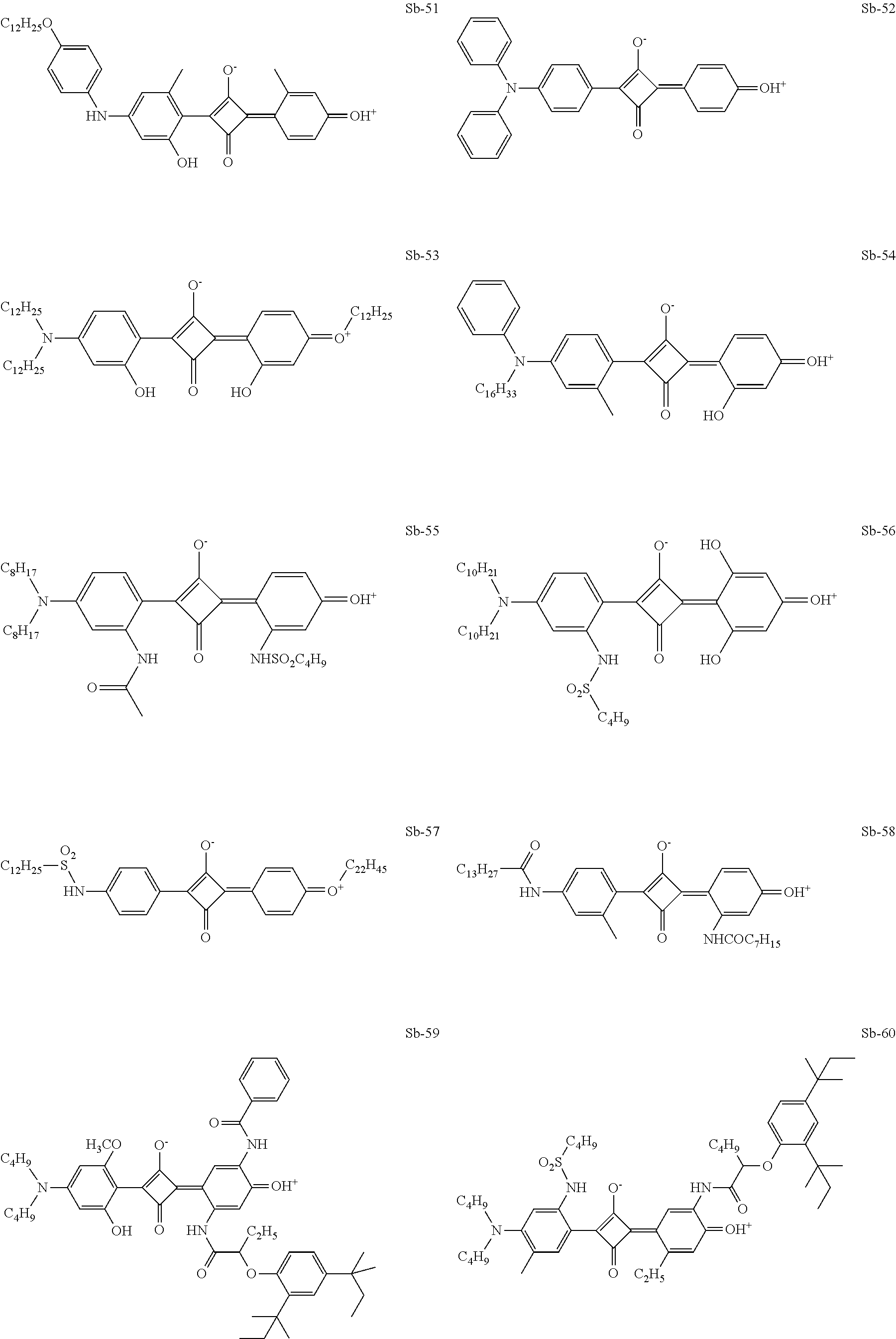

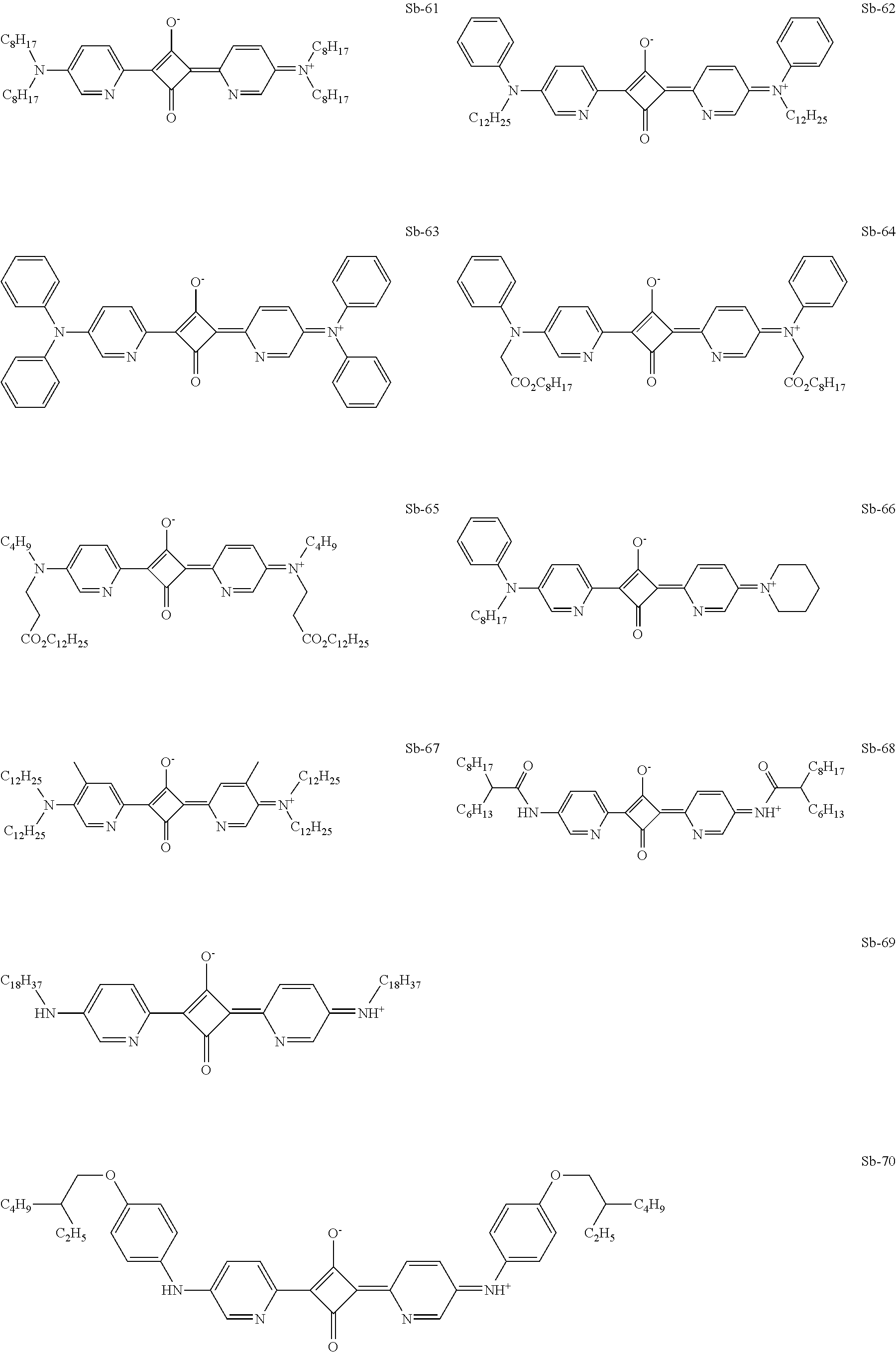

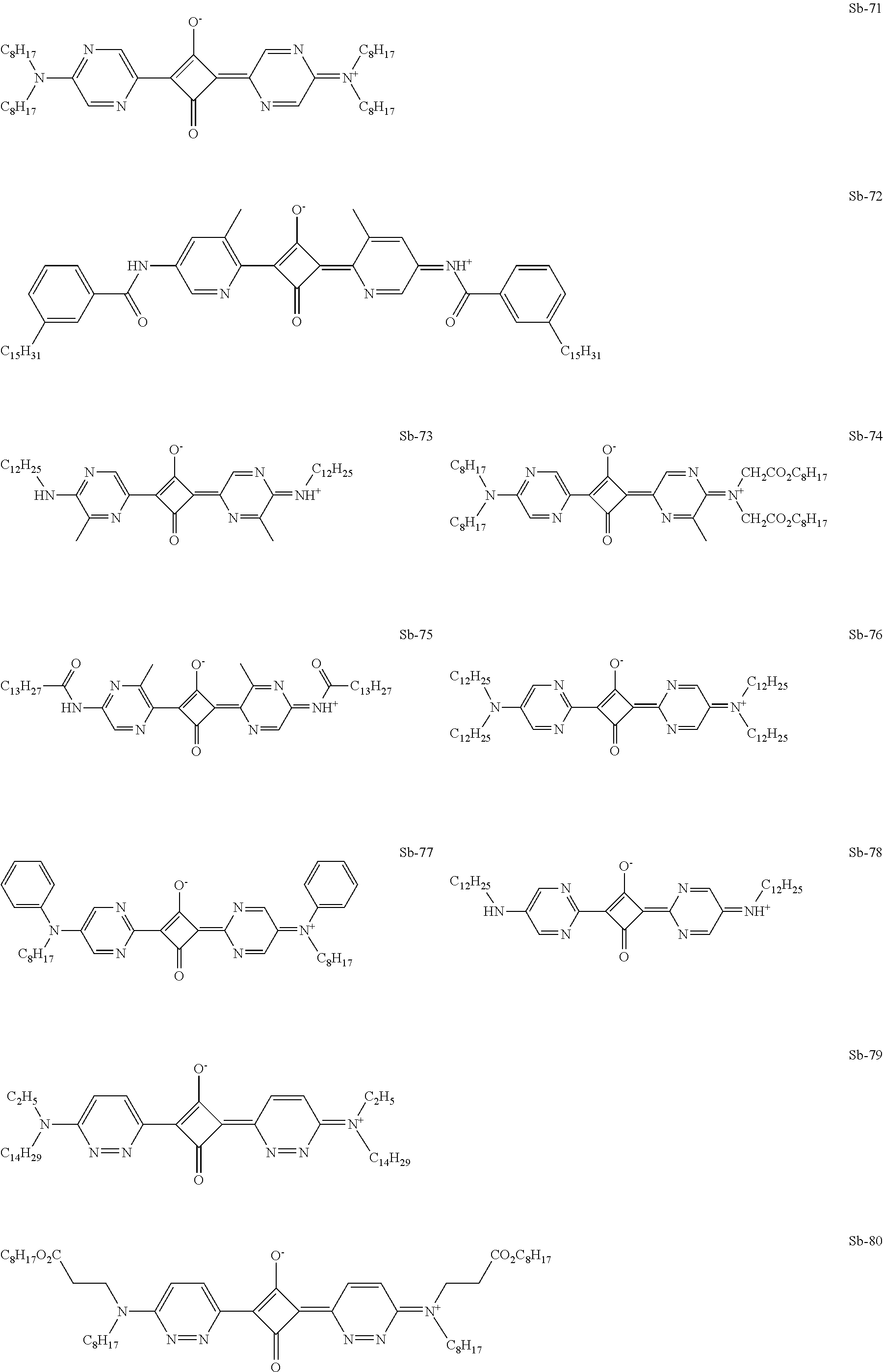

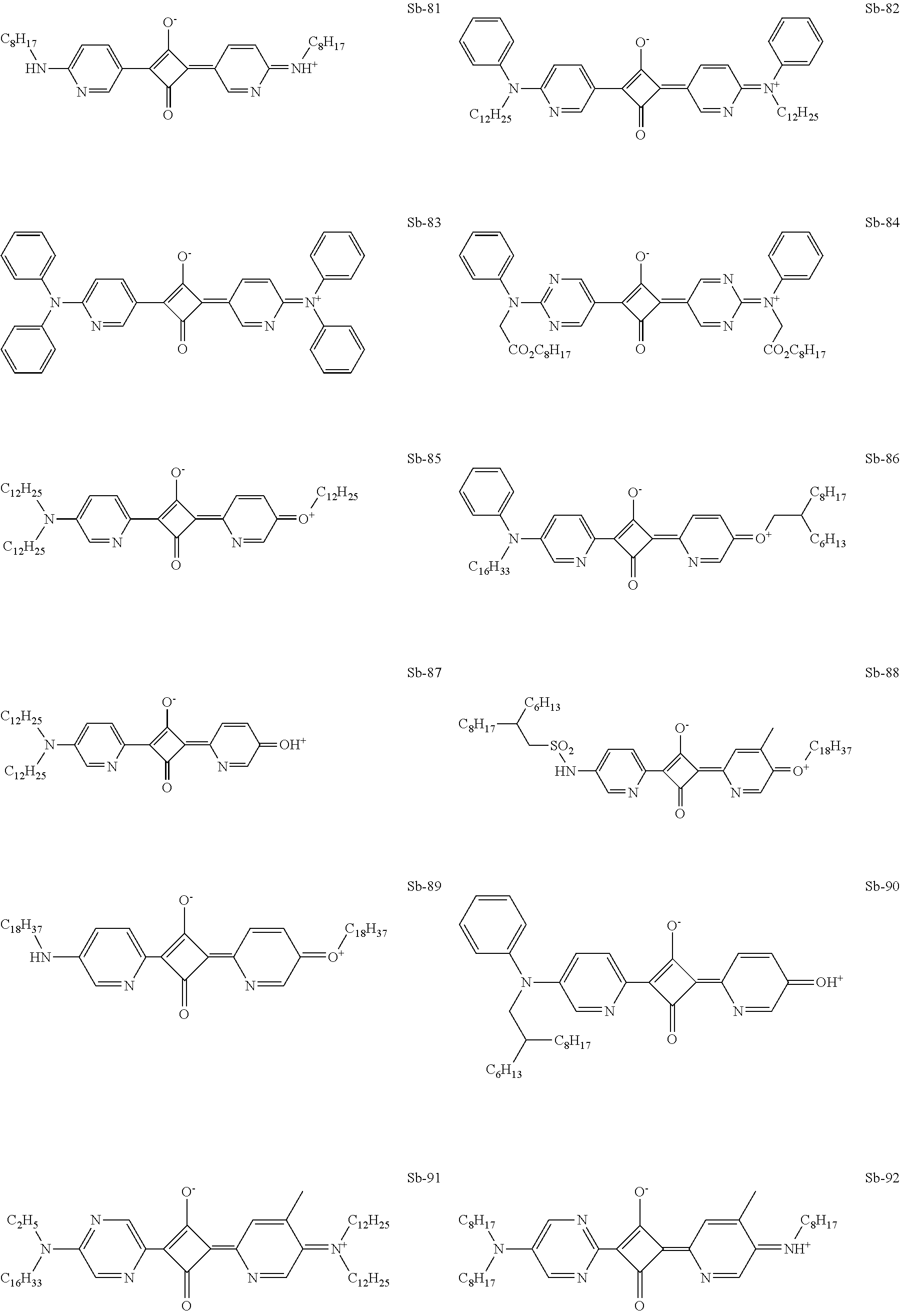

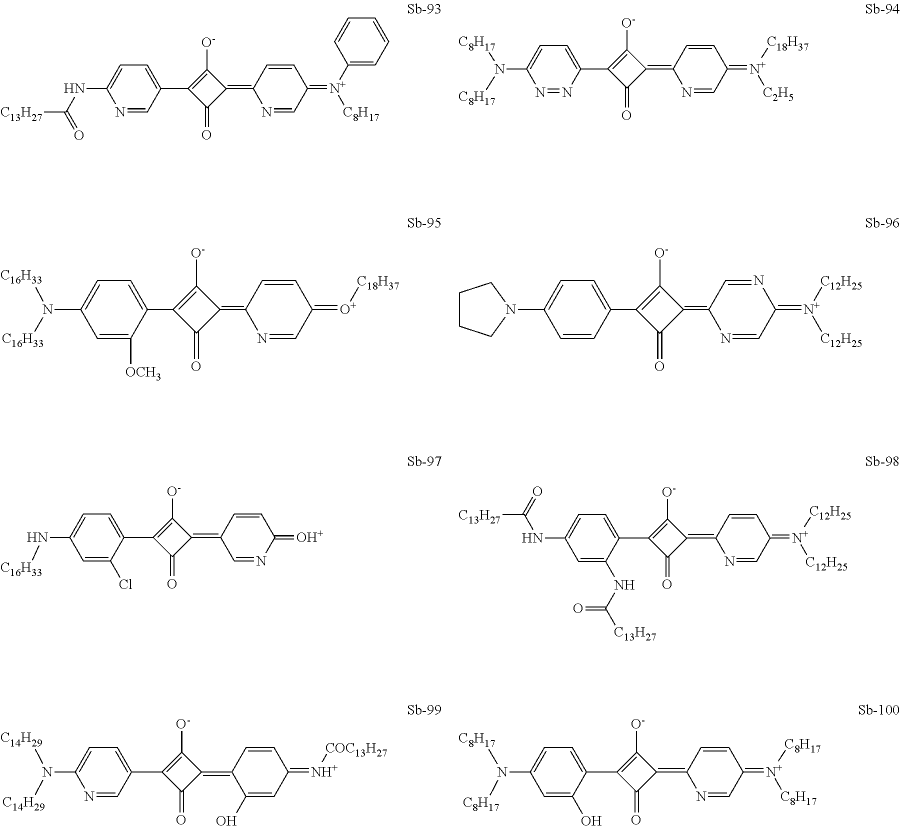

When using the compound represented by Formula (Sb) as a colorant, it is preferable that a compound represented by Formula (4) is contained.

Cu(Xa)n(Xb) Formula (4)

In Formula (4), Xa represents an anion, n represents 1 or 2, Xb represents a counter ion necessary to neutralize the charge, if needed.

As examples of an anion represented by Xa, the examples described for X⁵ in aforementioned Formula (2) may be cited, and, also, the preferable examples thereof are the same.

Examples of a counter ion represented by Xb include a halogen ion, an enolate, a hydroxyl ion, a perchloric acid ion, a tetraalkylborate, PF₆⁻, BF₄⁻ and SbF₆⁻.

A compound represented by Formula (4) is preferably a compound represented by Formula (3). As examples of a concrete compound, the compounds containing Cu in the examples a concrete compound represented by Formula (3) may be cited, however, the present invention is not limited thereto.

Next, a compound represented by Formula (Sc) will be explained.

In Formula (Sc), R⁶¹ and R⁶² each represent a substituent. As such a substituent, preferable is an aromatic group which may have a substituent or an aliphatic group which may have a substituent. The number of carbon atoms in the aromatic group is preferably 1-16, and more preferably 5 or 6. The number of carbon atoms in the aliphatic group is preferably 1-18, and more preferably 4-18, while the total number of carbon atoms in R⁶¹ and R⁶² is preferably 17 or more. Examples of a non-substituted aliphatic group and a non-substituted aromatic group include a methyl group, an ethyl group, an n-propyl group, an n-butyl group, an n-octyl group, an n-decyl group, an i-hexadecyl group, a phenyl group and a naphthyl group.

In Formula (Sc), examples of a substituent represented by R⁶³ and R⁶⁶ include an alkyl group, a cycloalkyl group, an alkenyl group, an alkynyl group, an aryl group, a heteroaryl group, a heterocycle group, an alkoxy group, a cycloalkoxy group, an aryloxy-group, an alkylthio group, a cycloalkylthio group, an arylthio group, an alkoxycarbonyl group, an aryloxycarbonyl group, a sulfamoyl group, an acyl group, an acyloxy group, an amide group (for example, a methylcarbonylamino group and an ethyl carbonylamino group, a dimethylcarbonylamino group, a propylcarbonylamino group, a pentylcarbonylamino group, a cyclohexylcarbonylamino group, a 2-ethylhexyl carbonyl amino group, an octylcarbonylamino group, a dodecylcarbonylamino group, a phenylcarbonylamino group, a naphthylcarbonylamino group), a carbamoyl group, an ureido group, a sulfinyl group, an alkylsulfonyl group, an arylsulfonyl group, an amino group, a cyano group, a nitro group and a halogen atom. These groups may further be substituted by a similar substituent.

Of these, examples of a preferable substituent include a hydrogen atom an alkyl group, an aryl group, a heterocycle group, a heteroaryl group, an alkoxy group, a sulfamoyl group, an ureido group, an amino group, an amide group, an acyl group, an alkoxycarbonyl group, a carbamoyl group, a cyano group and a halogen atom, and more preferably include an alkyl group, an aryl group, an alkoxy group, a cyano group and a halogen atom. A 5- or 6-membered ring may be formed by R⁶³ and R⁶⁴ or by R⁶⁵ and R⁶⁶, in which it is preferable to form a benzene ring.

In Formula (Sc), R⁶¹ and R⁶² may be the same or different, and R⁶¹ and R⁶² each are preferably an oxygen atom, a sulfur atom, or —CR⁶⁷R⁶⁸—. As examples of R⁶⁷ and R⁶⁸, the same groups described for aforementioned R⁶³ and R⁶⁶ may also be cited. Examples of a preferable substituent thereof include a hydrogen atom, an alkyl group and an aryl group, and it is preferable that the substituent further has a substituent.

In Formula (Sc), L⁶¹ and L⁶² each independently represent a non-substituted or substituted methine group. The methane group is preferably non-substituted, however, when it has a substituent, the substituent is preferably an alkyl group, an aryl group, a halogen atom, an alkoxycarbonyl group, a carbamoyl group or a cyano group.

When a compound represented by Formula (Sc) is used as a colorant, it may contain a compound represented by aforementioned Formula (2), (3) or (4).

Concrete examples a dye represented by Formula (Sc) will be shown below, however, the present invention is not limited thereto. Moreover, when there is a tautomer, the tautomers are represented by only one kind of description, however, it is not limited to the tautomer, and also a mixture of the tautomers are included.

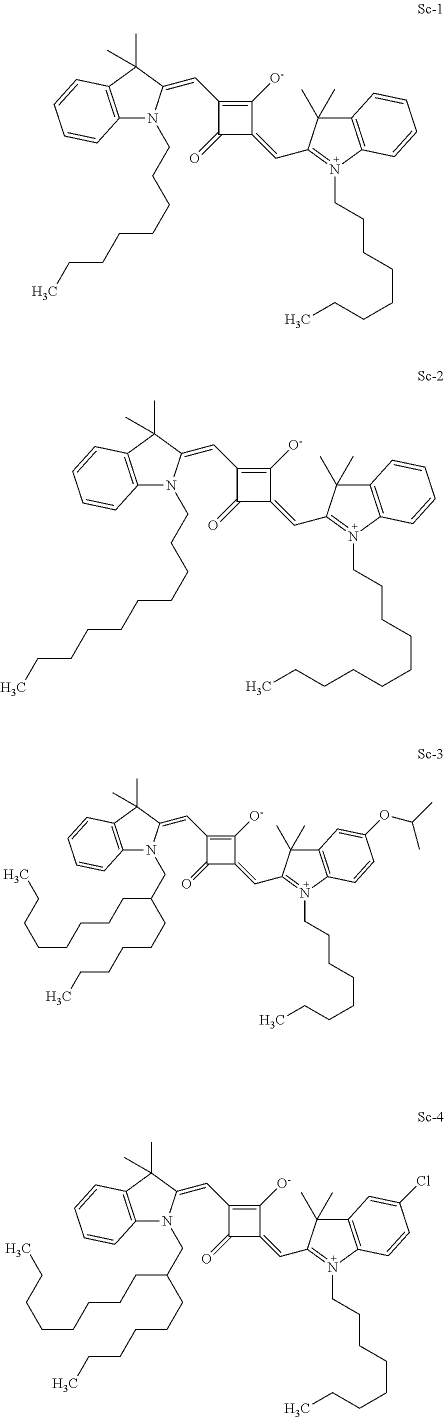

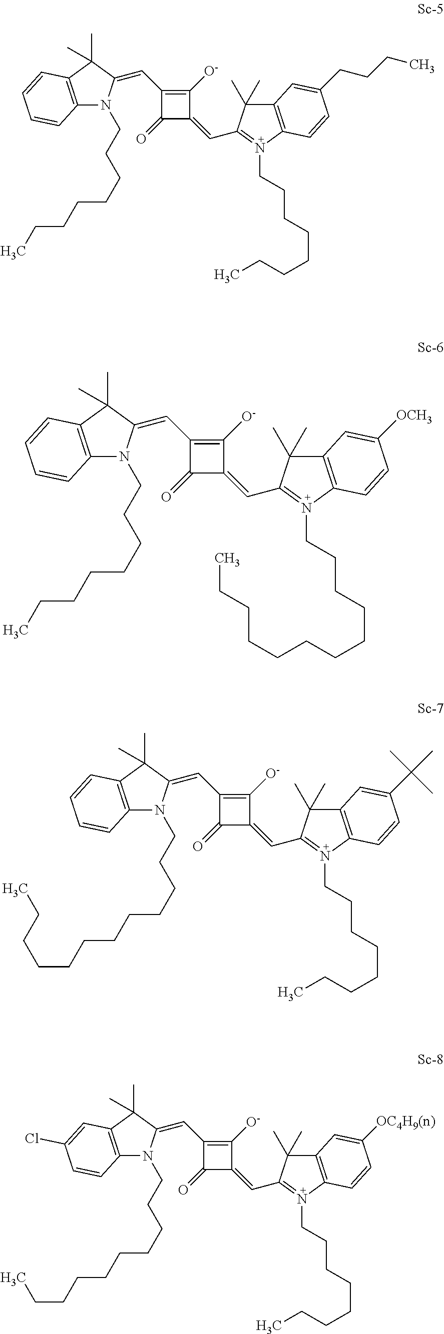

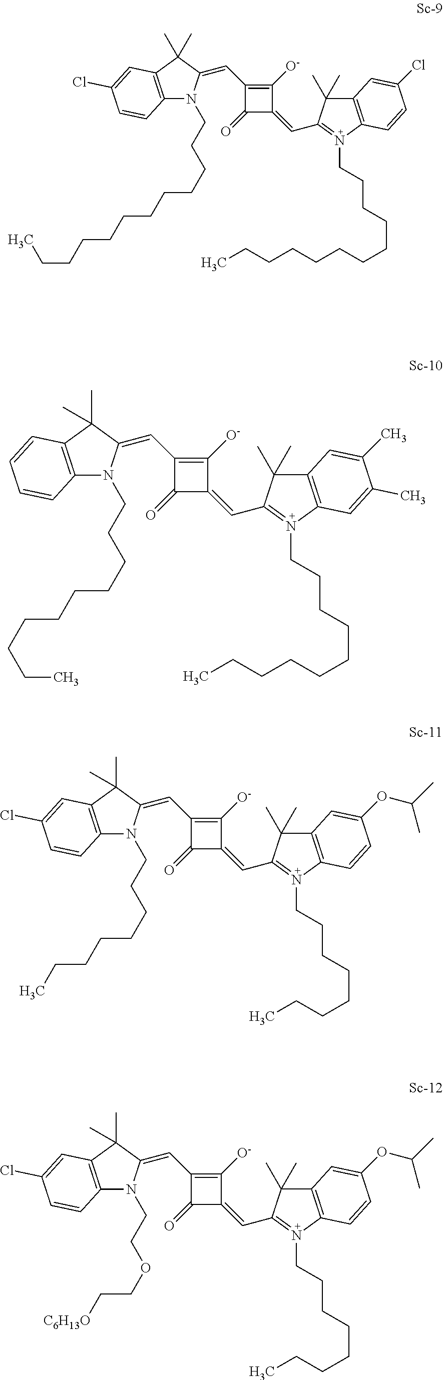

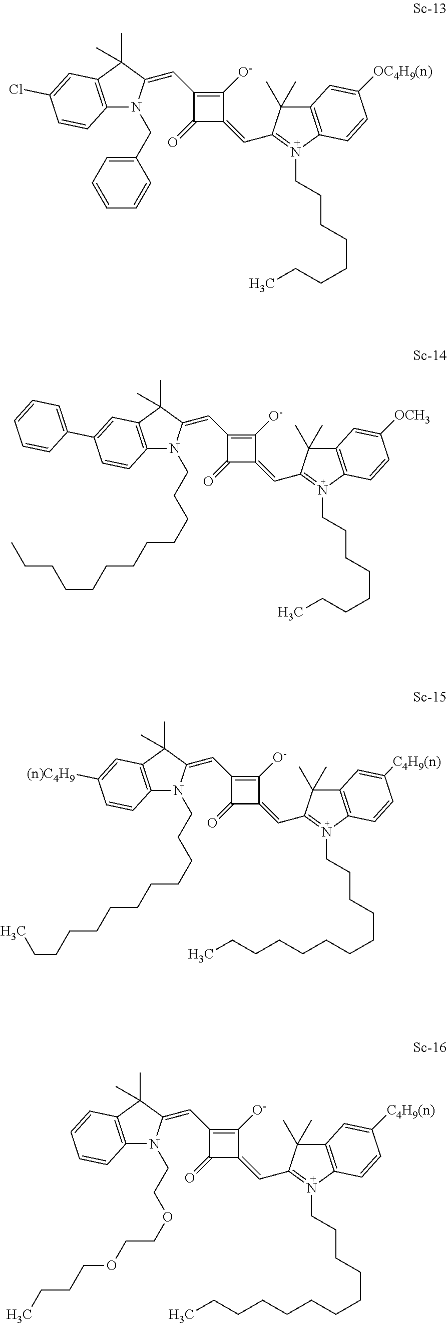

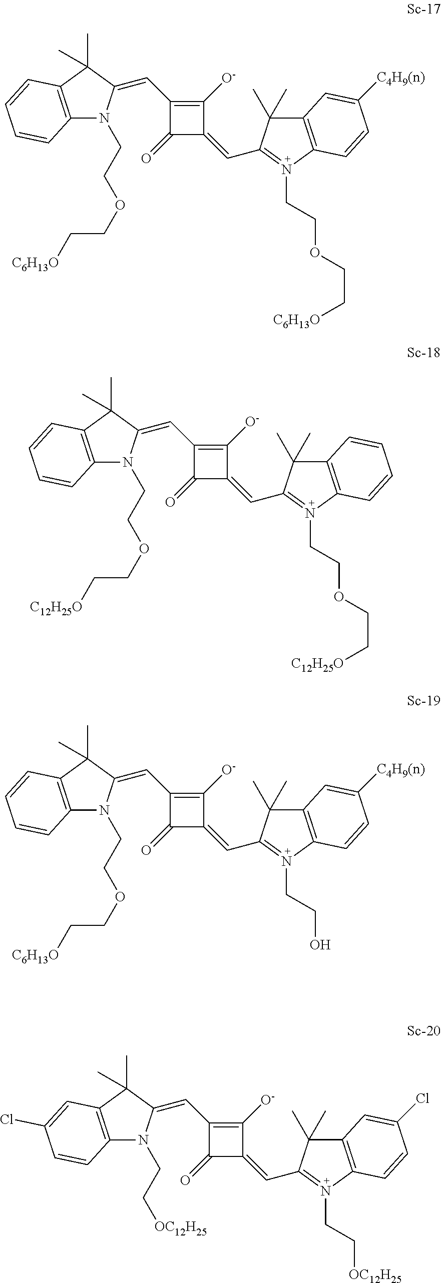

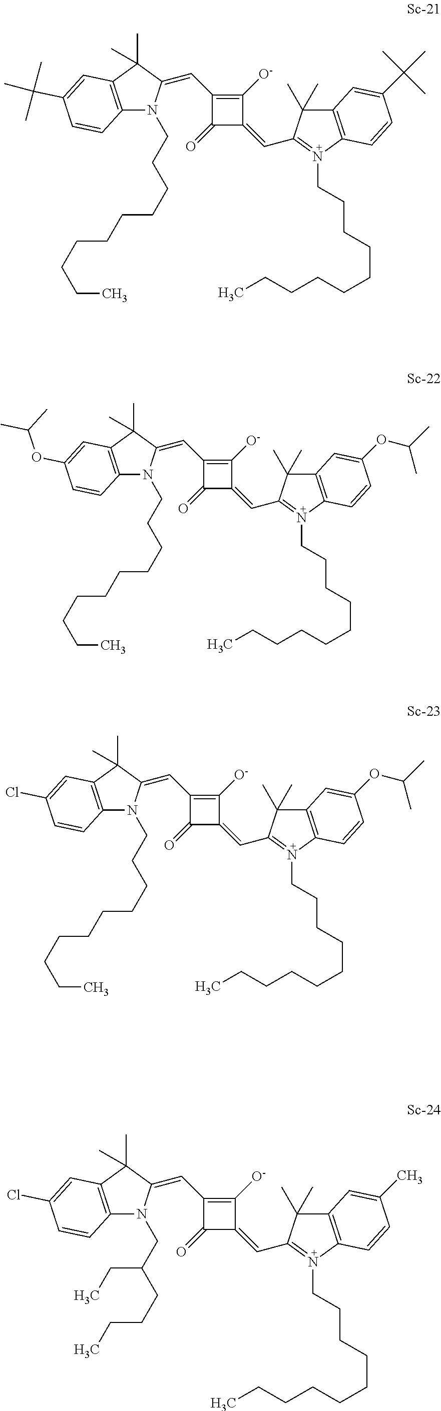

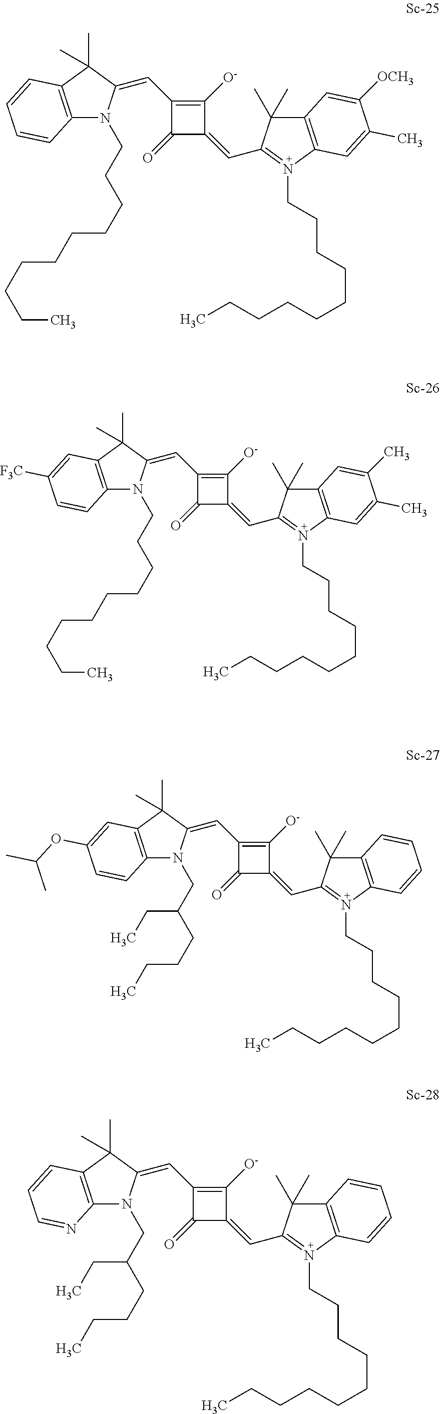

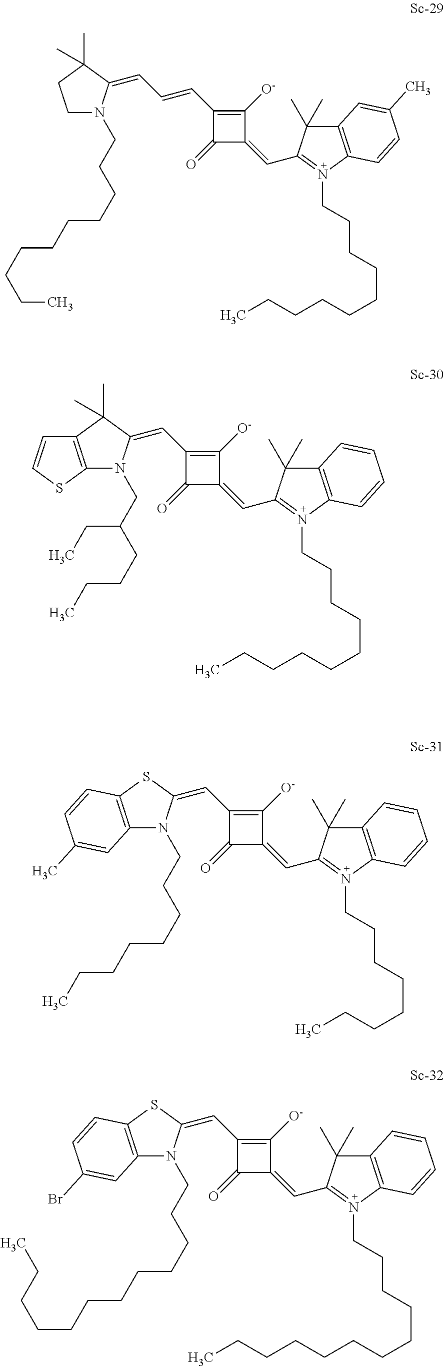

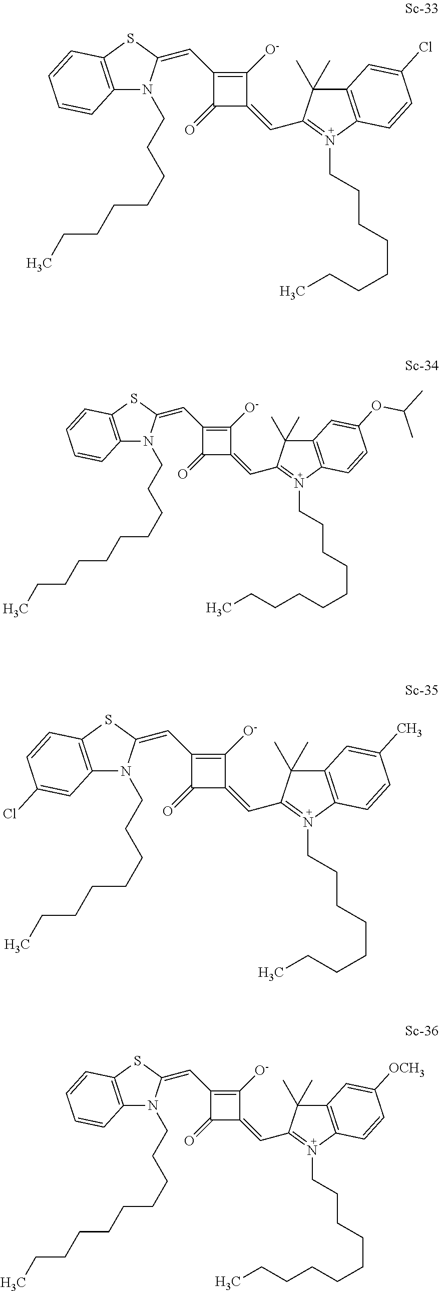

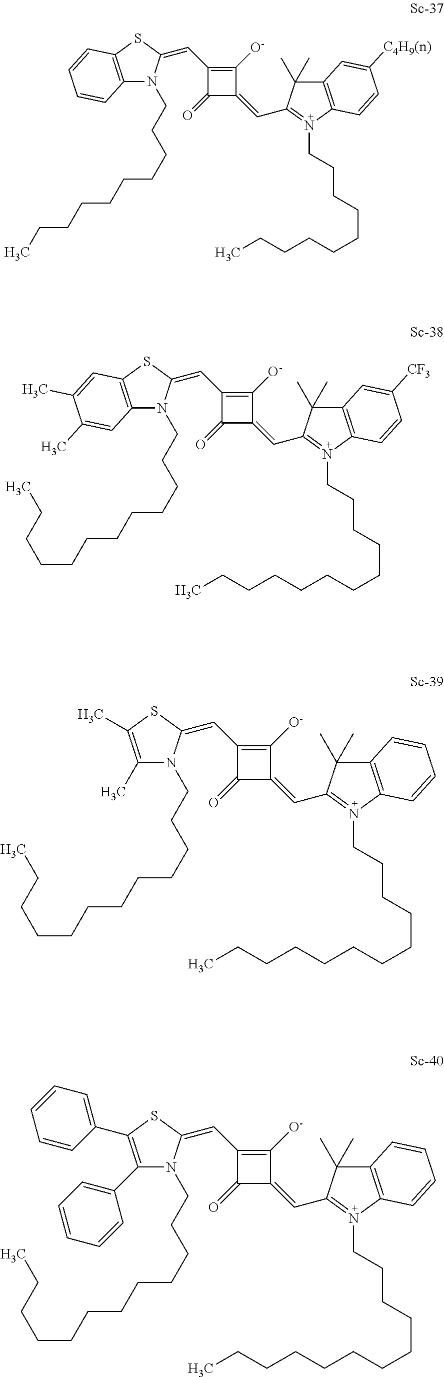

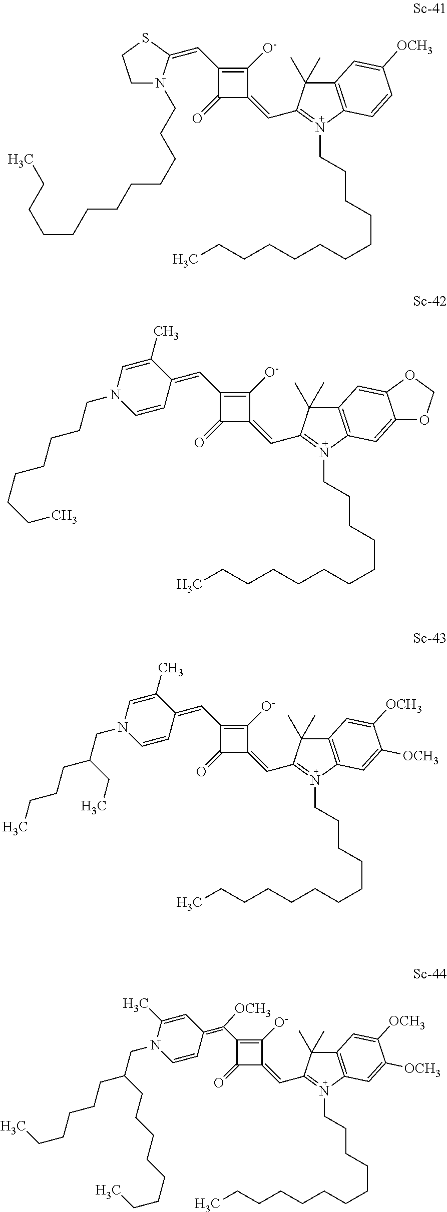

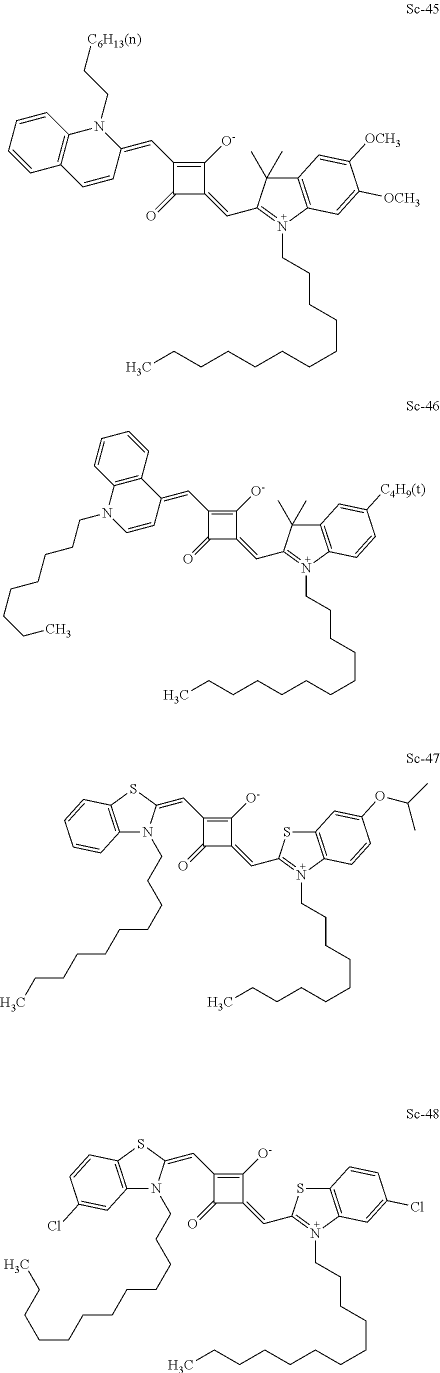

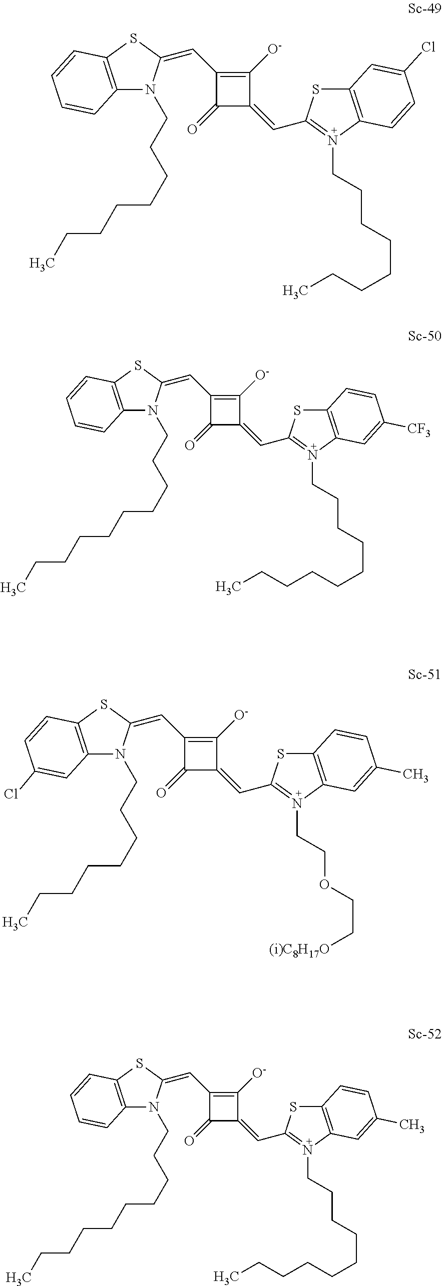

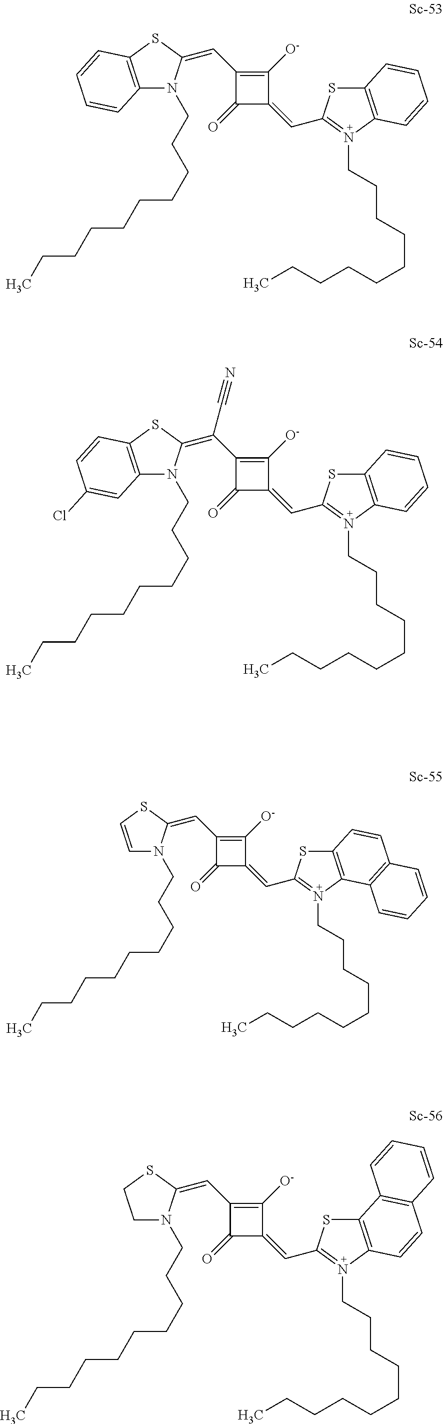

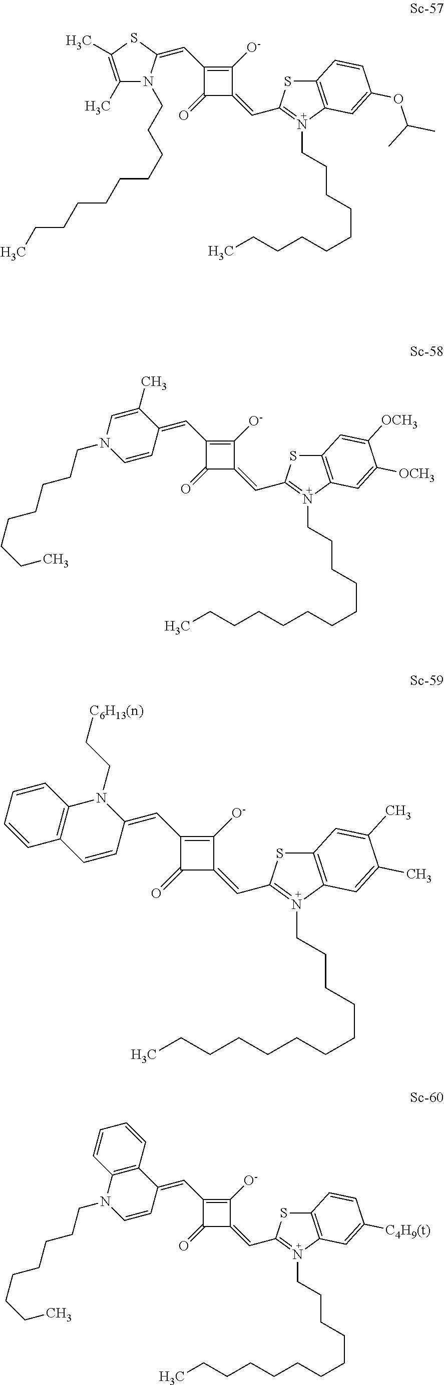

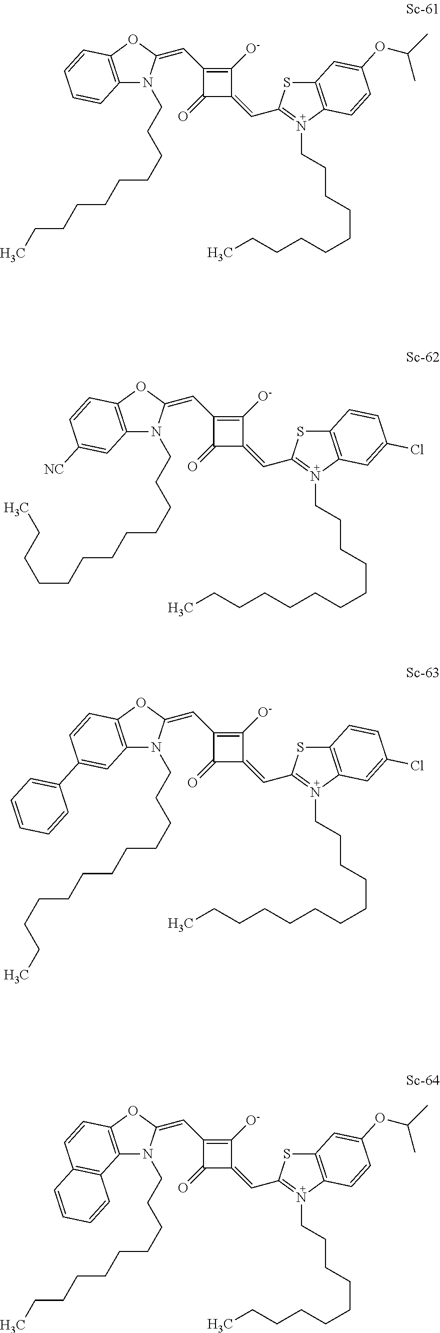

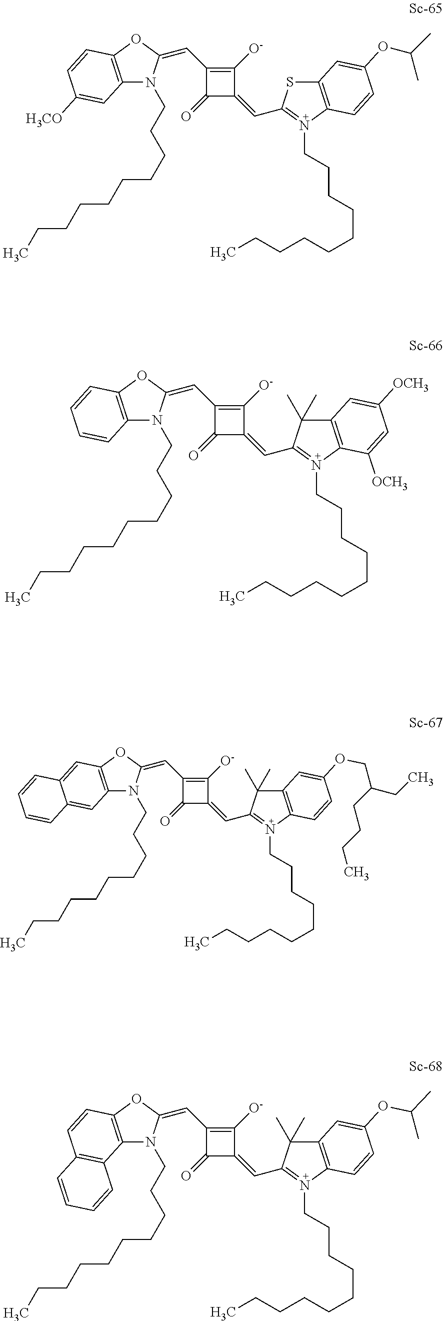

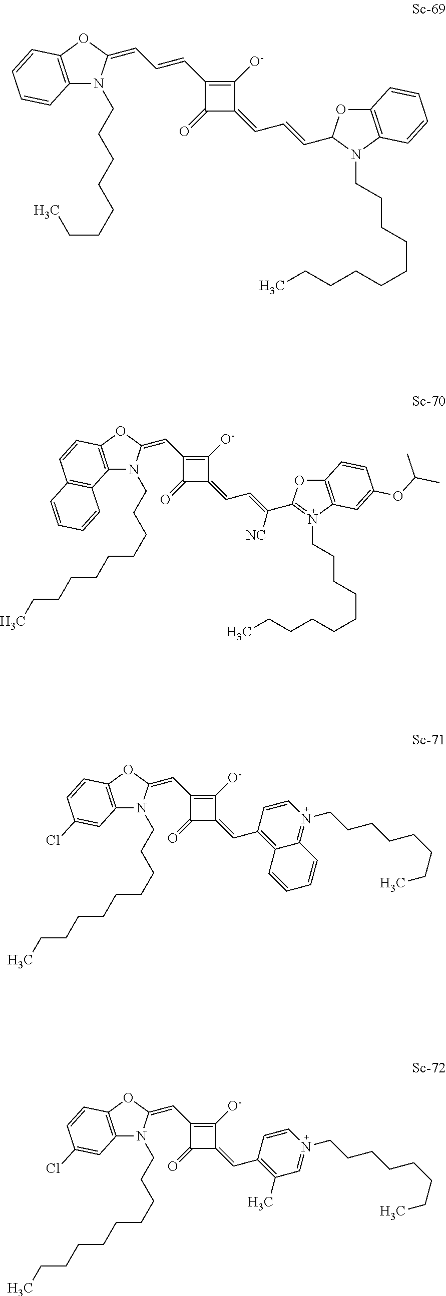

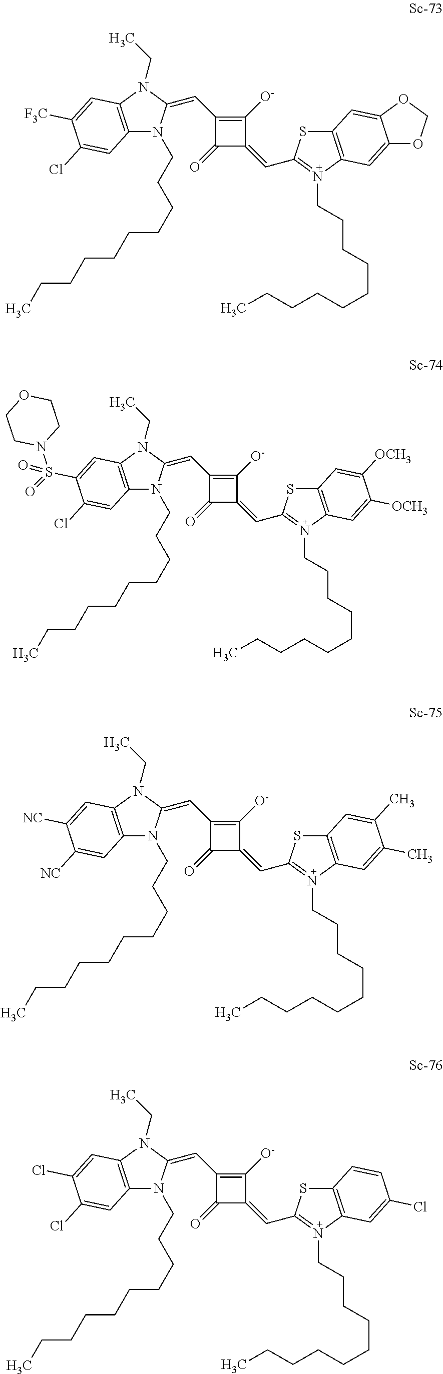

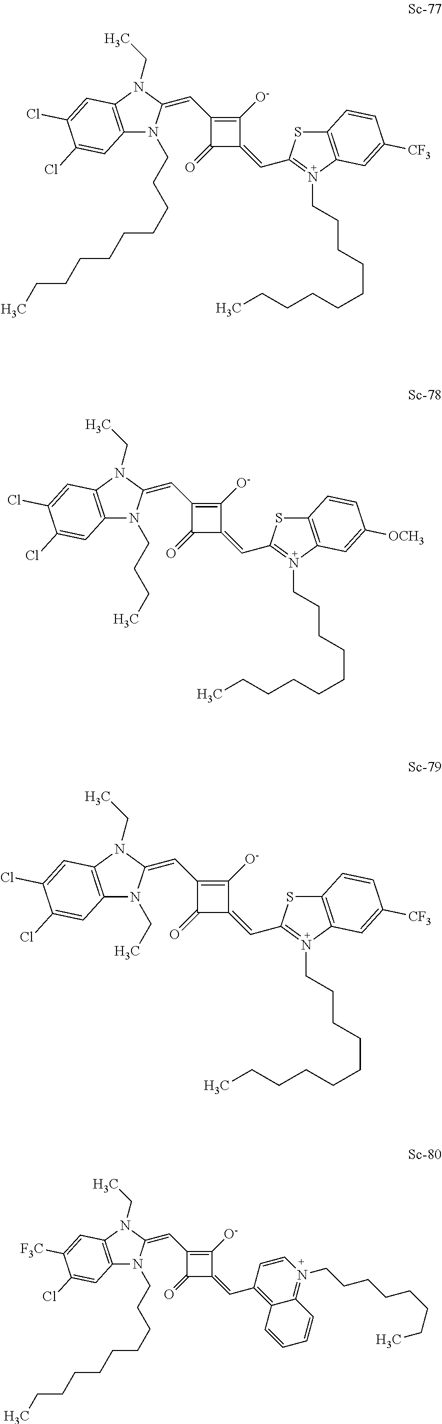

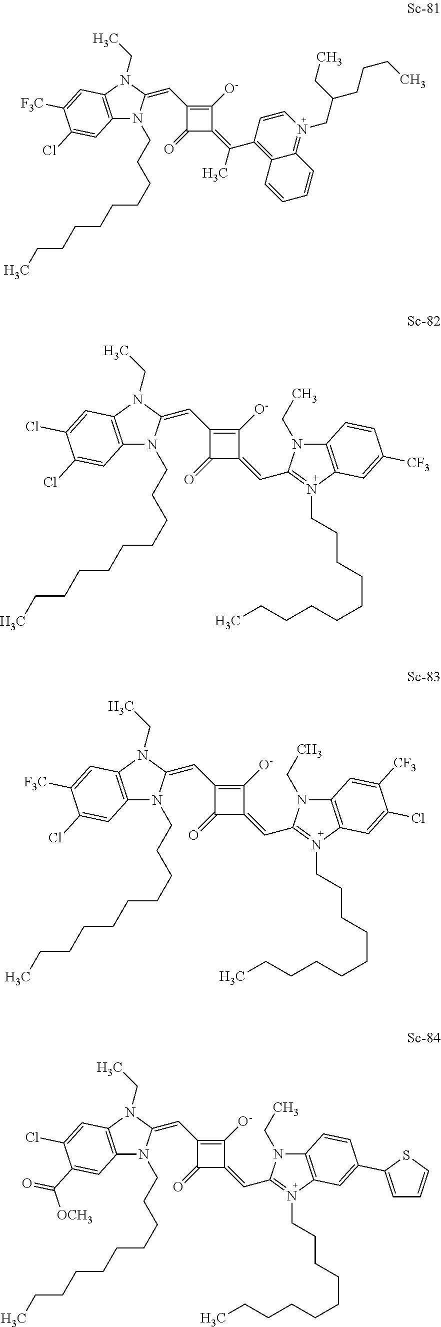

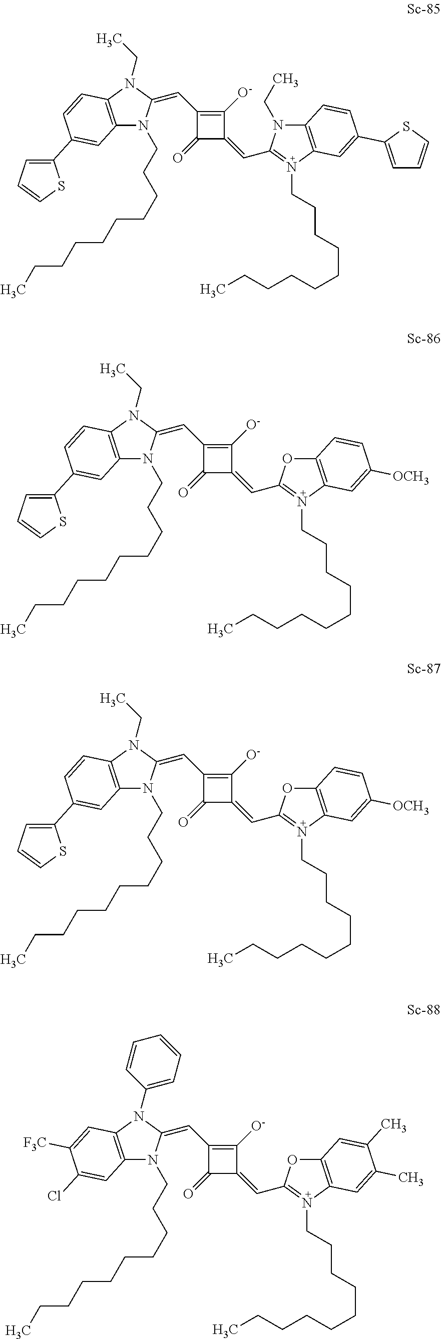

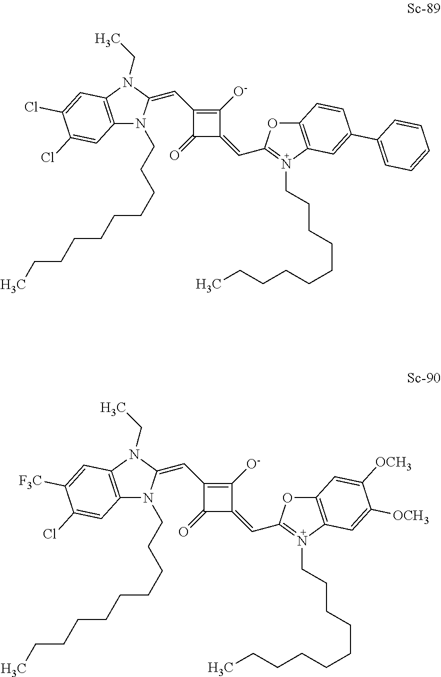

Next, a colorant represented by Formula (Ac) will be explained.

In Formula (Ac), Y represents a substituent of 0.2≦σp≦0.9, preferably represents a substituent of 0.3≦σp≦0.8, and more preferably represents a substituent of 0.4≦σp≦0.7. The σp value of σp<0.2 is not preferable, because the absorption becomes broadened, and the σp value of σp>0.9 is not preferable, because the production yield of the dye becomes low. Preferable examples of a substituent include an acyl group, an alkoxycarbonyl group, an aryloxycarbonyl group, a carbamoyl group, an alkylsulfonyl group, an arylsulfonyl group, a sulfamoyl group, a cyano group, and a perfluoroalkyl group.

In Formula (Ac), A⁷ represents a group of atoms necessary to form a 5-membered ring containing nitrogen with the neighboring nitrogen atom.

In Formula (Ac), L⁷ represents a monovalent organic group, or a group represented by Formula (Ac-1). Examples of a monovalent organic group include a halogen atom, an alkyl group, an aryl group, an acyl group, an alkoxy group, an alkoxycarbonyl group, an acyloxy group, a carbamoyl group, a sulfamoyl group, an alkylthio group, an arylthio group, an amino group, an acylamino group, an alkylureido group, an arylureido group, an alkylsulfonamide group, an ary sulfonamide group, an alkylaminosulfonylamino group, an arylaminosulfonylamino group, a hydroxy group, a cyano group, a nitro group and a heterocycle group. Examples of a group represented by Formula (Ac-1) include a 2-pyrrolyl group, an imidazolyl group, an isothiazolyl group, an isoxazolyl group, a 3-pyrazolyl group, a pyradinyl group, a triazolyl group, a 2-pyridyl group, a pyridazinyl group, a pyrimidinyl group, a 3H-indolyl group, a 1H-indazolyl group, a purinyl group, an isoquinolyl group, a quinolyl group, a phthalazinyl group, a naphthyridinyl group, a quinozalynyl group, and a quinazolynyl group. These heterocycles may further have a substituent, of which examples include a halogen atom, an alkyl group, an aryl group, an acyl group, an alkoxy group, an alkoxycarbonyl group, an acyloxy group, an alkylthio group, an arylthio group, an amino group, a cyano group, a nitro group, and a heterocycle group.

The value of r is 1 or 2. When r is 1, L is a group represented by Formula (Ac-1), and when r is 2, at least one is a group represented by Formula (Ac-1).

X⁷¹ represents substituted or non-substituted alkylamino group, and examples of a substituent include an aryl group, an acyl group, an alkoxy group, an alkoxycarbonyl group, an acyloxy group, an alkylthio group, an arylthio group, an amino group, a cyano group, a nitro group, a hydroxyl group, a carboxyl group, a sulfonic acid group, a sulfonamide group, an acylamino group, a carbamoyl group, and a sulfamoyl group.

R⁷¹ represents a substituted or non-substituted alkyl group, and examples of the substituent of a substituted alkyl group include an aryl group, an acyl group, an alkoxy group, an alkoxycarbonyl group, an acyloxy group, an alkylthio group, an arylthio group, an amino group, a cyano group, a nitro group, hydroxyl, a carboxyl group, a sulfonic acid group, a sulfonamide group, an acyl amino group, and a sulfamoyl group.

R⁷² represents a hydrogen atom or a substituent, and examples of the substituent include an alkyl group, an aryl group, an acyl group, an alkoxy group, an alkoxycarbonyl group, an acyloxy group, an alkylthio group, an arylthio group, an amino group, a cyano group, and a nitro group.

As for L⁷ represented by Formula (Ac-1), L⁷ is preferably represented by following Formula (Ac-1a) or (Ac-1b).

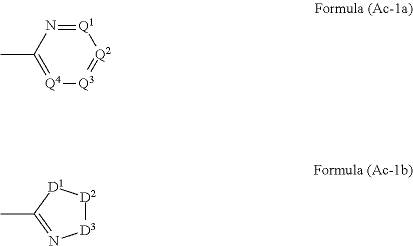

In the formulas, Q¹-Q⁴ each represent —CR^{7a}═ or —N═, D¹-D³ each represent —CR^{7b}═ or —N═, and R^{7a} and R^{7b} each represent a substituent.

Examples of a group represented by Formula (Ac-1a) include a pyradinyl group, a 2-pyridyl group, a pyridazinyl group, and a pyrimidinyl group. Examples of R^{7a} include a halogen atom, an alkyl group, an aryl group, an acyl group, an alkoxy group, an alkoxycarbonyl group, an acyloxy group, an alkylthio group, an arylthio group, an amino group, a cyano group, a nitro group, and a heterocycle group.

Examples of a group represented by Formula (Ac-1b) include a 2-pyrrolyl group, an imidazolyl group, an isothiazolyl group, an isoxazolyl group, a 3-pyrazolyl group, a pyradinyl group, and a triazolyl group. Examples of R^{7a} include a halogen atom, an alkyl group, an aryl group, an alkoxy group, an alkoxycarbonyl group, an acyloxy group, an alkylthio group, an arylthio group, an amino group, a cyano group, a nitro group, and a heterocycle group.

The colorant represented by Formula (Ac) may be a metal complex compound represented by Formula (Ad).

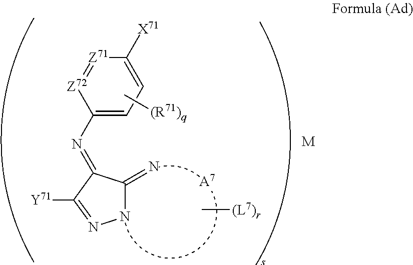

In Formula (Ad), Y⁷¹, Z⁷¹, Z⁷², A⁷, L⁷, X⁷¹, R⁷¹, R⁷², and q and r have the same meaning as those of Formula (Ac). M represents a metal atom or a salt thereof; and m represents an integer.

The metal represented by M is selected from the metal atoms of groups VIII, Ib, IIb, IIIc, IVa, Va, VIa, and VIIa of the periodic table, and it is preferably a divalent transition metal. Concrete examples of the metal include divalent metals of Ni, Cu, Co, Cr, Zn, Fe, Pd, and Pt, more preferably include Ni, Cu, Co, Cr, and Zn, and specifically preferably include Ni.

Among the metal salts, examples of an inorganic metal salt include a perchlorate, a halide salt, q sulfate, a boron fluoride salt, a strontium fluoride salt, a hexafluorophosphoric acid salt. As an organic metal salt or a metal complex, organic groups which can neutralize a metal ion are usable. Examples of such an organic group include a fatty acid, an aromatic carboxylic acid, an alkyl sulfonic acid, an aryl sulfonic acid, a phenol, acetylacetone, a dithiocarboxylic acid, and tetraphenyl boron. A metal atom or a salt thereof in which M is selected from Ni, Cu, Co, Cr, Zn, Fe, Pd, and Pt is preferably used.

The metal complex colorant of the present invention may be any as far as a colorant represented by Formula (Ac) and a metal ion form a complex, and preferably the colorant to be a ligand has at least two coordination positions and both of the coordination positions are nitrogen atoms.

Concrete examples of colorants represented by Formulas (Ac) and (Ad) will be shown below, however, the present invention is not limited thereto.

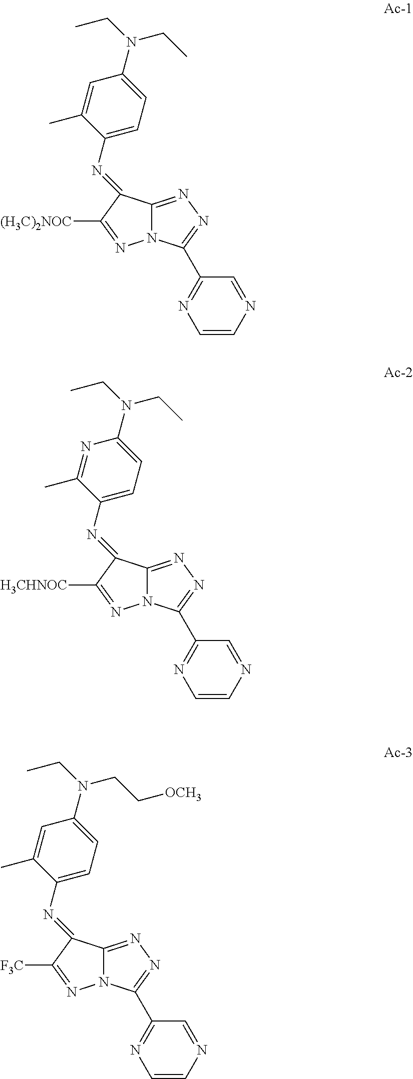

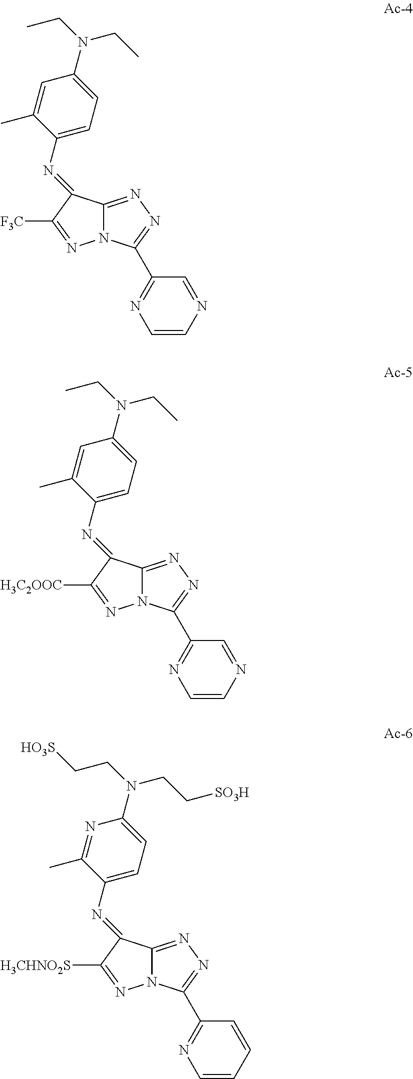

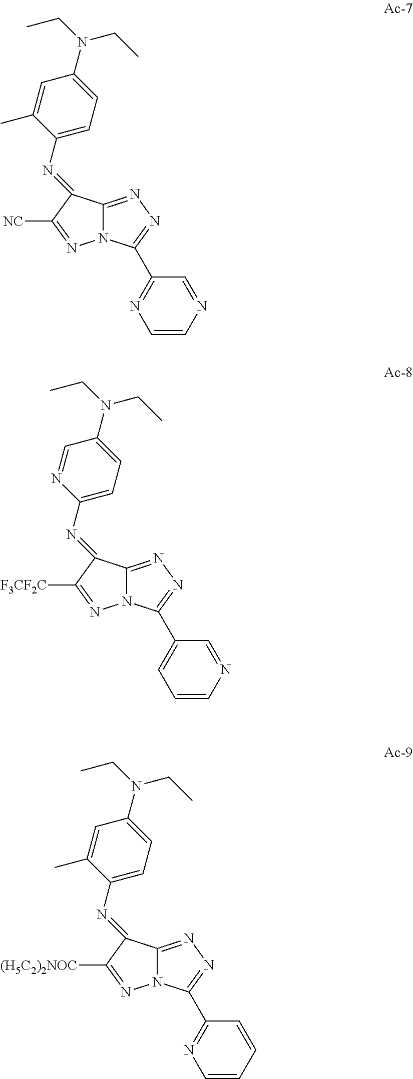

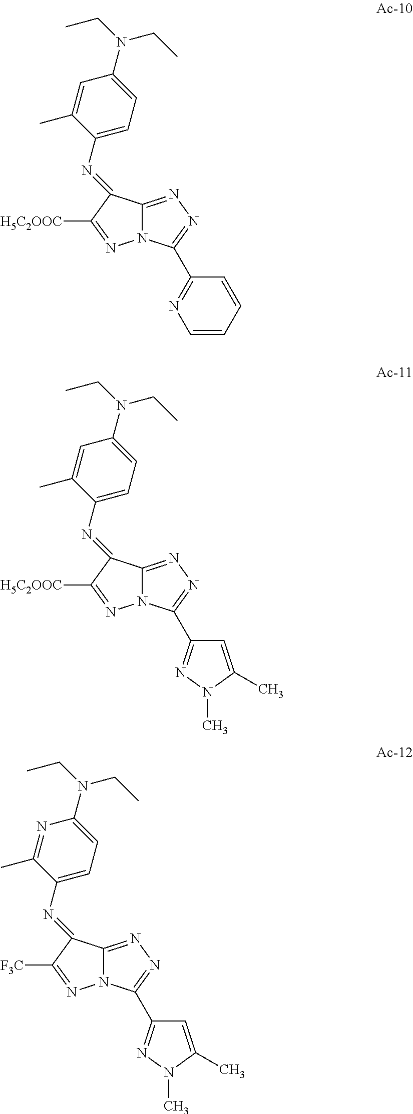

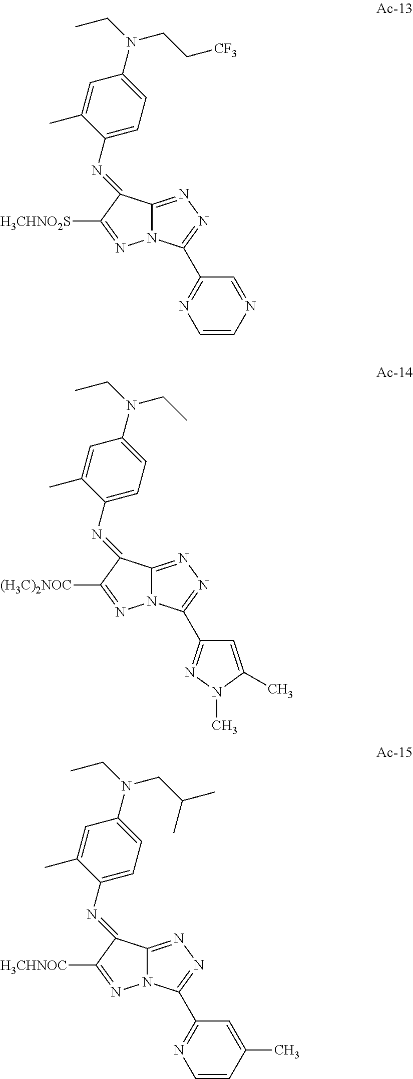

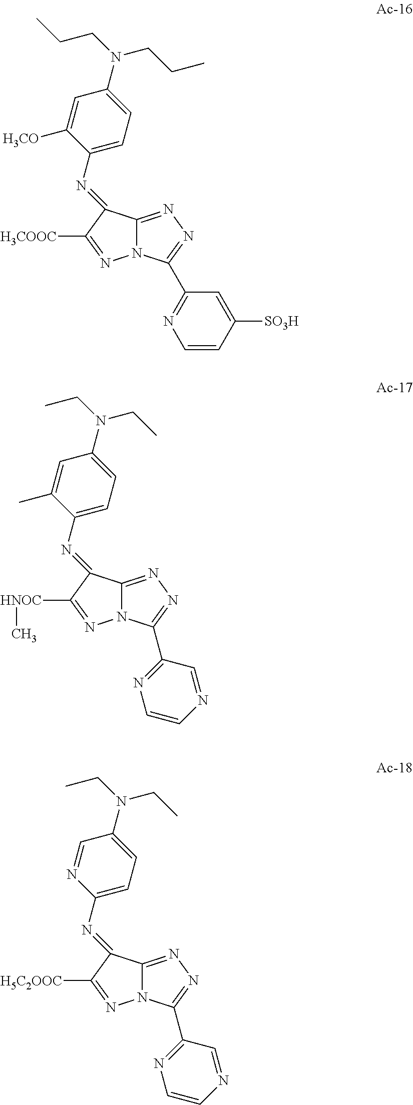

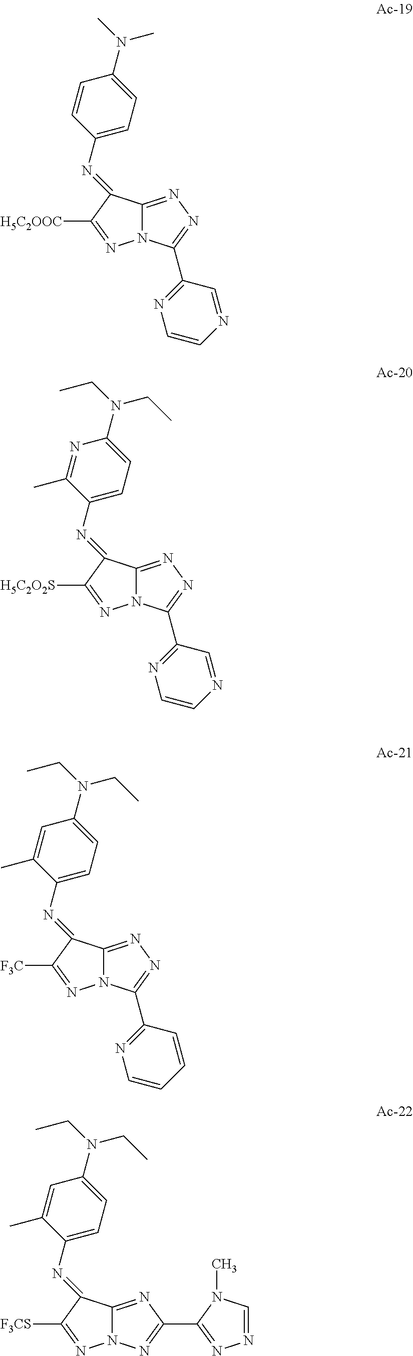

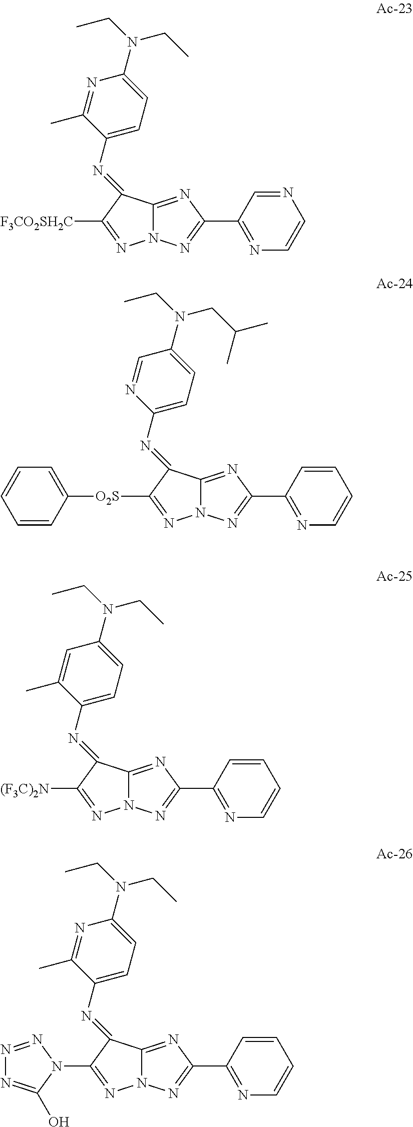

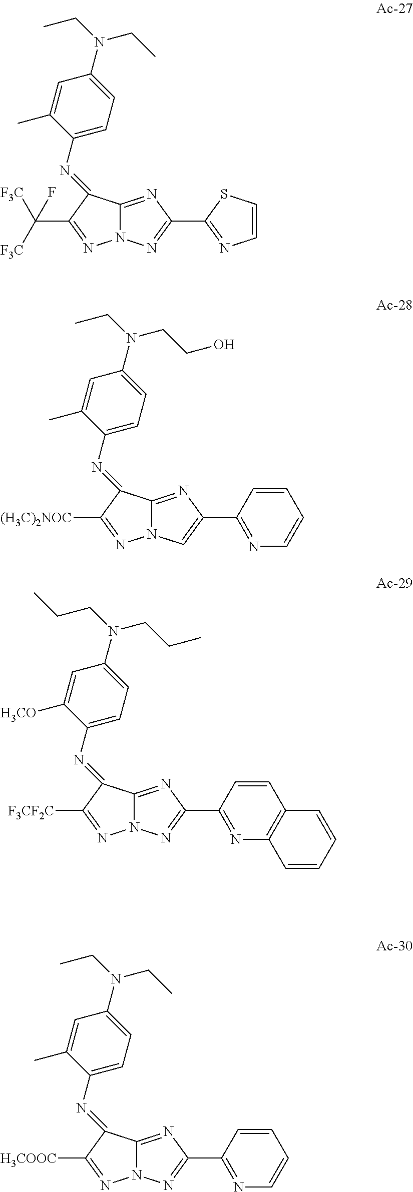

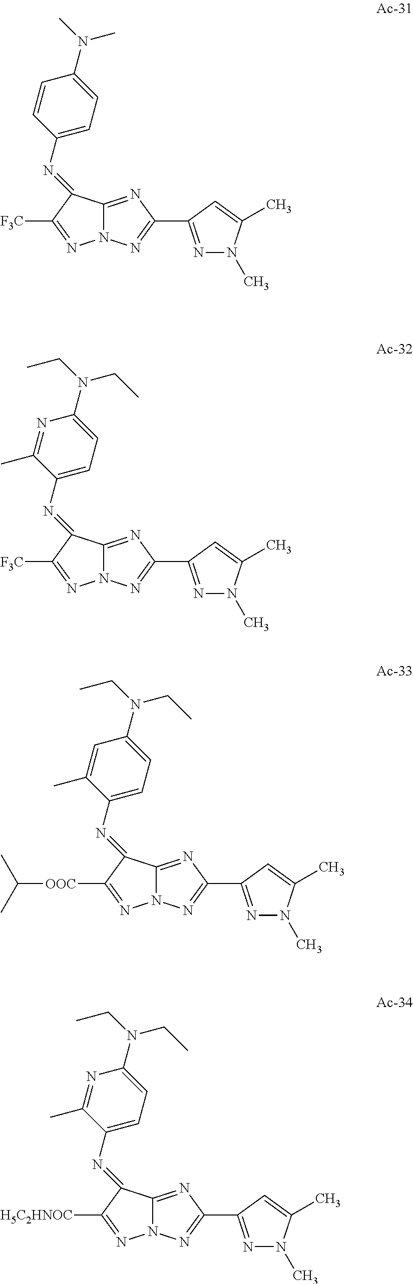

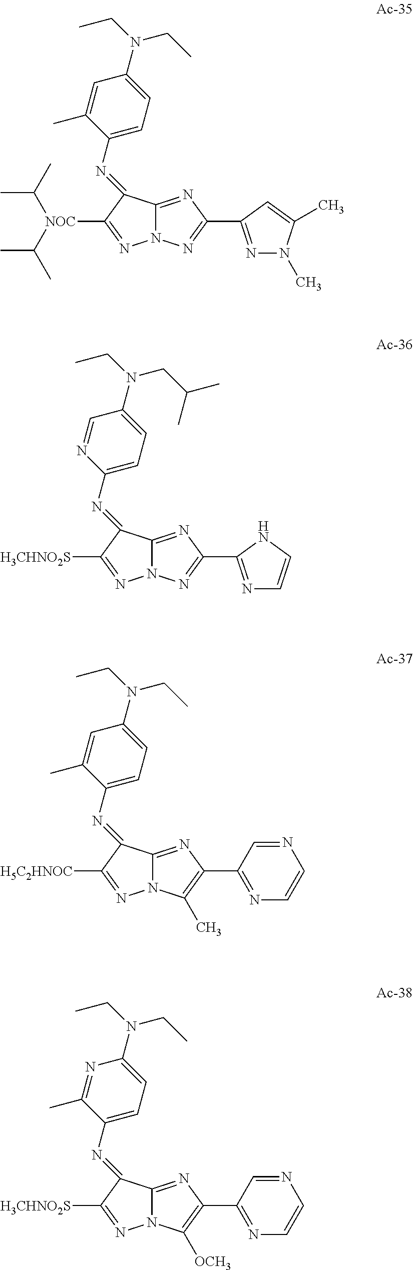

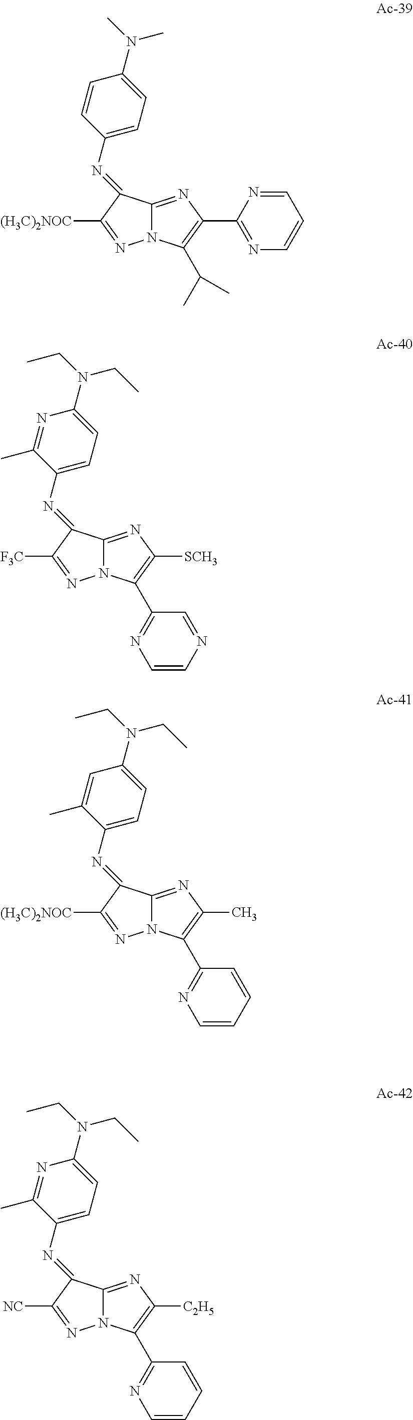

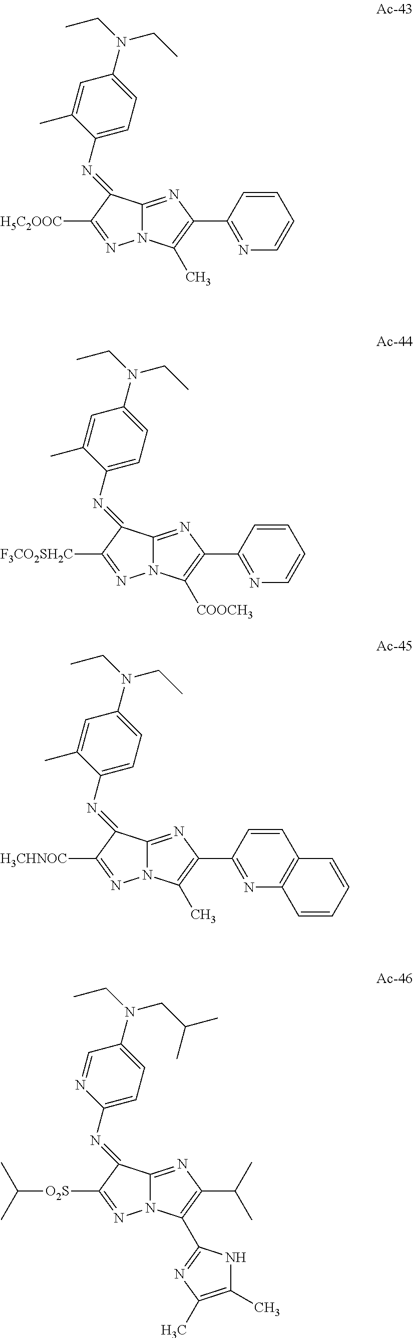

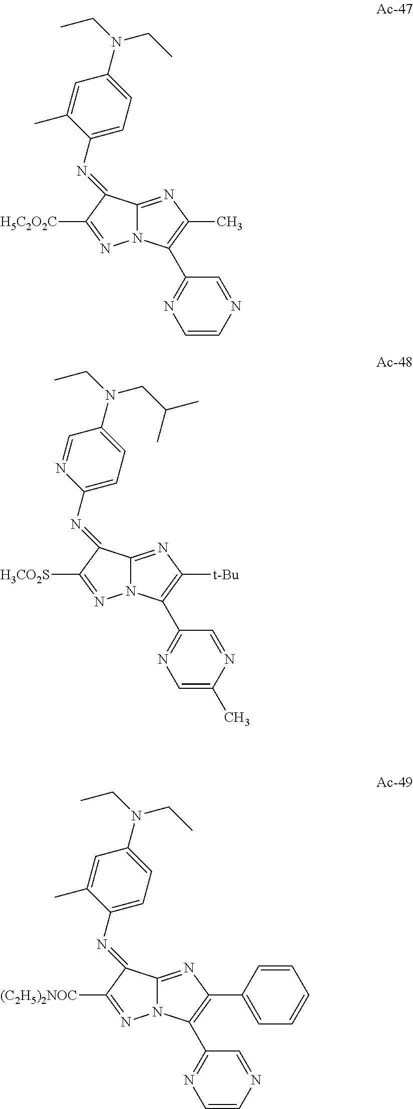

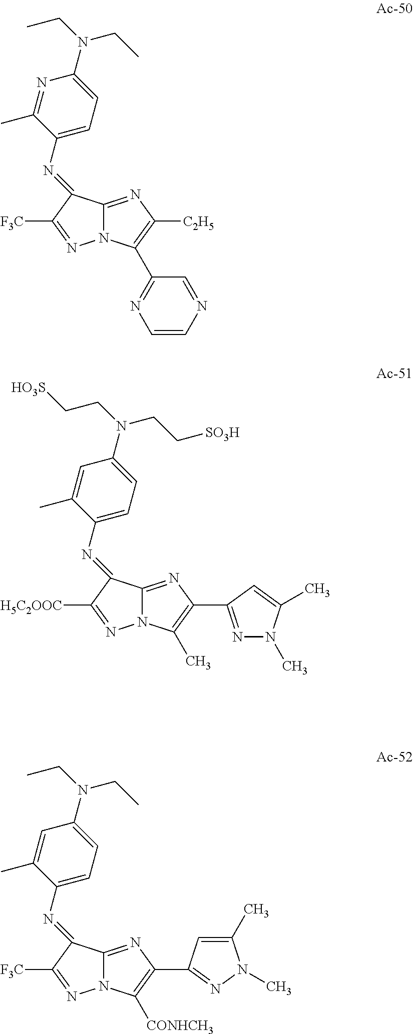

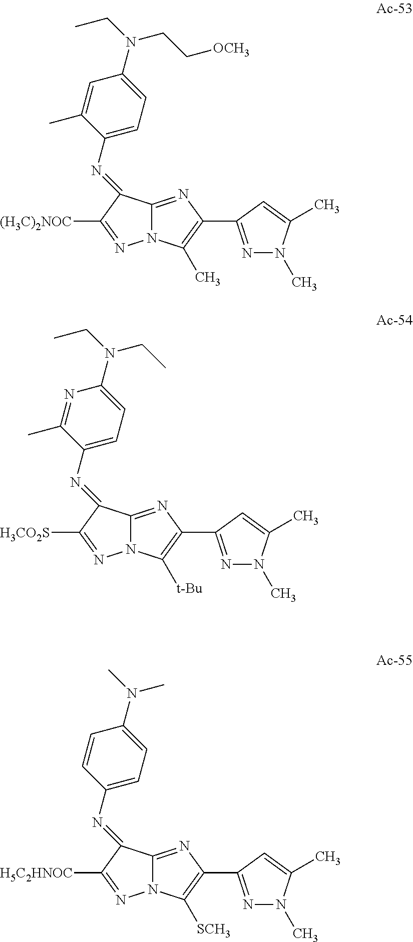

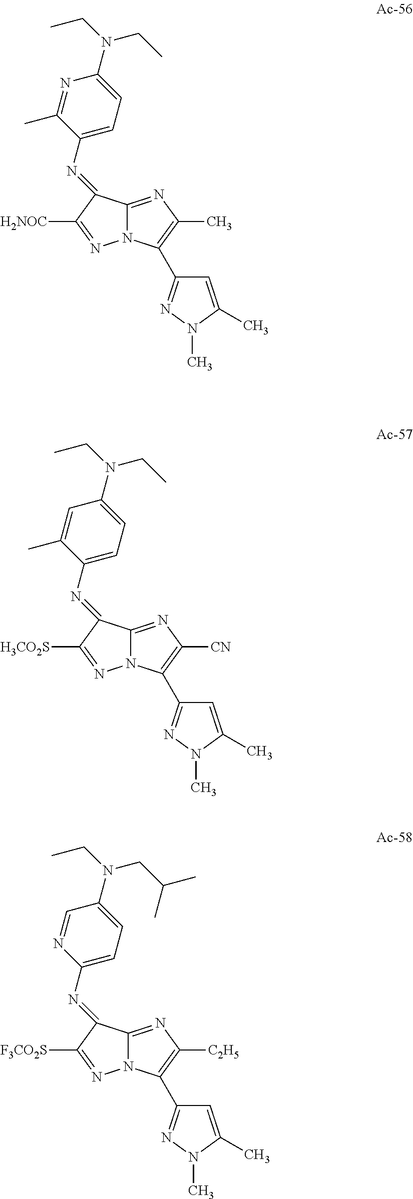

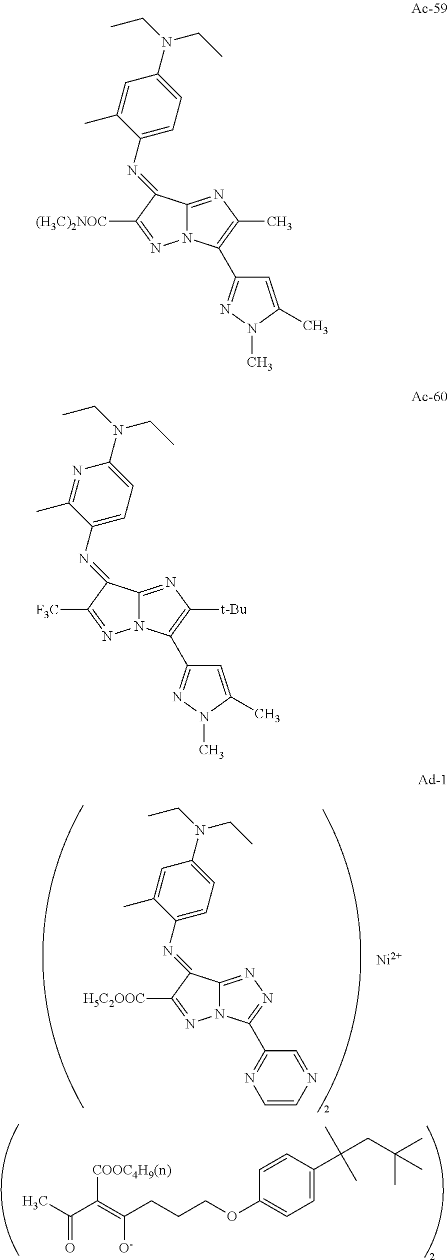

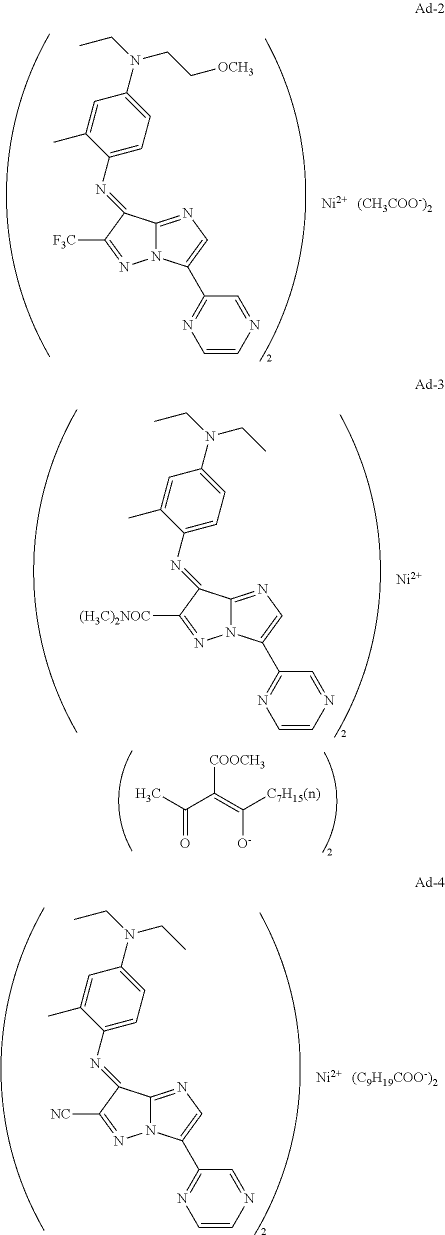

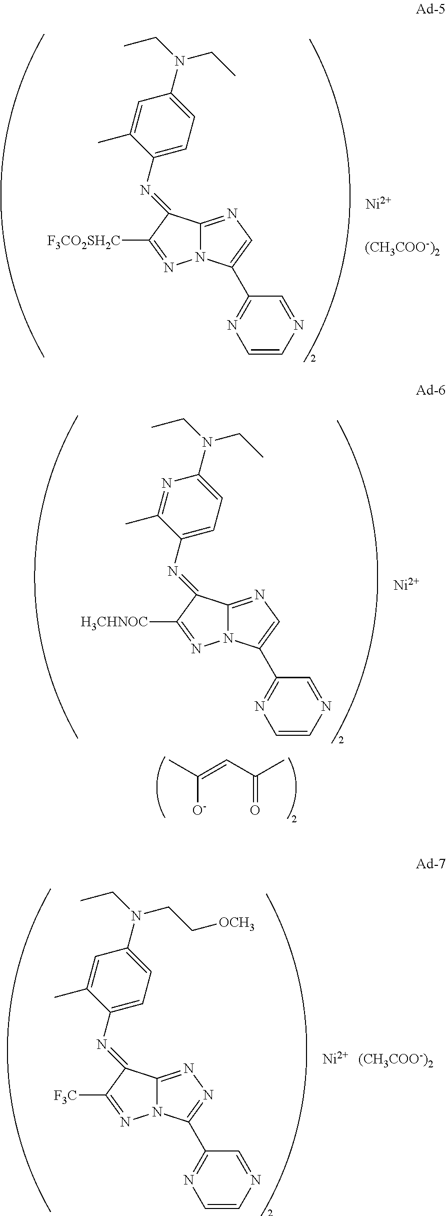

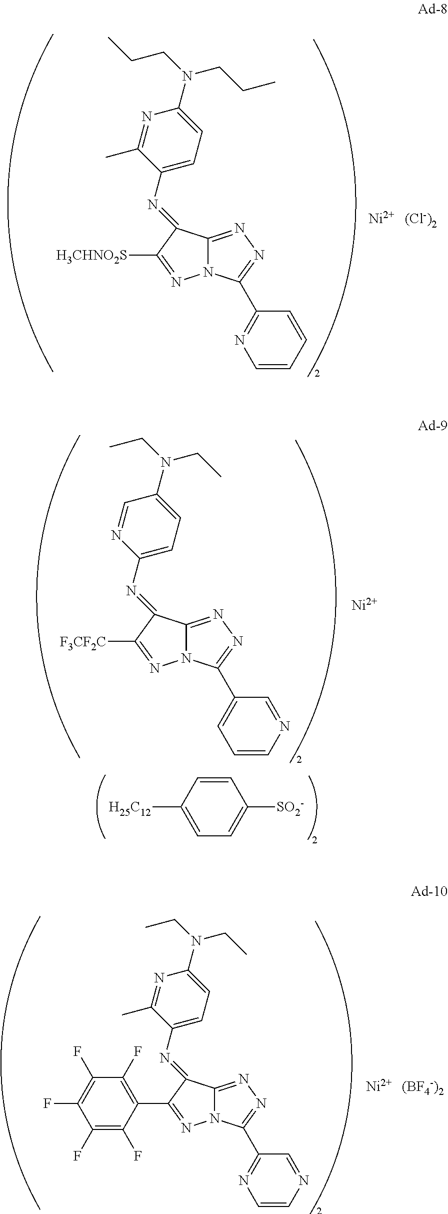

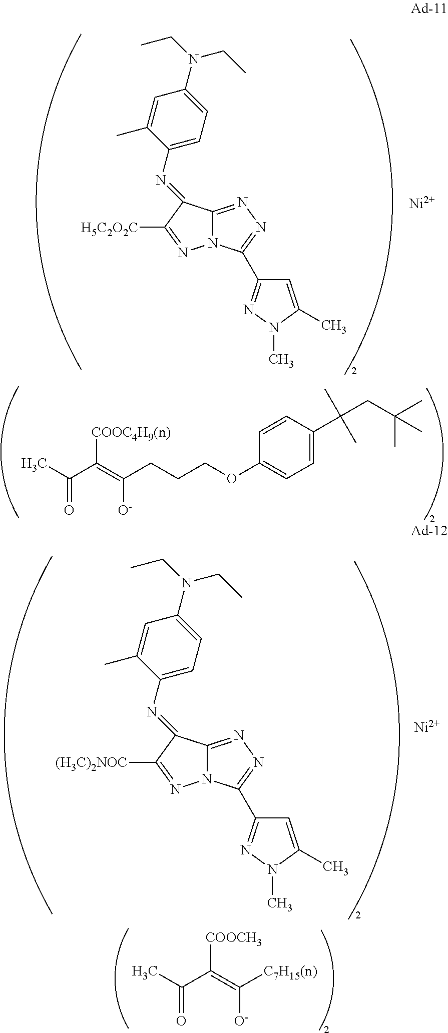

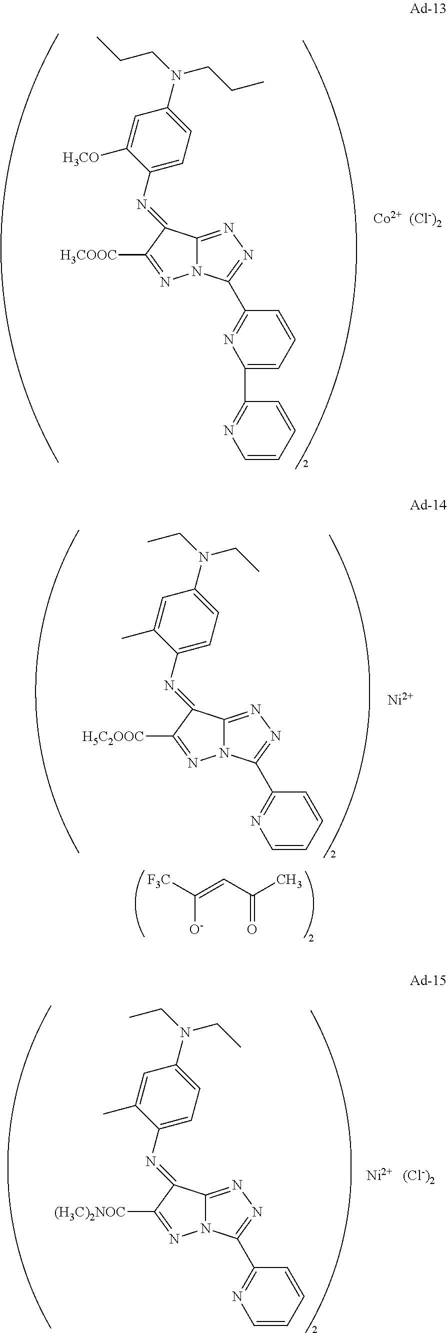

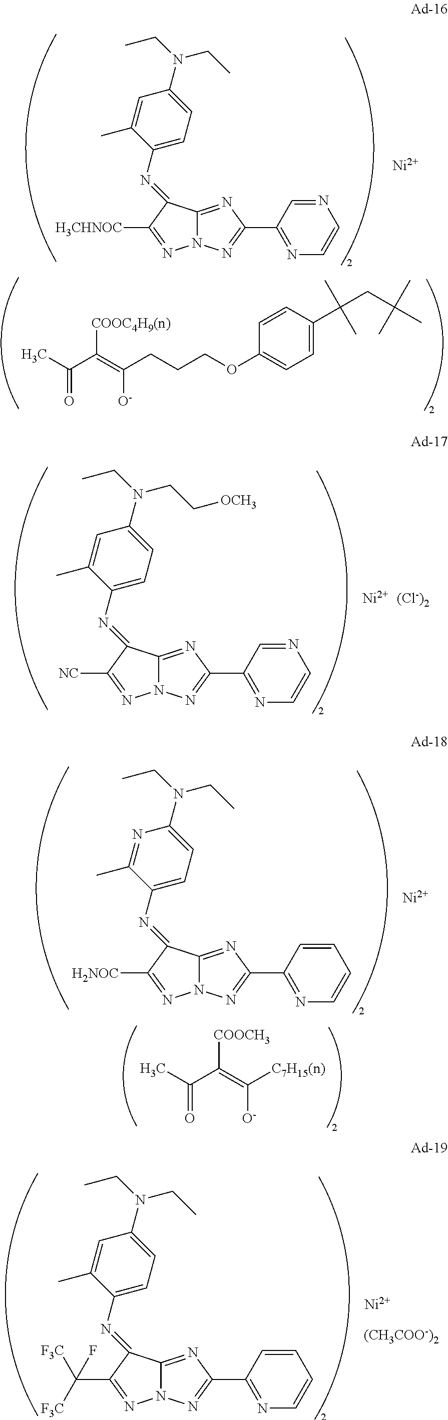

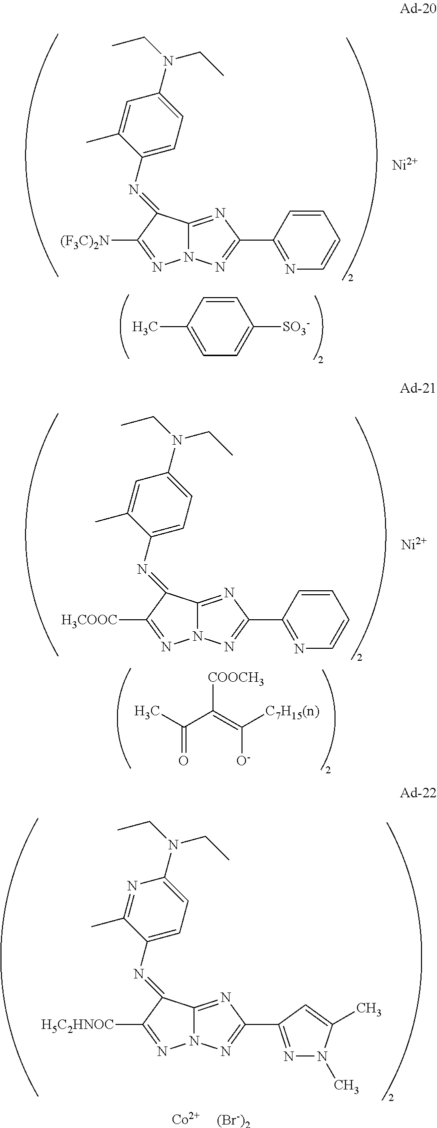

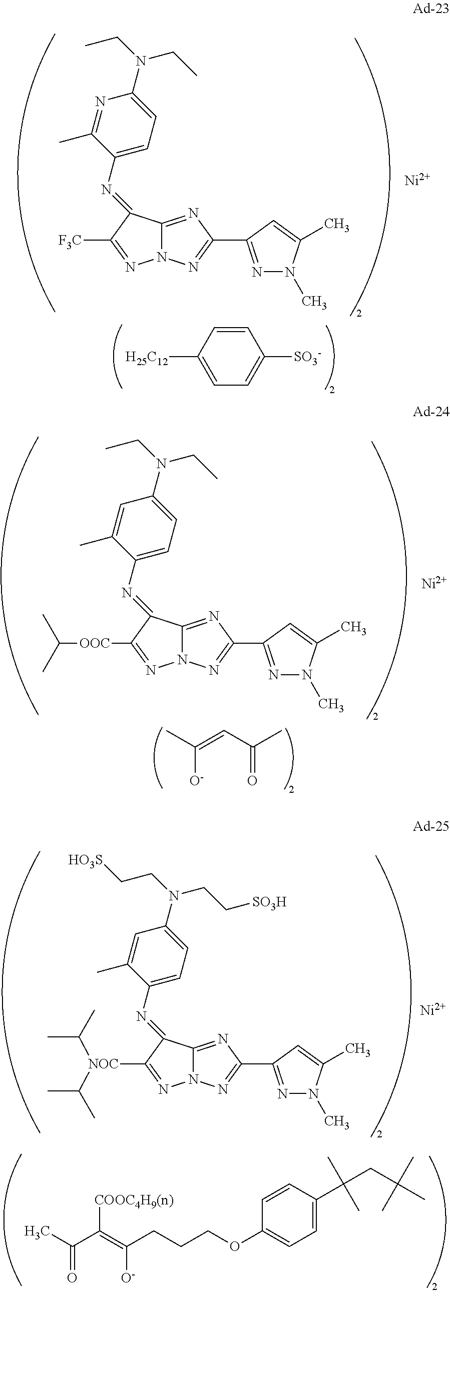

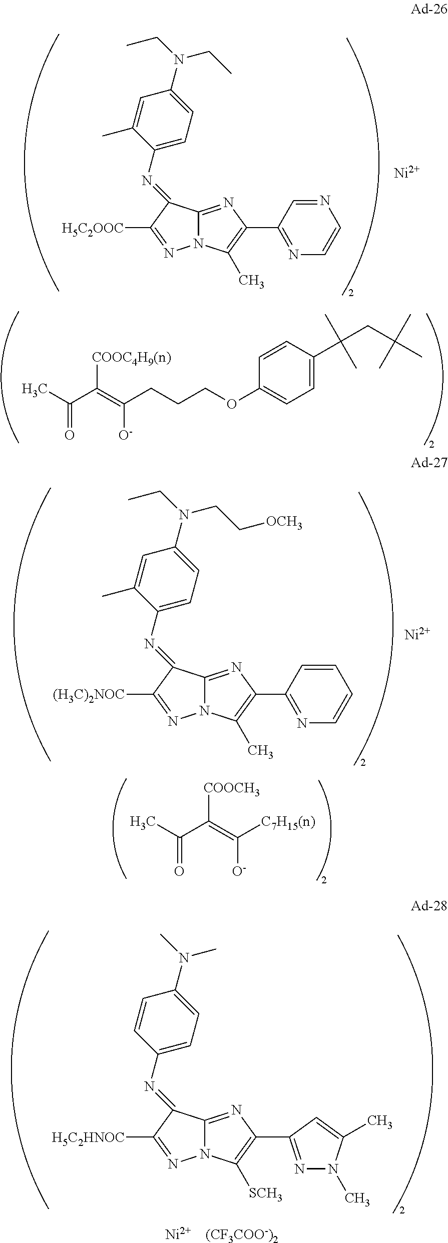

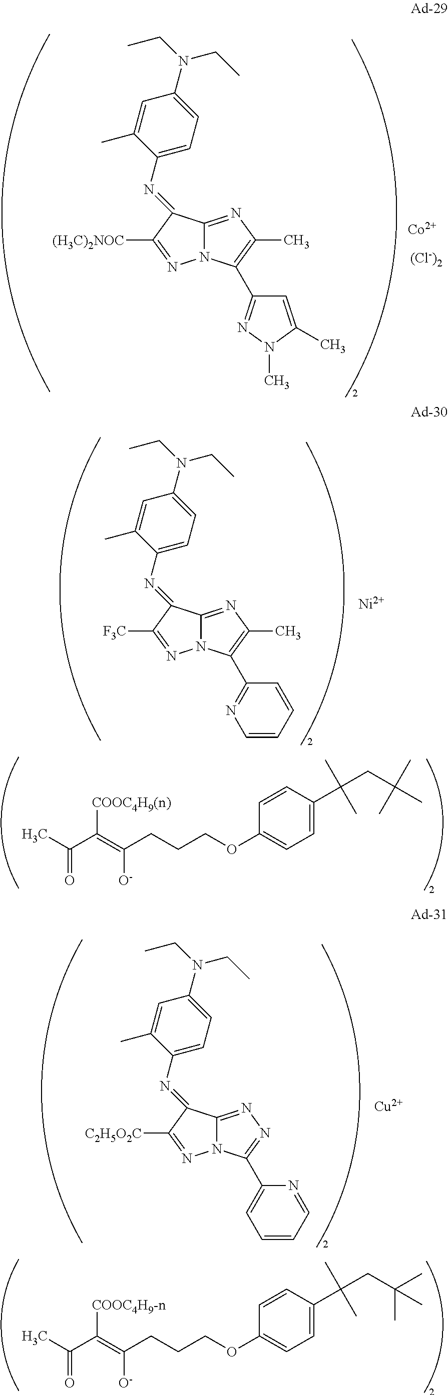

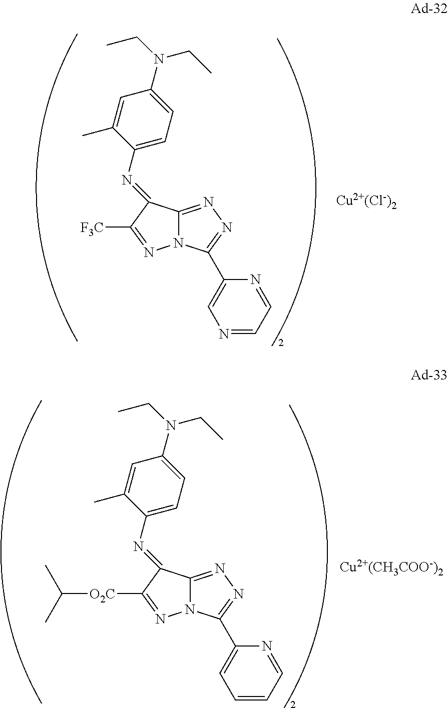

In the present invention, an electrophotographic toner which meets the condition described in claim 1 can be obtained by, in addition to the colorant of Formula (1), simultaneously using another colorant, preferably, a colorant of Formula (Sa), (Sb), (Ac) or (Ad).

When simultaneously using the colorants, it is preferable that one kind of a colorant represented by Formula (1) and one kind or two or more kinds of other simultaneously used colorants are used together, and it is more preferable that two or more kinds of other colorants are used together.

The used amount of a colorant in the toner manufacturing process is not specifically limited, however, it is preferable that the used amount of a colorant of Formula (1) is 40-90%, more preferably 50-80%, and most preferably 60-70% based on the total used amount of the colorant.

In the electrophotography, image forming and image output are carried out by using a yellow toner and a magenta toner in addition to the aforementioned cyan toner to output a full color image by forming a mixed color image.

### (Yellow Toner)

As a yellow toner used in the present invention, yellow toners conventionally known in the art are usable, and most suitable toners in view of the usage'purpose may be selected.

In order to effectively use, a hue angle of a yellow toner as a monochrome is preferably 70-95, and more preferably 80-90. A yellow colorant is a colorant which provide yellow hue when an electrophotographic toner containing the colorant is prepared and an image is formed. The colorant may be a dye or a pigment.

Examples of a yellow colorant used for a yellow toner include dyes such as C. I. Solvent Yellow 19, 44, 77, 79, 81, 82, 93, 98, 103, 104, 112 and 162; yellow pigments such as C. I. Pigment Yellow 14, 17, 74, 93, 94, 138, 155, 180 and 185; and a mixture thereof. Specifically, C. I. Solvent Yellow 162 as a dye and C. I. Pigment Yellow 74, 93, 138, and 180 as pigments are preferably used.

### (Magenta Toner)

As a magenta toner used in the present invention, magenta toners conventionally known in the art are usable, and most suitable toners in view of the usage purpose may be selected.

Next, magenta colorants preferably used in the present invention will be explained.

A magenta colorant is a colorant which provide magenta hue when an electrophotographic toner containing the colorant is prepared and an image is formed. The colorant may be a dye or a pigment.

In order to effectively use, a hue angle (h) according to the L*a*b* color coordinate of a magenta toner as a monochrome is preferably 300°-330°, and more preferably 310°-330°.

As concrete colorants for a magenta toner, the following will be cited.

C. I. Pigment Red 48:2, C.I. Pigment Red 57:1, C.I. Pigment Red 58:2, C.I. Pigment Red 200, C.I. Pigment Red 7, C.I. Pigment Red 8, C.I. Pigment Red 13, C.I. Pigment Red 23, C.I. Pigment Red 223, C.I. Pigment Red 212, C. I. Pigment Red 213, C.I. Pigment Red 222, C.I. Pigment Red 238, C.I. Pigment Red 245, C.I. Pigment Red 49:2, C.I. Pigment Red 175, C.I. Pigment Red 144, C. I. Pigment Red 214, C.I. Pigment Red 220, C.I. Pigment Red 221, C.I. Pigment Red 190, C.I. Pigment Red 224, C.I. Pigment Red 202, C.I. Pigment Red 88, and C. I. Pigment Red 181.

In the case of recent increased opportunities for printing images on computer displays, the color space of conventional printing is much narrower than that of a computer display, resulting in a large difference in color between an image on a display and an image printed from the display. Regarding the toner of the present invention, this problem has been largely improved and a print image closer to the color region of a computer display when compared with the conventional toners has come to be obtained by using the toner containing an aforementioned cyan colorant. Thus, the toner of the invention can be said to contribute to the expansion of the color space of print images.

Further, it has become possible to realize broader and more stable color reproducibility compared with those of a conventional toner image or an image formed with a printing ink, while being light resistant and ozone resistant.

### (Colorant Used Simultaneously)

The toner according to the present invention is obtained by flocculating/fuzing composite resin particles and colorant particles.

As a colorant which constitute the toner according to the present invention (namely, colorant particles used for flocculating/fuzing together with composite resin particles), there may be cited varieties of inorganic and organic pigments and dyes in addition to the aforementioned cyan colorant and magenta colorant. As inorganic pigments, those having been known in the art are usable. Concrete inorganic particles will be shown below.

Black pigments include, for example, carbon blacks such as furnace black, channel black, acetylene black, thermal black, lamp black, etc., and in addition, magnetic powders such as magnetite, ferrite, etc.

These inorganic pigments may be employed alone or in combination in accordance with requirements. Furthermore, the addition amount of the pigment is generally in the range of 2 to 20% by mass and preferably in the range of 3 to 15% by mass based on the mass of a polymer.

Magnetite mentioned above may be added when used as a magnetic toner. In this case, preferable amount is 20 to 60% by mass in the toner in view of providing a prescribed magnetic property.

Also, as an organic pigment and dye, those known in the art maybe employed. Concrete examples of such an organic pigment and dye will be shown below.

Magenta or red coloring pigment includes C.I. Pigment Red 2, C.I. Pigment Red 3, C.I. Pigment Red 5, C.I. Pigment Red 6, C.I. Pigment Red 7, C.I. Pigment Red 15, C.I. Pigment Red 16, C.I. Pigment Red 48:1, C.I. Pigment Red 53:1, C.I. Pigment Red 57:1, C.I. Pigment Red 122, C.I. Pigment Red 123, C.I. Pigment Red 139, C.I. Pigment Red 144, C.I. Pigment Red 149, C.I. Pigment Red 166, C.I. Pigment Red 177, C.I. Pigment Red 178 and C.I. Pigment Red 222.

Orange or yellow pigment includes C.I. Pigment Orange 31, C.I. Pigment Orange 43, C.I. Pigment Yellow 12, C.I. Pigment Yellow 13, C.I. Pigment Yellow 15, C.I. Pigment Yellow 93, and C.I. Pigment Yellow 156.

Green or cyan pigment includes C.I. Pigment Blue 15, C.I. Pigment Blue 15:2, C.I. Pigment Blue 15:3, C.I. Pigment Blue 16, C.I. Pigment Blue 60, and C.I. Pigment Green 7.

Dye includes, for example, C.I. Solvent Red 1, 49, 52, 58, 63, 111, and 122, C.I. Solvent Yellow 19, 44, 77, 79, 81, 82 93, 98, 103, 104, 112, and 162, and C.I. Solvent Blue 25, 36, 60, 70, 93, and 95, and a mixture thereof is also usable.

The colorant (colorant particles) constituting the toner according to the present invention may be subjected to a surface-modifying treatment. Commonly known surface modifiers are usable, and specifically, a silane coupling agents, a titanium coupling agent, or an aluminum coupling agent are preferably used. Examples of a silane coupling agent include an alkoxysilane such as methylmethoxysilane, phenyltrimethoxysilane, methylphenyldimethoxysilane and diphenyldimethoxysilane, a siloxane such as hexamethyldisiloxane, γ-chloropropyl-trimethoxysilane, vinylnichlorosilane, vinyltrimethoxysilane, vinyltriethoxysilane, γ-methacryloxypropyltrimethoxysilane, γ-glycidoxypropyltrimethoxysilane, γ-mercaptopropyl-trimethoxysilane, γ-aminopropyltriethoxysilane, and γ-ureidopropyltriethoxysilane. Titanium coupling agents include, for example, TTS, 9S, 38S, 41B, 46B, 55, 138S and 238S which are commercially available, as a trade name “Plain Act”, from Ajinomoto Co., Inc.; A-1, B-1, TOT, TST, TAA, TAT, TLA, TOG, TBSTA, A-10, TBT, B-2, B-4, B-7, B-10, TBST, A-400, TTS, TOA-30, TSDMA, TfAB and TTOB which are commercially available from Nippon Soda Co., Ltd. Aluminum coupling agents include, for example, “Plain Act AL-M” (product of Ajinomoto Co., Inc.).

The surface modifier is incorporated preferably in an amount of 0.01% to 20%, and more preferably 0.1% to 5% by mass, based on colorant.

Surface modification methods of colorant particles include, for example, incorporating a surface modifier to a colorant particle dispersion and heating to cause a reaction.

Surface-modified colorant particles are filtered off, and after washing with an identical solvent and filtering are repeated, the particles are dried.

As one of the preferable embodiments of the present invention, there may be cited is that the colorant is an oil-soluble dye. Usually, oil-soluble dyes which do not contain any water-soluble group such as a carboxylic acid or sulfonic acid group, are soluble in organic solvents and not soluble in water, but a dye obtained by salt-formation of a water-soluble dye with a long chain base and thereby being soluble in oil, is also included. There are known, for example, an acid dye, a direct dye and a salt formation dye of a reactive dye with a long chain amine.

Specific examples thereof will be described below but are not limited to these: Valifast Yellow 4120, Valifast Yellow 3150, Valifast Yellow 3108, Valifast Yellow 2310N, Valifast Yellow 1101, Valifast Red 3320, Valifast Red 3304, Valifast Red 1306, Valifast Blue 2610, Valifast Blue 2606, Valifast Blue 1603, Oil Yellow GG-S, Oil Yellow 3G, Oil Yellow 129, Oil Yellow 107, Oil Yellow 105, Oil Scarlet 308, Oil Red RR, Oil Red OG, Oil Red 5B, Oil Pink 312, Oil Blue BOS, Oil Blue 613, Oil Blue 2N, Oil Black BY, Oil Black BS, Oil Black 860, Oil Black 5970, Oil Black 5906, Oil Black 5905, which are all available from Orient Kagaku Kogyo Co., Ltd.; Kayaset Yellow SF-G, Kayaset Yellow K-CL, Kayaset Yellow GN, Kayaset Yellow A-G, Kayaset Yellow 2G, Kayaset Red SF-4G, Kayaset Red K-BL, Kayaset Red A-BR, Kayaset Magenta 312, Kayaset Blue K-FL, which are all available from NIPPON KAYAKU CO., LTD.; FS Yellow 1015, FS Magenta 1404, FS cyan 1522, FS Blue 1504, C.I. Solvent Yellow 88, 83, 82, 79, 56, 29, 16, 14, 04, 03, 02, and 01; C.I. Solvent Red 84:1, C.I. Solvent Red 84, 218, 132, 73, 72, 51, 43, 27, 24, 18, and 01; Solvent Blue 70, 67, 44, 40, 35, 11, 02, and 01; C.I. Solvent Black 43, 70, 34, 29, 27, 22, 7, 3, and 3; C.I. Solvent Violet 3; C.I. Solvent Green 3 and 7; Plast Yellow DY352, Plast Red 8375, which are available from Arimoto Kagaku Kogyo Co., Ltd.; MS Yellow HD-180, MS Red G, MS Magenta HM-1450H, MS Blue HM-1384, which are available from Mitsui Kagaku Kogyo; ES Red 3001, ES Red 3002, ES Red 3003, TS Red 305, ES Yellow 1001, ES Yellow 1002, Ts Yellow 118, ES Orange 2001, ES Blue 6001, TS Turq Blue 618, which are available from SUMITOMO CHEMICAL CO., LTD.; MACROLEX Yellow 6G, Ceres Blue GNNEOPAN Yellow 075, Ceres Blue GN, MACROLEX Red and Violet R, which as available from Bayer Co.

Disperse dyes are also usable as an oil-soluble dye, examples thereof include C.I. Disperse Yellow 5, 42, 54, 64, 79, 82, 83, 93, 99, 100, 119, 122, 124, 126, 160, 184:1, 186, 198, 199, 204, 224 and 237; C.I. Disperse Orange 13, 29, 31:1, 33, 49, 54, 55, 66, 73, 118, 119 and 163; C.I. Disperse Red 54, 60, 72, 73, 86, 88, 91, 92, 93, 111, 126, 127, 134, 135, 143, 145, 152, 153, 154, 159, 164, 167:1, 177, 181, 204, 206, 207, 221, 239, 240, 258, 277, 278, 283, 311, 323, 343, 348, 356 and 362; C.I. Disperse Violet 33; C.I. Disperse Blue 56, 60, 73, 87, 113, 128, 143, 148, 154, 158, 165, 165:1, 165:2, 176, 183, 185, 197, 198, 201, 214, 224, 225, 257, 266, 267, 287, 354, 358, 365 and 365; C.I. Disperse green 6:1 and 9.

In addition, azomethine dyes and indoaniline dyes, which may be derived from a cyclic methylene compound such as phenol, naphthols; as pyrazolone and pyrazolotriazole, or a coupler such as a ring-opening methylene compound, are also preferably usable as an oil-soluble dye.

### (Colorant Content)

In the toner according to the present invention, the content of the colorant represented by Formula (1) is preferably 2-20% by mass base on the mass of the resin, and, further, by containing 1-15% by mass of the colorant, a sufficient density is obtained and a protection function of the colorant by the resin can be achieved.

As an image stabilizing agent, the compounds described or referred on pages 10 to 13 of JP-A No. H08-29934 may be added and phenol type, amine type, sulfur type and phosphor type compounds available on the market are also cited. An organic and inorganic UV absorbent may be added for the same purpose. As the organic UV absorbent, a benzotriazole compound such as 2-(2′-hydroxy-5-t-butylphenyl)benzotriazole and 2-(2′-hydroxy-3,5-di-t-butylphenyl)benzotriazole, a benzophenone type compound such as 2-hydroxy-4-methoxy-benzophenone and 2-hydroxy-4-n-octyloxybenzophenone, and a hydroxybenzoate compound such as phenyl salicylate, 4-t-butylphenyl salicylate, n-hexadecyl 2,5-t-butyl-4-hydroxybenzoate and 2,4-di-t-butylphenyl-3′,5′-di-t-butyl-4′-hydroxybenzoate can be cited. As the inorganic UV absorbent, titanium oxide, zinc oxide, cerium oxide, iron oxide and barium sulfate can be cited. The organic UV sorbents are preferable. The UV sorbent preferably has 50%-transparent wavelength range of from 350 to 420 nm and more preferably from 360 to 400 nm. The UV cutting ability is insufficient at the wavelength of shorter than 350 nm and the coloring is increased at the wavelength of longer than 420 nm, therefore, such the UV absorbent is not preferable. The adding amount is preferably within the range of from 10 to 200% by weight of the dye is preferable and that from 50 to 150% by weight is more preferable though the adding amount is not specifically limited.

### (Silanol Compound)

It is preferable to contain a silanol compound represented by Formula (5) in the toner used in the present invention.

(Rs)ₘ₅Si(OH)ₙ₅ Formula (5)

In Formula (5), Rs represents a hydrogen atom, an alkyl group, an aryl group, a heterocycle group, an alkoxy group, or a siloxy group, and m5 and n5 each represents an integer of 1-3, provided that m5+n5=4. When m5 is 2 or 3, Rs may be the same or different.

In Formula (5), examples of an alkyl group represented by Rs include a methyl group, an ethyl group, a propyl group, a butyl group, a t-butyl group, and an n-octyl group, examples of an aryl group include a phenyl group, a naphthyl group, and an anthranyl group, examples of a heterocyclic group include a pyridyl group, a pyrimidyl group, a quinolyl group, a pyrazolyl group, and an imidazolyl group, and examples of an alkoxy group include a methoxy group, an ethoxy group, an n-propoxy group, an i-propoxy group, and an n-octoxy group. These groups may further be substituted with a substituent described for R₁-R₄ of the aforementioned Formula (1). Examples of Rs preferably include a hydrogen atom, an alkyl group having 1-12 carbon atoms, an aryl group, an alkoxy group having 1-12 carbon atoms, and a siloxy group, wherein, in the case of a siloxy group, an oligomer is preferable. Examples of Rs further preferably include a hydrogen atom, an alkyl group having 1-8 carbon atoms, and an alkoxy group having 1-8 carbon atoms.

The organic silanol compound according to the present invention can be easily synthesized by a person having an ordinary knowledge in the field according to a method known in the art, and can also be obtained as a commercial item. Examples of a reference include JP-A Nos. 63-22759, 63-316789, 63-5093, 3-157388, 6-256355, 8-143581 and 2002-20390.

Concrete structures of Formula (5) according to the present invention will show below, however, with respective to tautomers having a different position of a substituent, only one example thereof is shown, and, the present invention is not limited thereto.

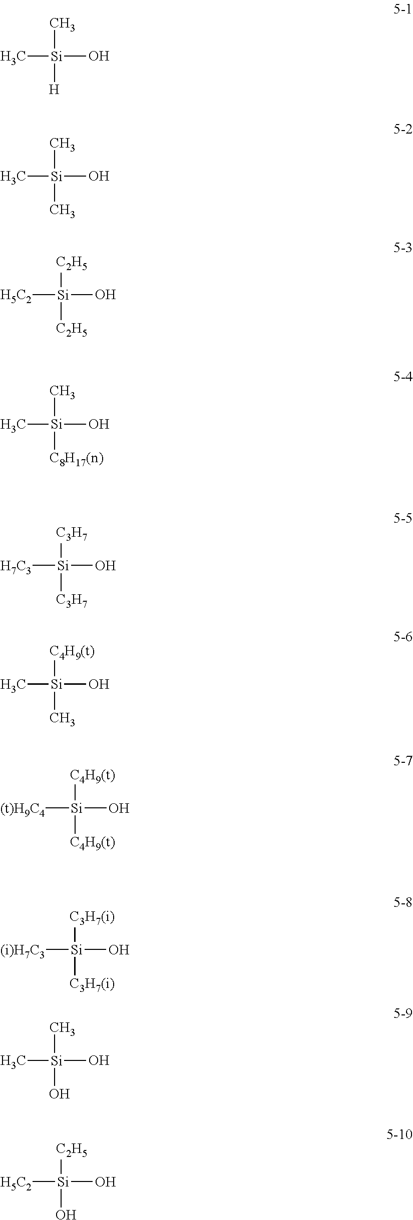

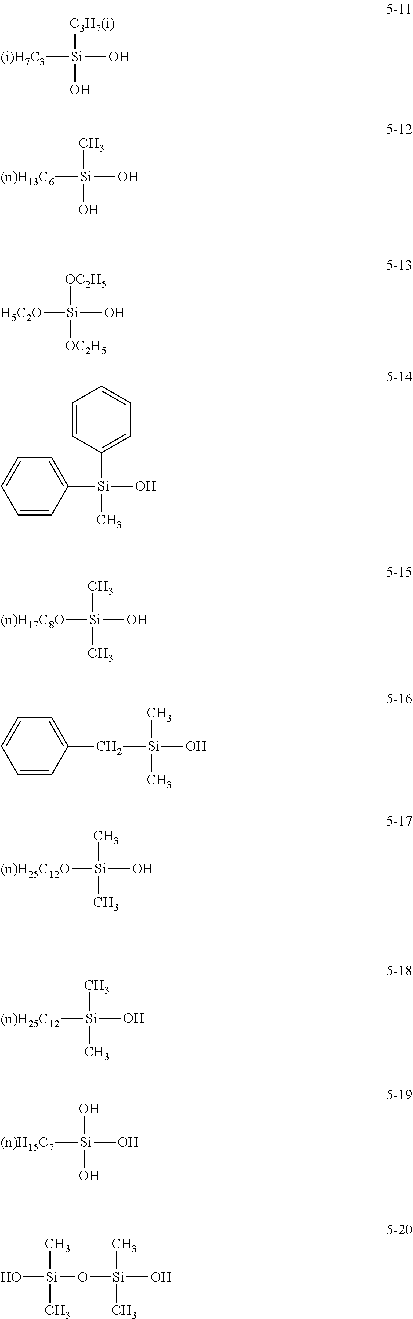

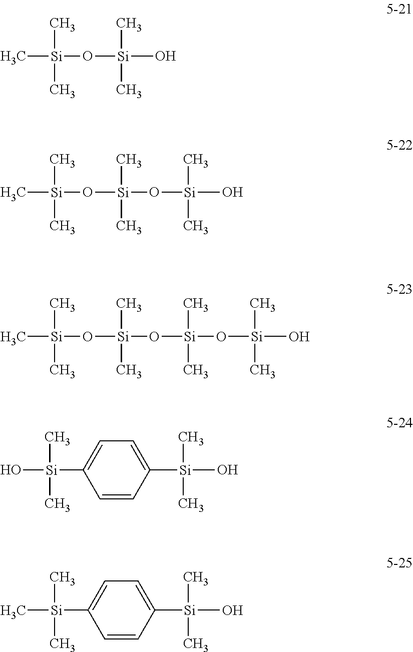

The content of a silanol compound represented by Formula (5) is not specifically limited, but is preferably 100-500, and is more preferably 100-350 ppm based on the toner for developing an electrostatic image. When the content of the organic silanol compound concerning the present invention is 100 ppm or more, the effect of the present invention can be attained, and, when it is 500 ppm or less, the toner for developing an electrostatic image is not too soft, and the deterioration of the storage property of the toner, reduction of a fixing ratio or the odor does not become a problem, thus, it is preferable.

The adding amount of a silanol compound represented by Formula (5) in the manufacturing process is preferably 100-350 ppm based on the toner for developing an electrostatic image. When the adding amount of the silanol compound is in this range, an effect to enhance the dispersion property of a releasing agent (wax) in the toner can be attained, and the residual amount of the organic silanol compound in the toner after dried under a reduced pressure can be controlled in the prescribed range of the present invention, however, the present invention is not limited thereto.

As a method to incorporate a silanol compound represented by Formula (5) in the toner for developing an electrostatic image, for example, in the case of a polymerization toner manufactured by a method including the process in which a resin is produce via polymerization of the following polymerizable monomer in an aqueous mediume, preferable is a method to add a silanol compound when a colorant disperson is prepared, however, in addition, a method to add a silanol compound in a polrimerizable monomer when resin particles are prepared may also be cited.

In the present invention, the quantity of the organic silanol is quantitatively determined by a head space system gas chromatography using a detecting method employed in conventional gas chromatography, such as an internal standard method. In this method, a toner is sealed in a vessel and heated to a temperature near the setting temperature of the heat fixing device provided in the image forming apparatus using the toner, and when the vessel is filled with volatile components, gas contained in the vessel is injected into a gas chromatograph to determine the volatile component content as well as performing mass spectrometry (MS).

The measurement using head space gas chromatography will be detailed below.

### 1. Sampling of Specimen:

A sample of 0.8 g is collected into a 20 ml vial for use in head space, wherein the sampling amount is weighed to the order of 0.01 g (which is necessary to calculate the area per unit weight). The vial is sealed with a septum using a special crimper.

### 2. Sample Heating

The sample is put vertically into an incubator maintained at 170° C. and heated for 30 min.

### 3. Setting of Gas Chromatographic Separation Condition:

There is used a separation column of 3 mm inside diameter and 3 m length, which is filled with a carrier coated with silicone oil SE-30 in a weight ratio of 15%. The separation column is loaded onto a gas chromatograph and helium gas is allowed to flow at a rate of 50 ml/min. The separation column temperature is set to 40° C. and the measurement was conducted, while raising the temperature to 260° C. at a rate of 15° C./min. After reaching 260° C., the column is maintained for 5 min.

### 4. Introduction of Sample:

The vial is taken out of the incubator and 1 ml gas generated from the sample is collected using a gas-tight syringe and injected into the column.

### 5. Calculation:

A calibration curve is prepared in advance using an organic silanol compound used as an internal standard material, and the concentration of each component is determined.

### 6. Equipment

### (1) Head Space Condition:

Head Space Device:
BP7694 “Head Space Sampler”, available from Hewlett-Packard Corp.

Temperature Condition:
Transfer line: 200° C.
Loop temperature: 200° C.
Sampling amount: 0.8 g/20 ml vial

### (2) GC/MS Condition:

GC: HP5890, available from Hewlett-Packard Corp.

MS: HP5971, available from Hewlett-Packard Corp.

Column: HP-624 30 m×0.25 mm

Oven temperature: 40° C. (3 min)-15° C./min-260° C.

Measurement mode: SIM

A preparation method of a toner of the present invention is preferably polymerization of a polymerizable monomer in an aqueous medium, in which a polymerizable monomer is polymerized by the process of suspension polymerization to prepare resin particles or the monomer is polymerized in liquid (aqueous medium) containing an emulsifying agent by the process of emulsion polymerization to form resin particles, and after optionally adding charge-controlling resin particles, an organic solvent and a flocculant such as salts are added thereto to cause the resin particles to flocculate and fuse.

### <Suspension Polymerization Method>

An example of the preparation method of a toner of the present invention will be described below. A charge controlling resin is dissolved in a polymerizable monomer and various constituent materials such as a colorant, a polymerization initiator and an optional releasing agent are added thereto and allowed to be dissolved or be dispersed in the monomer using a homogenizer, a sand mill, a sand grinder or an ultrasonic homogenizer. Using a homomixer or a homogenizer, the monomer, together with the dissolved or dispersed constituent materials, is dispersed in an aqueous medium containing a dispersion stabilizer to form oil droplets exhibiting a size desired as a toner. Thereafter, the thus formed dispersion is transferred to a reaction apparatus (stirring apparatus) having a stirring mechanism provided with a stirring blade as described later and heated to undergo polymerization. After completion of the reaction, the dispersion stabilizer is removed and the reaction mixture is subjected to filtration, washing and drying to prepare a toner. Herein, the aqueous medium refers to one containing at least 50% by weight of water.

### <Emulsion Polymerization Method>

Preferred as another example of a preparation method of a toner of the present invention is a method in which resin particles are subjected to flocculation and fusion in an aqueous medium to prepare a particulate toner. This method is not specifically limited and includes methods described in JP-A Nos. 5-265252, 6-329947 and 9-15904. Thus, it is a method in which resin particles and dispersed particles of a constituent material such as a colorant, or plural particulate constituents such as resin and a colorant are subjected to salting-out, flocculation and fusion; specifically, after dispersing these using an emulsifying agent, a flocculant is added thereto at a concentration of more than the critical flocculation concentration to cause salting-out and simultaneously, heated at a temperature more than the glass transition temperature of the formed polymer to cause particles to fuse to gradually grow the particles, and when reaching the intended particle diameter, a large amount of water is added to stop the particle growth and heating and stirring are further continued to smoothen the particle surface and to control the particle diameter, thereafter, the particles which are in the water-bearing and floating state, are dried with heating to form the toner desired. An infinitely water-soluble solvent, such as alcohol, may be added concurrently with a flocculant.

There is preferably employed a method of preparing toners in which, after dissolving a crystalline material in a polymerizable monomer, the monomer is polymerized to form composite resin particles and the thus formed resin particles and colorant particles are subjected to flocculation and fusion. A crystalline material may be dissolved or melted in the monomer.

A process in which composite resin particles obtained in a multistep polymerization process and colorant particles are subjected to flocculation and fusion is preferred in the preparation of toners. A multistep polymerization will be described below.

### (Manufacturing Method of Composite Resin Particle Obtained in Multistep Polymerization)

When a multistep polymerization process is used, the manufacturing method of the toner of the present invention preferably contains the following steps:

1: multistep polymerization step,

2: flocculation/fusion step in which composite resin particles and colorant particles are allowed to flocculate and to fuse to obtain toner particles,

3: filtration and washing step in which the toner particles are filtered out of the toner particle dispersion and washed to remove surfactant and the like,

4: drying step in which the washed toner is dried, and

5: a step of adding an external additive to the dried toner particles.

The foregoing steps will be further described below.

### [Multistep Polymerization Step]

The multistep polymerization step is a polymerization process which is undergone to expand the molecular weight distribution of resin particles to obtain toner particles preventing off-setting. Thus, polymerization reaction is undergone in the manner of being separated to multiple steps (or stepwise) to form phases differing in molecular weight distribution in the interior of the resin particle so that the obtained resin particles each exhibit a molecular weight gradient from the center of the particle to the surface. For example, after a dispersion of high molecular weight resin particles is obtained, a polymerizable monomer and a chain transfer agent are further added thereto to the low molecular weight surface layer.

In the present invention, multistep polymerization of three steps or more is preferred in terms of manufacturing stability and fracturing resistance. There will be described the two-step polymerization process and three-step polymerization process, as representative examples of multi-step polymerization. In the toner obtained in the multistep polymerization reaction, the outer layer is preferably comprised of a low molecular weight resin in terms of fracturing resistance.

### <Two-Step Polymerization Process>

The two-step polymerization process is a process of preparing composite resin particles which are each comprised of a central portion (nucleus) formed of a high molecular weight resin, containing a crystalline material, and an outer layer (shell) formed of a low molecular weight resin.

Specifically, a monomer solution obtained by dissolving a crystalline material in a monomer is dispersed in an aqueous medium (e.g., aqueous surfactant solution) in the form of oil drops and this system is subjected to polymerization (1st polymerization step) to prepare a dispersion of resin particles of high molecular weight, containing a crystalline material.

Subsequently, to the dispersion of resin particles, a polymerization initiator and a monomer to obtain a low molecular weight resin are added and allowed to be polymerized (2nd polymerization step) in the presence of the resin particles to form a covering layer comprised of a low molecular weight resin on the resin particle surface.

### <Three-Step Polymerization Process>

The three-step polymerization process is a process of preparing composite resin particles which are comprised of a central portion (nucleus) formed of a high molecular weight resin, an interlayer containing a crystalline material and an outer layer (shell) formed of a low molecular weight resin. Thus the toner of the present invention has a structure of aforementioned composite resin particles.

This process will be specifically explained. A dispersion of resin particles obtained according to a conventional polymerization process (1st polymerization step) is added to an aqueous medium (e.g., aqueous surfactant solution), a monomer solution obtained by dissolving a crystalline material in a monomer is dispersed in the aqueous medium in the form of oil drops and this system is subjected to polymerization (2nd polymerization step) to prepare a dispersion of composite resin particles (high molecular weight resin-intermediate molecular weight resin) having a covering layer (interlayer) comprised of resin (polymer of the monomer) on the surface of the resin particle (nucleus particle).

Subsequently, to the obtained composite resin particle dispersion, a polymerization initiator and a monomer to obtain a low molecular weight resin are added and allowed to be polymerized (3rd polymerization step) in the presence of the resin particles to form a covering layer comprised of a low molecular weight resin (polymer of monomer) on the resin particle surface. Introduction of the interlayer can disperse the minute crystalline material homogeneously, thus it is preferable.

In one embodiment of the toner preparation method, a polymerizable monomer is polymerized in an aqueous medium. Resin particles (nuclei) containing a crystalline material or a covering layer (interlayer) can be formed in such a manner that the crystalline material is dissolved in a monomer and the obtained monomer solution is dispersed in the form of oil droplets dispersed in an aqueous medium, then, this system is further subjected to polymerization process to obtain latex particles.

Herein, the aqueous medium refers to a medium comprised of 50 to 100 mass % water and of a 0 to 50 mass % water-soluble organic solvent. Examples of a water-soluble organic solvent include methanol, ethanol, isopropanol, butanol, acetone, methyl ethyl ketone, and tetrahydrofuran and alcohol type organic solvents not dissolving the obtained resin are preferred.

Examples of a polymerization process suitable for the foregoing formation of resin particles containing a crystalline material or a covering layer include a process in which a surfactant is dissolved in an aqueous medium at a concentration less than the critical micelle concentration and a monomer solution obtained by dissolving a releasing agent is dispersed in the form of oil droplets dispersed in the aqueous medium, employing mechanical energy, then, a water-soluble polymerization initiator is added to the obtained dispersion to allow radical polymerization to occur within the oil droplets (hereinafter, also called a mini-emulsion method in the present invention). Further, instead of adding a water-soluble polymerization initiator, an oil-soluble polymerization initiator may be added to the monomer solution, concurrently with the addition of the water-soluble polymerization initiator.

In the mini-emulsion method differing from the conventional emulsion polymerization method, a crystalline material dissolved in an oil phase does not leave the oil phase and a sufficient amount of the releasing agent can be introduced into the formed resin particles containing a crystalline material or a covering layer.

Dispersing machines to perform the foregoing oil droplet dispersion employing mechanical energy are not specifically limited, including, for example, a stirring apparatus provided with a high-speed rotor, CLEAR MIX (product of M Technique Co., Ltd.), an ultrasonic disperser, a mechanical type homogenizer, Manton-Gaulin homogenizer and a pressure type homogenizer. The dispersing particle diameter is 10 to 1000 nm, preferably 50 to 1000 nm, and more preferably 30 to 300 nm.

The phase separation structure of a crystalline material of the toner, that is, a Feret horizontal diameter, shape factor and their coefficients of variation may be controlled to control the dispersing particle diameter distribution.

Commonly known methods such as the emulsion polymerization method, the suspension polymerization method and the seed polymerization method are also adoptable as a polymerization process for forming resin particles containing a crystalline material or a covering layer. These polymerization methods are also adaptable to obtain resin particles (nucleus) or a covering layer constituting composite resin particles and contain no crystalline material.

The diameters of composite resin particles obtained in the foregoing polymerization process, which can be determined using a electrophoresis light-scattering photometer (ELS-800, product of Otsuka Denshi Co., Ltd.), are within the range of 10 to 1000 nm.

The glass transition temperature (Tg) of composite resin particles is preferably within the range of 48 to 74° C., and more preferably 52 to 64° C.

The softening point of the composite resin particles is preferably within the range of 95 to 140° C.

The toner of the present invention is obtained by allowing resin particles to be fused onto the resin and colorant particle surface through flocculation and fusion to form a resin layer. This will be further described below.

### [Flocculation/Fusion Step]

The flocculation/fusion step is a stage in which composite resin particles obtained in the foregoing multistep polymerization step and colorant particles are allowed to be flocculated and fused to form irregular-form (or non-spherical) toner particles (in which flocculation and fusion simultaneously occur).

The flocculation/fusion means flocculation (flocculation of particles) and fusion (disappearance of the interface between particles) being concurrently caused, or action allowing flocculation and fusion to be concurrently caused. To allow flocculation and fusion to concurrently result, it is preferred to flocculate particles (composite resin particles, colorant particles) at a temperature higher than a glass transition temperature (Tg) of a resin forming the composite resin particles.

In the flocculation/fusion step, particles of an internal additive such as a charge control agent (microparticles having a number-average primary particle diameter of 10 to 1000 nm) may be flocculated and fused together with composite resin particles and colorant particles. Colorant particles may be surface-modified, in which commonly known surface-modifiers are usable.

### [Ripening Step]

The ripening step is a step following the foregoing flocculation/fusion step, in which a crystalline material is phase-separated, while the temperature is maintained near the melting point of a crystalline material, and preferably within a melting point ±20° C. The Feret horizontal diameter, shape factor and their coefficients of variation can be controlled in this step.

In the present invention, the sum of divalent (or trivalent) metal elements added as a flocculant and monovalent metal elements added as a flocculation terminator is preferably 350 to 35000 ppm. The residual content of metal ions in a toner can be determined using fluorescent X-ray spectrometer System3270 Type (available from Rigaku Denki Corp.), in which the intensity of fluorescent X-rays emitted from metal species of metal salts used as a flocculant (e.g., calcium originating in calcium chloride) is measured. Specifically, plural toners having a known metal salt flocculant content are prepared and 5 g of each of the toners is pelletized, then, the relationship (calibration curve) between the metal salt flocculant content (ppm by weight) and intensities of fluorescent X-rays emitted from metal species of the metal salts are determined. Subsequently, a toner (sample) to determine the metal salt flocculant content is similarly pelletized and the intensity of a fluorescent X-ray emitted from a metal specie of the metal salt flocculant is measured to determine the content, that is, the residual quantity of metal ions contained in the toner.

### [Filtration and Washing Step]

The filtration and washing step comprises filtration to filter off toner particles from the toner particle dispersion, obtained in the foregoing step, and washing to remove adherents such as surfactants or coagulants from the filtrated toner particles (aggregates in a cake form). Filtration methods are not specifically limited, including centrifugal separation, reduced-pressure filtration using a Nutsche funnel and a filtration method using a filter press.

### [Drying Step]

The drying step is a stage in which the washed toner particles are subjected to drying treatment. In the present invention, this drying step is preferably a step to be dried under a reduced pressure.

Reduced-pressure drying machines usable in this step include, for example, a spray drier, a vacuum freeze drier and a reduced-pressure drier; however, the present invention is not limited thereto. A standing rack drier, a moving rack drier, a fluidized bed drier, a rotary drier and a stirring drier, which are pressure-reducible, are preferably used.

The drying condition may not be limited as far as the drying temperature is not higher than the Tg of the used resin, and the value of reduced pressure and the drying duration may be appropriately selected without being limited.

When dried particles are aggregated with each other by attraction force between particles, the aggregates may be disintegrated. Mechanical disintegrating apparatuses such as a jet-mill, a Henschel mixer, a coffee mill or a food processor can be employed as a disintegrating apparatus.

It is preferred to prepare the toner in the manner that composite resin particles are formed in the absence of a colorant and a dispersion of colorant particles is added to a dispersion of the composite resin particles to cause the composite particles and the colorant particles to be salted out, flocculated and fused.

Inhibition of the polymerization reaction to obtain the composite resin can be avoided by preparation of the composite resin particles in the absence of a colorant. As a result, staining of the fixing apparatus and image staining, which are caused by accumulation of a toner, can be reduced without vitiating superior off-set resistance.

The polymerization reaction to obtain composite resin particles is completely undergone so that no monomer or no oligomer remains in toner particles and, during the imaging process, production of foul odors is reduced in the thermal fixing stage using the toner.

Further, surface characteristics of the thus obtained toner particles are uniform, leading to a narrow distribution of electrostatic charge, whereby formation of images exhibiting superior sharpness can be achieved over a long period of time. Using such a toner which is homogeneous in composition, molecular weight and surface characteristic among particles, enhancement of off-set resistance and prevention of winding can be achieved, while maintaining an excellent adhering property to an image support (or a high fixing strength), in the imaging process including a fixing step of a contact heating system, leading to formation of images exhibiting an optimal glossiness.

Hereinafter, constituent factors used in the process of preparing toners will be described.

### (Polymerizable Monomer)

A polymerizable toner to make a resin (binder) of the toner contains a hydrophobic monomer as an essential component and a cross-likable monomer is optionally used therein. It is desirable to contain at least one kind of monomer having an acidic polar group or a monomer having a basic polar group.

### (1) Hydrophobic Monomer:

Hydrophobic monomers constituting monomer components are not specifically limited and commonly known hydrophobic monomers are usable. One or more kinds of monomers can be used in combination to meet required characteristics.

Specifically, there are usable a monovinylaromatic type monomer, a (metha)acrylic acid ester type monomer, a vinyl ester type monomer, a vinyl ether type monomer, a monoolefin type monomer, a diolefin type monomer and a halogenated olefin type monomer.

Examples of a vinyl aromatic type monomer include styrene monomers such as styrene, o-methylstyrene, m-methylstyrene, p-methylstyrene, p-methoxystyrene, p-phenylstyrene, p-chlorostyrene, p-ethylstyrene, p-n-butylstyrene, p-tert-butylstyrene, p-n-hexylstyrene, p-n-octylstyrene, p-n-nonylstyrene, p-n-decylstyrene, p-n-dodecylstyrene, 2,4-dimethylstyrene and 3,4-dichlorostyrene, and derivatives thereof.

Examples of acryl type monomers include acrylic acid, methacrylic acid, methyl acrylate, ethyl acrylate, butyl acrylate, 2-ethylhexyl acrylate, cyclohexyl acrylate, phenyl acrylate, methyl methacrylate, ethyl methacrylate, butyl methacrylate, hexyl methacrylate, 2-ethylhexyl methacrylate, ethyl β-hydroxyacrylate, propyl γ-aminoacrylate, stearyl methacrylate, dimethylaminoethyl methacrylate and diethylaminoethyl methacrylate.

Examples of a vinyl ester type monomer include vinyl acetate, vinyl propionate, and vinyl benzoate.

Examples of a vinyl ether type monomer include vinyl methyl ether, vinyl ethyl ether, vinyl sobutyl ether and vinyl phenyl ether.

Example of a monoolefin type monomer include ethylene, propylene, isobutylene, 1-butene, 1-pentene and 4-methyl-1-pentene.

Example of diolefin type monomer include butadiene, isoprene and chloroprene.

### (2) Cross-Linkable Monomer:

A cross-linkable monomer may be added to improve characteristics of resin particles. Examples of a cross-linkable monomer include ones containing at least two unsaturated bonds, such as divinylbenzene, divinylnaphthalene, divinylether, diethylene glycol methacrylate, ethylene glycol dimethacrylate, polyethylene glycol dimethacrylate and diallyl phthalate.

### (3) Acidic Polar Group-Containing Monomer:

Monomers containing an acidic polar group include (a) α,β-ethylenically unsaturated compound containing a carboxyl group (—COOH), and (b) a α,β-ethylenically unsaturated compound containing a sulfonic acid group (—SO₃H).

Examples of (a) a α,β-ethylenically unsaturated compound containing a carboxyl group (—COOH) include acrylic acid, methacrylic acid, fumaric acid, methacrylic acid, itaconic acid, cinnamic acid, monobutyl maleate, monooctyl maleate and their metal salts, such as Na or Zn.

Examples of (b) a α,β-ethylenically unsaturated compound containing a sulfonic acid group (—SO₃H) include a sulfonated styrene and an Na salt thereof, allylsulfosuccinic acid, octyl allylsulfosuccinate and an Na salt thereof.

### (4) Basic Polar Group-Containing Monomer:

Examples of monomers containing a basic polar group include (i) a (meth)acrylic acid ester of an aliphatic alcohol containing an amine or a quaternary ammonium group and 1 to 21 carbon atoms (preferably 2 to 8, and more preferably 2 carbon atoms); (ii) a (meth)acrylic acid amide or a (meth)acrylic acid amide which is substituted by mono- or di-alkyl group of 1 to 18 carbon atoms on a N-atom; (iii) a vinyl compound which is substituted by a N-containing heterocyclic group; and (iv) a N,N-diallyl-alkylamine or its quaternary ammonium salt. Of these, a (meth)acrylic acid ester of an aliphatic alcohol containing an amine or a quaternary ammonium group is preferred as a basic polar group-containing monomer.

Examples of (i) a (meth)acrylic acid ester of an aliphatic alcohol containing an amine or a quaternary ammonium group include dimethylaminoethyl acrylate, dimethylaminoethyl methacrylate, diethylaminoethyl acrylate, diethylaminoethyl methacrylate, quaternary ammonium salts of the foregoing four compounds, 3-dimethylaminophenyl acrylate, and 2-hydroxy-3-methacryloxypropyl methylammonium.

Examples of (ii) a (meth)acrylic acid amide or a (meth)acrylic acid amide which is substituted by mono- or di-alkyl group on a N-atom include acrylamide, N-butyl acrylamide, N,N-dibutylacrylamide, piperidyl acrylamide, methacrylamide, N,N-dimethyl acrylamide and N-octadecyl acrylamide.

Examples of (iii) a vinyl compound which is substituted by a N-containing heterocyclic group include Examples of (iii) a vinyl compound which is substituted by a N-containing heterocyclic group include vinylpyridine, vinylpyrrolidone, vinyl-N-methylpyridinium chloride and vonyl-N-ethypyridinium chloride.

Examples of (iv) a N,N-diallyl-alkylamine or its quaternary ammonium salt include N,N-diallylmethlammonium chloride and N-N-diallylethylammonium chloride.

### (Polymerization Initiator)

Any water-soluble polymerization initiator (also simply called initiators) is optimally usable. Examples thereof include persulfates (e.g., potassium persulfate, ammonium persulfate), azo compounds [e.g., 4,4′-azobis-cyanovaleric acid and its salt, 2,2′-azobis(2-amidinopropane)-salt], and peroxide compounds such as hydrogen peroxide and benzoyl peroxide. The foregoing polymerization initiators may be combined with a reducing agent and used as a redox initiator. The use of a redox initiator results in enhanced polymerization activity and lowering of the polymerization temperature, thereby shortening the polymerization time.

The polymerization temperature can be chosen at any temperature higher than the lowest temperature forming a radical of an initiator, for example, within the range of 50 to 90° C. The use of polymerization initiators initiating at ordinary temperature, for example, a combination of hydrogen peroxide and a reducing agent (e.g., ascorbic acid) enables polymerization at room temperature or a higher temperature.

### (Surfactant)

To undergo mini-emulsion polymerization using a polymerizable monomer described above, it is preferred to disperse the monomer in the form of oil droplets dispersed in an aqueous medium, using a surfactant. Surfactant usable therein are not specifically limited but preferred surfactants include ionic surfactants.

Example of an ionic surfactant include sulfonic acid salts (e.g., sodium dodecybenzenesulfonate, sodium arylalkyl polyether sulfonate, sodium 3,3-disulfonediphenylurea-4,4-diazo-bis-8-sodium-6-sulfonate, o-carboxybenzene-azo dimethylaniline, sodium 2,2,5,5-tetramethyl-triphenylmethane-4,4-diazo-bis-β-naphthol-6-sulfonate), a sulfuric acid eater salts (e.g., sodium dodecylsulfate, sodium tetradecylsulfate, sodium pentadecylsulfate, sodium octylsulfate) and carboxylic acid salts (e.g., sodium oleate, sodium laurate, sodium caprylate, sodium caproate, potassium stearate, calcium oleate).

There are also usable nonionic surfactants. Specific examples thereof include polyethylene oxide, polypropylene oxide, a combination of polyethylene oxide and polypropylene oxide, an ester of polyethylene glycol and a higher fatty acid, alkylphenol polyethylene oxide, an ester of a higher fatty acid and polyethylene glycol, an ester of a higher fatty acid and polypropylene oxide and sorbitan ester.

In the present invention, the foregoing surfactants are mainly used as an emulsifying agent in emulsion polymerization but may be used in other processes or for other purposes.

### (Molecular Weight Distribution of Resin Particles and Toner)

The toner of the present invention preferably has a peak or a shoulder in 100,000-1,000,000 and in 1,000-500,000, and, more preferably, has a peak or a shoulder in 100,000-1,000,000, 25,000-150,000 and in 1,000-50,000.

Preferably use is a resin containing at least both of a high molecular weight component having a peak or a shoulder in the region of 100,000-1,000 and a low molecular weight component having a peak or a shoulder in the region of 1,000-less than 50,000, and, more preferably, the resin has an intermediate molecular weight substance having a peak or a shoulder in the region of 15,000-100,000.

The method of measuring a molecular weight of a toner or a resin is preferably GPC (Gel Permeation Chromatography) using THF (tetrahydrofuran) as a solvent. Namely, added to 1 ml of THF is a measured sample in an amount of 0.5 to 5.0 mg or, more specifically, 1 mg, and is sufficiently dissolved at room temperature while stirring employing such as a magnetic stirrer. Subsequently, after filtering the resulting solution employing a membrane filter having a pore size of 0.45 to 0.50 μm, the filtrate is injected in a GPC. Measurement conditions of GPC are as follows. A column is stabilized at 40° C., and THF is flowed at a rate of 1 cc per minute. Then measurement is carried out by injecting approximately 100 μl of the sample of a concentration of 1 mg/ml. It is preferable that commercially available polystyrene gel columns are combined and used. For example, it is possible to cite combinations of Shodex GPC KF-801, 802, 803, 804, 805, 806, and 807, produced by Showa Denko Co., combinations of TSKgel G1000H, G2000H, G3000H, G4000H, G5000H, G6000H, G7000H, TSK guard column, and the like. Further, as a detector, a refractive index detector (IR detector) or a UV detector is preferably employed. When the molecular weight of samples is measured, the molecular weight distribution of the sample is calculated employing a calibration curve which is prepared employing monodispersed polystyrene as standard particles. Approximately ten polystyrenes samples are preferably employed for determining the calibration curve.

### (Flocculant)

Flocculants used in the present invention are preferably chosen from metal salts.

Metal salts used as a flocculant or a flocculation terminator, as described hereinafter, include monovalent metal salts, for example, salts of alkali metals such as sodium, potassium and lithium; divalent metal salts, for example, salts of alkaline earth metals such as calcium and magnesium and divalent metal salts such as manganese and copper; and trivalent metal salts, such as iron and aluminum.

Specific examples thereof include monovalent metal salts such as sodium chloride, potassium chloride and lithium chloride; divalent metal salts such as magnesium chloride, calcium chloride, calcium nitrate, zinc chloride, copper sulfate, magnesium sulfate and manganese sulfate; trivalent metal salts such as aluminum chloride and iron chloride. These are optimally chosen according to the object. Generally, a salt of a divalent metal gives a smaller critical flocculation concentration (a flocculation value or a flocculation point) than a salt of a monovalent metal, and a salt of a trivalent metal gives a further smaller critical flocculation concentration.

The critical flocculation concentration as mentioned in the present invention is a measure relating to stability of dispersed material in an aqueous dispersion, indicating a concentration at which flocculation occurs when adding a flocculant. The critical flocculation concentration varies depending on the flocculant itself and the dispersing agent used therein, which are described, for example, in S. Okamura et al., “Kobunshi Kagaku” 17, 601 (1960) and therefrom, values can be found. Alternatively, a desired salt is added to a particle dispersing solution with varying the concentration to measure the ζ-electric potential of the particle dispersing solution and the salt concentration at which the ζ-electric potential starts to vary can be defined as the critical flocculation concentration.

In the present invention, a particulate polymer dispersion is treated using the metal salt described above so as to form a concentration greater than the critical flocculation concentration. In this regard, directly adding a metal salt or addition in the form of an aqueous solution is appropriately chosen according to the object. When added in the form of an aqueous solution, the concentration of the added metal salt needs to be greater that the critical flocculation concentration, based on the whole volume of the particulate polymer dispersion and the aqueous metal salt solution.

In the present invention, the concentration of a metal salt used as a flocculant may be greater than the critical flocculation concentration, preferably by a factor of at least 1.2 and more preferably at least 1.5 times greater than the critical flocculation concentration.

### (Releasing Agent)

A toner preferably is one which is obtained by allowing resin particles occluding a releasing agent to be fused in an aqueous medium. Subjecting such resin particles occluding a releasing agent and color particle to flocculation/fusion results in a toner in which the releasing agent is finely dispersed.

As a releasing agent, a low molecular weight polypropylene (having a number-average molecular weight of 1500 to 9000) or a low molecular weight polyethylene os preferred, and a specifically preferred releasing agent is a compound represented by the following formula:

R₁—(OCO—R₂)ₙ

In the formula, n is an integer of 1 to 4 (preferably 2 to 4, more preferably 3 or 4 and still more preferably 4); R₁ and R₂ are each a hydrocarbon group, which may be substituted. R₁ has 1 to 40 carbon atoms (preferably 1 to 20, and more preferably 2 to 5 carbon atoms); R₂ has 1 to 40 carbon atoms (preferably 16 to 30, and more preferably 18 to 26 carbon atoms).

Next, examples of a typical compound will be shown below.

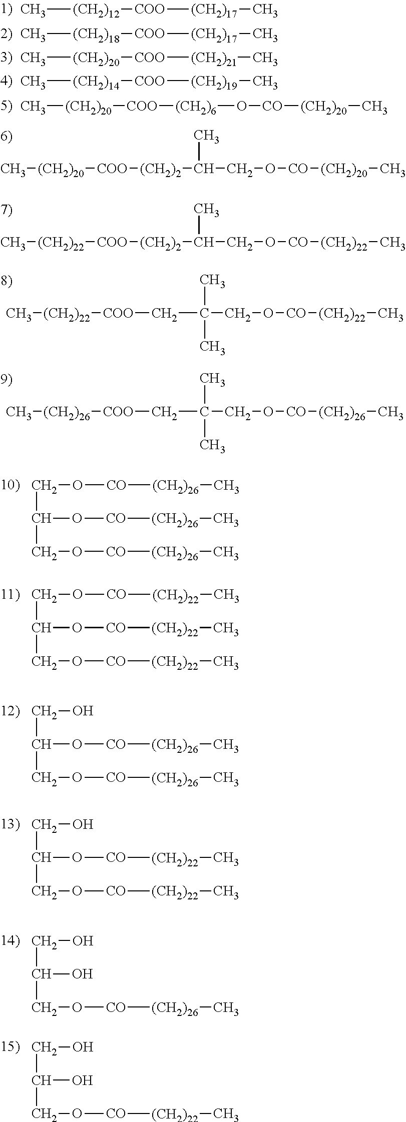

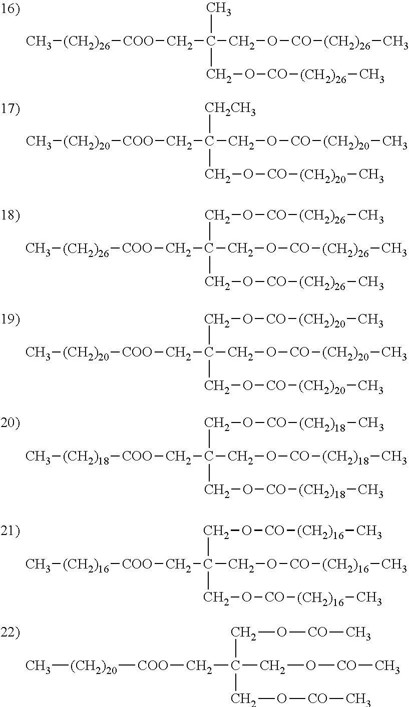

The foregoing releasing agents, as a fixing modifier is added preferably in an amount of 1 to 30%, more preferably 2 to 20%, and still more preferably 3 to 15% by mass, based on the whole electrostatic image developing toner.

In the toner of the present invention, it is preferred that the foregoing releasing agent is allowed to be occluded in resin particles in the process of mini-emulsion polymerization and the resin particles, together with toner particles, are further allowed to be flocculate and fused.

### (Charge Control Agent)

In addition to the foregoing colorants and releasing agents, there can be incorporated material giving various functions to the toner as a constituent. Specifically, examples thereof include a charge control agent. Such a constituent may be added concurrently with resin particles and colorant particles in the stage of flocculation/fusion, may be occluded in the toner, or may be incorporated to the resin particles.

As a charge control agent, commonly known, water-dispersible one is usable. Examples thereof include Nigrosine type dyes, metal salts of naphthenic acid or higher fatty acids, an alkoxylated amine, a quaternary ammonium salt compound, an azo type metal complex and a metal salicylate or its metal complex.

### (External Additive)

To improve flowability and enhance cleaning properties, so-called external additives may be incorporated. Such external additives are not specifically limited and include various inorganic particles, organic particles and lubricants.

Commonly known inorganic particulates are usable as an external additive used for the toner. Specifically, particulate silica, particulate titanium, and particulate aluminum are preferred. Hydrophobic inorganic particulates are preferred.

Specific example of particulate silica include R-805, R-976, R-974, R-972, R-812 and R-809, which are commercial available from Nippon Aerogel Co., Ltd.; HVK-2150 and H-200, which are commercially available from Hoechst Co.; TS-720, TS-530, TS-610, H-5 and MS-5, which are commercially available from Cabot Co., Ltd.

Specific examples of particulate titanium include T-805 and T-604, which are commercial available from Nippon Aerogel Co., Ltd.; MT-100S, MT-100B, MT-500BS, MT-600 and MT-600SS, which are commercially available from TIKA Co., Ltd.; TA-300SI, TA-500, TAF-30, TAP-510 and TAF-510T, which are commercially available from Fuji Titan Co., Ltd.; IT-S, IT-OA, IT-OB and IT-OC, which are commercially available from Idemitsu Kosan Corp.

Further, specific examples of particulate aluminum include RFY-C and C-604, which are commercial available from Nippon Aerogel Co., Ltd.; and TTO-55, available from ISHIHARA SANGYO KAISHA

Organic particulates usable as an external additive are spherical particulates having a number-average primary particulate diameter of 10 to 2000 nm. Examples of constituent material of such organic particulates include polystyrene, polymethylmethacrylate, and styrene-methyl methacrylate copolymer.

Lubricants usable as an external additive include higher fatty acid metal salts. Specific examples thereof include stearic acid metal salts such as zinc stearate, aluminum stearate, copper stearate, magnesium stearate, and calcium stearate; oleic acid metal salts such as zinc oleate, manganese oleate, iron oleate, copper oleate, and magnesium oleate; palmitic acid metal salts such as zinc palmitate, copper palmitate, magnesium palmitate, and calcium palmitate; linolic acid metal salts such as zinc linolate and calcium linolate; ricinolic acid metal salts such as zinc ricinolate and calcium ricinolate.

The amount of an external additive to be added preferably is 0.1 to 5% by mass, based on the toner.

### <Addition Step of External Additive>

The process of adding an external additive is the step of adding the external additive to dried toner particles.

Well known various mixing apparatuses are usable as an apparatus to incorporate an external additive, including a turbulent mixer, a Henschel mixer, a nauter mixer and a V-type mixer.

### (Toner Particle)

The volume-average toner particle diameter is preferably 3 to 10 μm, and more preferably 3 to 8 μm. The particle diameter can be controlled by adjusting flocculant (salting-out agent) concentration, organic solvent amount, fusion time and polymer composition in the process of preparing the toner.

Herein, the volume-average toner particle diameter refers to a median diameter D50 in the particle diameter distribution based on volume. A volume-average particle diameter of 3 to 10 μm reduces fine adhesive toner particles which are to be adhered to a heating member, causing off-setting and enhances transfer efficiency, leading to enhanced halftone image quality and enhanced fine-line and dot qualities.

The volume-average particle diameter of the toner can be measured using Coulter Counter TA-II, Coulter multisizer, or SLAD 1100 (a laser diffraction type particle diameter measuring apparatus, produced by SHIMADZU Corp.).

In the present invention, the particle diameter measurement was conducted using a Coulter multisizer which was connected to an interface outputting a particle diameter distribution and a personal computer. The foregoing Coulter Counter was used at an aperture of 100 μm and a volume distribution of toner particles of 2 μm or more (for example, 2 to 40 μm) was measured to determine the particle diameter distribution and the average particle diameter.

### <Range of Preferable Shape Factor of Toner Particles>

The ratio of toner particles having a shape factor within the range of 1.0-1.6 is preferably 65% or more by number, preferably, the ratio of toner particles having a shape factor within the range of 1.2-1.6 is 65% by or more number, and, more preferably, the ratio of toner particles having a shape factor within the range of 1.2-1.6 is preferably 70% ore more by number.

As used herein, the term “shape factor” refers to the value represented by the following expression, and represents the degree of roundness of toner particles.

Shape factor=[(maximum diameter/2)²×π]/projected area

where the maximum diameter refers to the width of particles which is determined in such a manner that when the projected image of the toner particle onto a plane is interposed by two parallel lines, the resulting width of the parallel lines reaches a maximum value, and the projected area refers to the area of the projected image of a toner particle onto a plane. The shape factor is determined in such a manner that images of toner particles magnified at a factor of 2,000 employing a scanning electron microscope are observed, and the resulting images are subjected to photographic image analysis employing a “Scanning Image Analyzer” (produced by JEOL, Ltd.). At that time, 100 random toner particles are employed and the shape factor is determined via the above expression.

With respect to the toner of the present invention, the diameter of each toner particle is expressed as D and natural logarithm ln D is taken along a horizontal axis. The horizontal axis is divided into a plurality of classes with an interval of 0.23 and thus a histogram representing a number based particle diameter distribution is drawn. It is preferable that the sum (M) of a relative frequency of toner particles contained in the highest frequency class (m1) and a relative frequency of toner particles contained in the second highest frequency class (m2) be 70% or more.

When the sum (M) of the relative frequency (m1) and the relative frequency (m2) is 70% or more, occurrence of selective development is surely suppressed by using the toner in the image forming process, since the dispersion of the diameter distribution of the toner becomes narrower.

In the present invention, the aforementioned histogram showing a number based particle diameter distribution is a number based particle diameter distribution in which natural logarithm ln D (D: particle diameter of each toner) is divided into a plurality of classes with an interval of 0.23 (namely, 0-0.23:0.23-0.46:0.46-0.69:0.69-0.92:0.92-1.15:1.15-1.38:1.38-1.61:1.61-1.84:1.84-2.07:2.07-2.30:2.30-2.53:2.53-2.76 . . . ). This histogram is obtained by transferring particle diameter data measured under the following conditions using Coulter-Multisizer to a computer through an I/O unit, followed by calculating in the computer using a particle diameter distribution analysis program.

### [Measurement Conditions]

1: Aperture: 100 μm

2: Sample preparation method: An adequate dose of the surfactant (a mild detergent) is added to 50-100 ml of an electrolyte “ISOTON R-II” (manufactured by Coulter Scientific Japan Co., Ltd.) and stirred, in which 10-20 mg of a measurement sample is added. The resulting system is subjected to a dispersion treatment for one minute with the ultrasonic homogenizer to prepare the sample.

Toner particles according to the present invention preferably exhibit a volume-based median diameter (also denoted simply as D50v) of not less than 3 μm and not more than 8 μm. The volume-based median diameter falling within the foregoing region enables faithful reproduction of fine-dot images, for example, at a level of 1200 dpi (dpi: the number of dots per inch or 2.54 cm).

Regarding the toner of the present invention, one of the tasks is to achieve faithful reproduction of the color of a photographic Image. The minute particle diameter level at a volume-based median diameter falling within the minute particle diameter enables to obtain a highly precise photographic image in which a dot image constituting the photographic image is equivalent to or more than a high-precision printed image. Specifically, in on-demand printing in which orders for several hundreds to several thousands sets are often received, high image quality prints with high-precision photographic images can be delivered to a user.

The volume-based median diameter (D50v) of toner particles can be determined using Coulter Multisizer 3 (Beckmann Coulter Co.), connected to a computer system for data processing.

The measurement procedure is as follows: 0.02 g of toner particles are added to 20 ml of a surfactant solution (for example, a surfactant solution obtained by diluting a surfactant containing neutral detergent with pure water to a factor of 10) and dispersed by an ultrasonic homogenizer to prepare a toner dispersion. Using a pipette, the toner dispersion is poured into a beaker having ISOTON II (produced by Beckman Coulter Co.) within a sample stand, until reaching a measurement concentration of 5 to 10%. The measurement count was set to 2,500 to perform measurement. Then aperture diameter of Multisizer 3 was 50 μm.

The toner of the present invention preferably exhibits a coefficient of variation (CV value) of volume-based particle diameter distribution of not less than 2% and not more than 21%, more preferably not less than 5% and not more than 15%.

The coefficient of variation (CV value) of volume-based particle diameter distribution represents a dispersion degree of particle diameter distribution, based on volume and defined as below:

CV value (%)={(standard deviation of number-based particle diameter distribution)/[median diameter (D50v) of number-based particle diameter distribution]}×100

A low value indicates a sharper particle diameter distribution and means that the particle diameter tends to be uniform. Uniform particle diameter enables more precise reproduction of fine-dot images or fine lines, as is essential in digital image formation. Printing a photographic image with uniform-diameterd toner particles results in photographic images of high image quality at a level equivalent to or higher than an image prepared by printing ink.

The toner of the present invention preferably exhibits a softening point (Tsp) at a temperature of 70 to 110° C., and more preferably 70 to 100° C. Colorants used in the toner of the present invention are stable, causing no change in spectrum even when affected by heat. A softening point falling with the foregoing range can reduce effects of heat applied to the toner in fixing. Accordingly, image formation is performed without relying on a colorant, so that it is expected to, develop broad stable-color reproduction.

A toner with a softening point falling within the foregoing range enables fixing a toner image at a lower temperature than the prior art, rendering it feasible to perform image formation friendly to environments at reduced power consumption.

The softening point of a toner can be controlled by the following methods, singly or in combination. Namely:
(1) the kind or the composition of monomer used for resin formation is adjusted;
(2) the molecular weight of a resin is controlled by the kind or the amount of a chain-transfer agent; and
(3) the kind or amount of a wax is controlled.

The softening point of a toner may be measured by using, for example, Flow Tester CPT-500 (produced by Shimadzu Corp.). Specifically, a sample which is molded to a 10 mm high column, is compressed by a plunger at a load of 1.96×10⁶ Pa with heating at a temperature rising rate of 6° C./min and extruded from a 1 mm diameter and 1 mm long nozzle, whereby, a curve (softening flow curve) between plunger-drop and temperature is drawn. The temperature at which flowing-out is initiated is defined as the fusion-initiation temperature and the temperature corresponding to 5 mm drop is defined as the softening temperature.

There will be described a method of preparing the toner of the present invention.

The toner of the present invention is comprised of particles containing at least a colorant represented by Formula (1) and a silanol compound represented by Formula (2) (hereinafter, also denoted as colored particles). The colored particles constituting the toner of the present invention are not specifically limited but can be prepared according the conventional methods for preparing toners. More specifically, preparation is feasible by applying, for example, a so-called grinding method for preparing a toner through kneading, grinding and classification or a preparation method of a polymer toner in which a polymerizable monomer is polymerized with controlling the shape or diameter of particles to achieve particle formation (for example, emulsion polymerization, suspension polymerization, or polyester elongation).

When preparing the toner of the present invention through a grinding method, kneading is performed with maintaining a temperature at not more than 130° C. When kneading a mixture at a temperature exceeding 130° C., heating action applied to the mixture tends to cause variation in the coagulation state of a colorant, rendering it difficult to maintain uniform colorant coagulation. It is a concern that variation in the coagulation state causes variations in color of the prepared toner, leading to color contamination.

### <Developers>

The toner according to the present invention may be employed as either a single-component developer or a two-component developer.

When the toner is used as a single component toner, cited are a non-magnetic single-component developer, and a magnetic single-component developer in which magnetic particles having a diameter of 0.1 to 0.5 μm are incorporated into a toner. The toner may be employed in both developers.

Further, the toner may be blended with a carrier and employed as a two-component developer. In this case, employed as magnetic particles of the carrier may be conventional materials known in the art, such as metals, for example, iron, ferrite, magnetite, and the like, alloys of the metals with aluminum, lead or the like. Specifically, ferrite particles are preferred. The volume average particle diameter of the magnetic particles is preferably 15 to 100 μm, and is more preferably 25 to 80 μm.

The volume average particle diameter of the carrier can be generally determined employing a laser diffraction type particle diameter distribution measurement apparatus “HELOS”, produced by Sympatec Co., which is equipped with a wet type homogenizer.

The preferred carrier is one in which magnetic particles are further coated with a resin, or a so-called resin dispersion type carrier in which magnetic particles are dispersed into resins. The resin composition for coating is not particularly limited. For example, usable are an olefin resin, a styrene resin, a styrene-acryl resin, a silicone resin, an ester resin, or a fluorine containing polymer resin. Further, resins, which constitute the resin dispersion type carrier, are not particularly limited, and resins known in the art may be employed. For example, listed may be a styrene-acrylic resin, a polyester resin, a fluorine resin, a phenol resin, and the like.

There will be described an image formation method using the toner of the present invention. First, there will be described an image formation method using the toner of the present invention as a two-component developer.

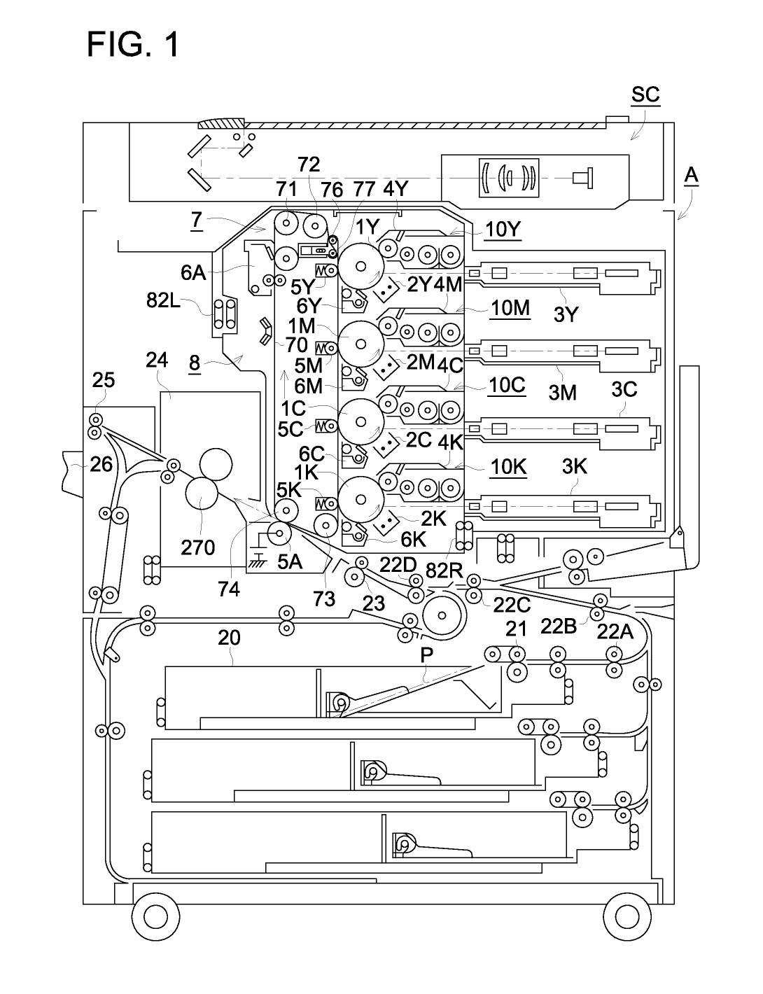

FIG. 1 illustrates an example of an image forming apparatus in which the toner of the present invention is usable as a two-component developer.

In FIG. 1, 1Y, 1M, 1C and 1K each designate photoreceptors; 4Y, 4M, 4C and 4K each designate a developing means; 5Y, 5M, 5C and 5K each designate primary transfer rollers as a primary transfer means; 5A designates a secondary transfer roller as a secondary transfer means; 6Y, 6M, 6C and 6K each designate cleaning means; the numeral 7 designates an intermediate transfer unit; the numeral 24 designates a thermal roll type fixing device; and the numeral 70 designates an intermediate transfer material.

This image forming apparatus is called a tandem color image forming apparatus, which is, as a main constitution, composed of plural image forming sections 10Y, 10M, 10C and 10K, an intermediate transfer material unit 7 as a transfer section including an endless belt form of a transfer belt, paper feeding and conveying means 21 to convey recording member P and heated roll-type fixing device 24 as a fixing means. Original image reading device SC is disposed in the upper section of image forming apparatus body A.

Image forming section 10Y to form a yellow image as one of different color toner images formed on the respective photoreceptors comprises drum-form photoreceptor 1Y as the first photoreceptor; electrostatic-charging means 2Y, exposure means 3Y and developing means 4Y which are disposed around the photoreceptor 1Y; primary transfer roller 5Y as a primary transfer means; and cleaning means 6Y. Image forming section 10M to form a magenta image as one of different color toner images formed on the respective photoreceptors comprises dram-form photoreceptor 1M as the second photoreceptor; electrostatic-charging means 2M, exposure means 3M and developing means 4M which are disposed around the photoreceptor 1M; primary transfer roller 5M as a primary transfer means; and cleaning means 6M. Image forming section 10C to form a cyan image as one of different color toner images formed on the respective photoreceptors comprises drum-form photoreceptor 1C as the third photoreceptor; electrostatic-charging means 2C, exposure means 3C and developing means 4C which are disposed around the photoreceptor 1C; primary transfer roller 5C as a primary transfer means; and cleaning means 6C. Image forming section 10K to form a black image as one of different color toner images formed on the respective photoreceptors comprises drum-form photoreceptor 1K as the fourth photoreceptor; electrostatic-charging means 2K, exposure means 3K and developing means 4K which are disposed around the photoreceptor 1K; primary transfer roller 5K as a primary transfer means; and cleaning means 6K.

Intermediate transfer unit 7 of an endless belt form is turned by plural rollers has intermediate transfer material 70 as the second image carrier of an endless belt form, while being pivotably supported.

The individual color images formed in image forming sections 10Y, 10M, 10C and 10K are successively transferred onto the moving intermediate transfer material 70 of an endless belt form by primary transfer rollers 5Y, 5M, 5C and 5K, respectively, to form a composite color image. Recording member P of paper or the like, as a final transfer material housed in paper feed cassette 20, is fed by paper feed and conveyance means 21 and conveyed to secondary transfer roller 5A through plural intermediate rollers 22A, 22B, 22C and 22D and resist roller 23, and color images are transferred together on recording member P. The color image-transferred recording member P is fixed by heat-roll type fixing device 24, nipped by paper discharge roller 25 and put onto paper discharge tray outside a machine.

After a color image is transferred onto recording member P by secondary transfer roller 5A, intermediate transfer material 70 which separated recording member P removes any residual toner by cleaning means 6A.

The primary transfer roller 5K is always compressed to the photoreceptor 1K. Other primary rollers 5Y, 5M and 5C are each the photoreceptors 1Y, 1M and 1C, respectively, only when forming color images.

Secondary transfer roller 5A is compressed onto intermediate transfer material 70 only when recording member P passes through to perform secondary transfer.

Housing 8 can be pulled out from the apparatus body A through supporting rails 82L and 82R.

Housing 8 is comprised of image forming sections 10Y, 10M, 10C and 10K and the intermediate transfer unit 7 of an endless belt form.

Image forming sections 10Y, 10M, 10C and 10K are arranged vertically in a line. Intermediate transfer material unit 7 of an endless belt form is disposed on the left side of photoreceptors 1Y, 1M, 1C and 1K, as indicated in the figure. Intermediate transfer material unit 7 comprises the intermediate transfer unit of an endless belt form 70 which can be turned via rollers 71, 72, 73, 74 and 76, primary transfer rollers 5Y, 5M, 5C and 5K and cleaning means 6A.

The image forming sections 10Y, 10M, 10C and 10K and the intermediate transfer unit 7 are pulled out of the body A by pulling the housing 8.

In the process of image formation, toner images are formed on photoreceptors 1Y, 1M, 1C and 1K, through electrostatic-charging, exposure and development, toner images of the individual colors are superimposed on the endless belt form, intermediate transfer material 70, transferred together onto recording member P and fixed by compression and heating in heat-roll type fixing device 24. After completion of transferring a toner image to recording member P, photoreceptors 1Y, 1M, 1C and 1K are subjected to cleaning any toner remained on the intermediate transfer material by cleaning device 6A and then goes into the foregoing cycle of electrostatic-charging, exposure and development to perform the subsequent image formation.

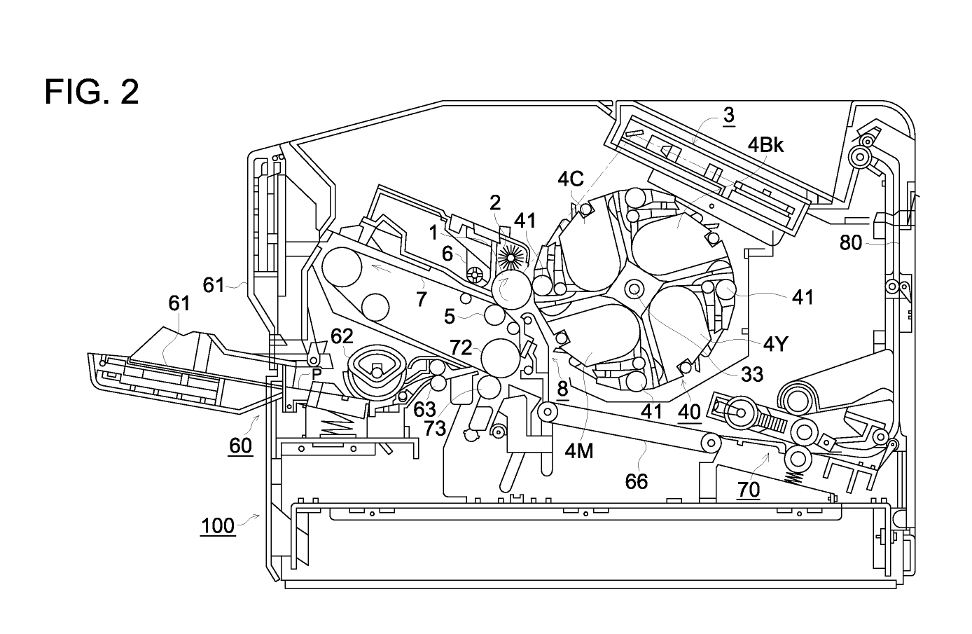

Next, there will be described an image forming method using the toner of the present invention as a nonmagnetic single-component developer. FIG. 2 illustrates an example of a full-color image forming apparatus using a nonmagnetic single-component developer. An image forming apparatus 100 shown in FIG. 2 is a typical image forming apparatus which can be installed with the aforementioned developing device 20. In the image forming apparatus of FIG. 2, there are provided, around a rotary-drivable electrostatic latent image bearing body 1 (hereinafter, also denoted as a photoreceptor drum), an electrostatic-charging brush 2 to allow the surface of the photoreceptor drum 1 to be uniformly charged to a prescribed potential and a cleaner 6 to remove any residual toner on the photoreceptor drum 1.

A laser scanning optical system 3 scanning-exposes the surface of the photoreceptor drum 1 uniformly charged by the charging brush 2 to form a latent image on the photoreceptor drum. A laser scanning optical system 3 incorporates a laser diode, a polygon mirror and an fθ optical system, with the control section of which print data for each of yellow, magenta, cyan and black are transferred from a host computer. Based on the print data for the respective colors, laser beams are successively outputted to scan the surface of the photoreceptor drum 1 to form an electrostatic latent image of each color.

A development device unit 40, housing a development device 4, supplies the individual color toners to the photoreceptor drum 1 to perform development. The development device unit 40 is provided with four development devices 4Y, 4M, 4C and 4Bk which house nonmagnetic single-component toners of yellow, magenta, cyan and black, respectively, and rotate centering around a shaft 33 to guide the individual development device 4 to the position opposing the photoreceptor drum 1.

The development device unit 40 rotates centering around the shaft 33 every time an individual electrostatic latent image is formed on the photoreceptor drum 1 by the laser scanning optical system 3, and guiding the development device housing a corresponding color toner to the position opposing the photoreceptor drum 1. Then, the respective charged color toners are successively supplied from each of the development devices 4Y, 4M, 4C and 4Bk to perform development.

In the image forming apparatus of FIG. 2, an endless intermediate transfer belt 7 is provided on the downstream side in the rotation direction of the photoreceptor drum 1 from the development device unit 40 and is rotated in synchronization with the photoreceptor drum 1. The intermediate transfer belt 7 is in contact with the photoreceptor drum 1 with being pressed by a primary transfer roller 5 to transfer the toner image formed on the photoreceptor drum 1. A secondary rotating transfer roller 73 is provided opposite a support roller 72 to support the intermediate transfer belt 7 and a toner image carried on the intermediate transfer belt 7 is transferred onto a recording material P such as a recording paper by being pressed at the site opposing the secondary transfer roller 73.

Between the full-color developing device unit 40 and the intermediate transfer belt 7, a cleaner 8 to remove any residual toner remained on the intermediate transfer belt 7 is provided with being detachable from the intermediate transfer belt 7.

A paper feeding means 60 for guiding the recording material P to the intermediate transfer belt 7 is constituted of a paper-feeding tray 61 housing recording material P, a paper-feeding 62 to feed the recording material P housed in the paper-feeding tray 61, sheet-by-sheet and a timing roller 63 to transfer the fed recording material P to the secondary transfer site.

The recording material P onto which a toner image has been transferred by being pressed is conveyed to a fixing device 24 through a conveyance means 66 constituted of an air-suction belt or the like, after which the transferred toner image is fixed on the recording material P in the fixing device 24. After fixing, the recording material P is conveyed through vertical conveyance route 80 and discharged onto the upper surface of apparatus body 100.

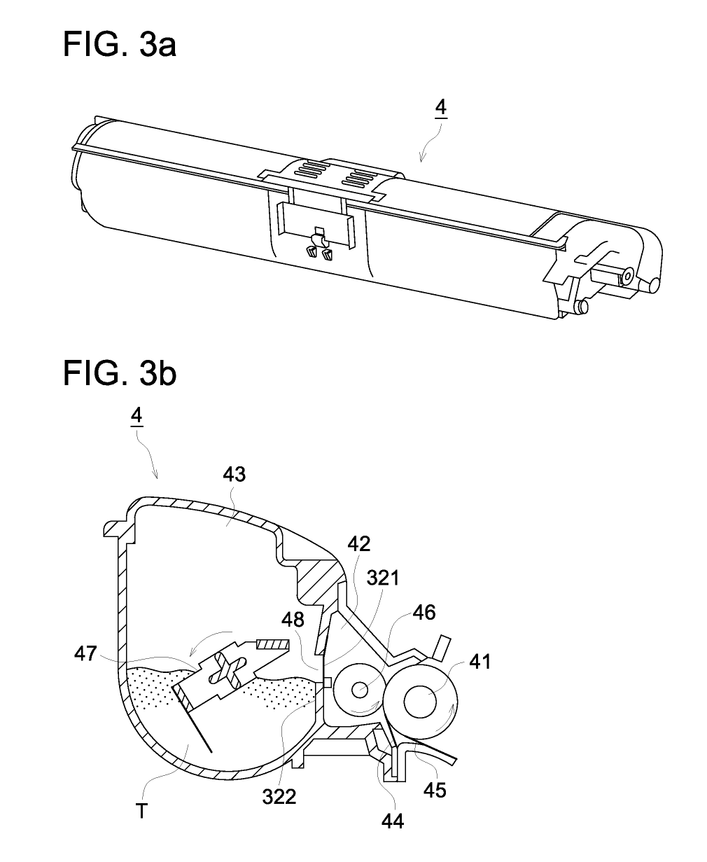

The image forming apparatus of FIG. 2 performs image formation with loading an exchangeable development device 4. A development device 4 shown in FIG. 3a, which is usually also called a toner cartridge, contains a prescribed amount of a toner within it where parts such as a developing roller are disposed. A development device, supplied in a cartridge form is mounted at a prescribed position within the image forming apparatus and supplies the contained developer to the photoreceptor drum to perform development. When no more developer remains after performing image formation of prescribed sheets, the cartridge is detached from the device and a new cartridge is loaded.

FIG. 3b illustrates a sectional view of the development device 4. Hereinafter, the development device 4 is also denoted as a toner cartridge 4. The toner cartridge 4 is provided with a buffer chamber 42 adjacent to a development roller 41 and a hopper 43 adjacent to the buffer chamber 42.

The development roller 41 is comprised of a conductive cylindrical substrate and an elastic layer formed of a hard material such as silicone rubber on the periphery of the substrate.

In the buffer chamber 42 is disposed a blade 44 as a toner controlling member with being pressed to the development roller 41. The blade 44 controls the electrostatic charge and the amount of toner applied onto the development roller 41. An auxiliary blade 45 to control the electrostatic charge and the amount of toner applied onto the development roller 41 may be provided downstream of the blade 41 with respect to the rotation of the development roller 41.

The development roller 41 is pressed against a feed roller 46. The feed roller 46 is rotated by a motor in the same direction as the development roller 41 (counterclockwise). The feed roller 46 is provided with an electrically conductive cylindrical substrate and a foamed layer formed of an urethane foam or the like on the periphery of the substrate.

A hopper 43 houses a toner T as a single-component developer. The hopper 43 is provided with a rotor 47 to stirring the toner. The rotor 47 is provided with a film-form conveyance blade to convey toner by rotation of the rotor 47 in the arrowed direction. The toner fed by the conveyance blade is fed into the buffer chamber 42 through passage 44 provided in the wall separating the hopper 43 from the buffer chamber 42. The shape of the conveyance blade is formed so that the blade bends while conveying the toner at the front in the rotation direction of the blade according to the rotation of the rotor 47 and returned to the straight state when reaching the left-side end of the passage 48. Thus, the blade feeds the toner to the pass 48 by allowing its shape to be returned straight via the bent state.

There is provided a valve 321 in the passage 48 to close the passage 48. The valve is a film-form member and one end of the valve is fixed at the upper right-hand side of the pass 48 and when the toner is fed from the hopper 43 to the pass 48, the valve is pressed to the right side by the pressure of the toner to open the passage 48. As a result, the toner is fed into the buffer chamber 42.

Further, a control member 322 is provided at the other end of the valve 321. The feed roller 46 is disposed so that the valve 321 forms a slight opening even when the passage 48 is closed. The control member 322 can be adjusted so that toner is not excessively accumulated at the bottom of the buffer chamber 42. It is so controlled that a toner which is recovered to the feed roller 46 from the development roller 41 does not fall in a large amount to the bottom.

In the toner cartridge 4, the development roller 41 rotates in the arrowed direction during image formation, while toner in the buffer chamber 42 is fed onto the development roller 41 through rotation of the feed roller 46. The toner fed onto the development roller 41 is electrically charged and thin-layered by the blade 44 and the auxiliary blade 45 and is then conveyed to the region opposed to the image bearing body, whereby the latent image on the image bearing body is subjected to development. A toner unused in development is returned to the buffer chamber 42 through rotation of the development roller 41 and is scraped off from the development roller 41 by the feed roller 46 to recover the toner.

The toner of the present invention causes no variation in crystal structure of a colorant contained in the toner at a heating temperature at the time of fixing in the prior art and stably color-reproducible toner images can be obtained in a conventional fixing device. Recently, there has been a trend of reduced energy consumption of an image forming apparatus in concern of the global environment. Specifically, a designed reduction of energy consumption in the fixing stage has been noted and there have been introduced techniques of fixing a toner images at a lower temperature than conventionally, corresponding to so-called low-temperature fixing.

When employing the toner of the present invention as a toner corresponding to low-temperature fixing, the surface temperature of a heating member in a fixing device is preferably controlled to less than 140° C., and more preferably to less than 130° C.

Under the above temperature, it is required to achieve an efficient supply of heat from the heating member to a transfer sheet, so that fixing by using a heat-resistant belt in either a heating member or a pressing member, so-called belt-fixing is preferred.

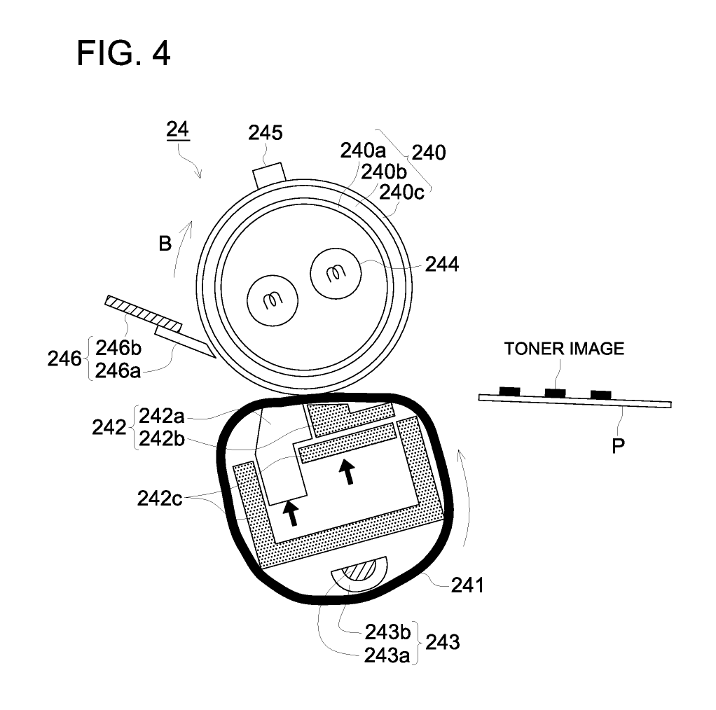

FIG. 4 illustrates a fixing device of a belt-fixing system (using a belt and a heating roller) capable of fixing the toner of the present invention.

A fixing device 24 is a type of using a belt and a heating roller to create a nip, which is mainly formed of a fixing roller 240, a seamless belt 241, a pressure pad 242a (pressure member) and a pressure pad 242b (pressure member), and a lubricant-supplying member 243.

The fixing roller 240 is formed of a heat-resistant elastic layer 240b and a releasing layer 240c (heat-resistant resin layer) around a metal core 240a (cylindrical cored bar) and a halogen lamp 244 as a heating source is disposed inside the core 240a. The surface temperature of the fixing roller 240 is measured by a temperature sensor 245 and based on the measured signals, the halogen lamp 244 is feedback-controlled by a temperature controller not shown here, whereby the surface of the fixing roller 240 is controlled to a constant temperature. The seamless belt 241 is in contact with the fixing roller 240 so as to be wound at a prescribed angle and forms a nip.

Inside the seamless belt 241, a pressure pad 242 having a low-frictional surface layer is disposed with being pressed to the fixing roller 240 through the seamless belt 241. The pressure pad 242 is provided with the pressure pad 242a to which a high pressure is applied and the pressure pad 242b to which a low pressure is applied and is held by a metal holder 242c.

The holder 242c is fitted with a belt traveling guide so that the seamless belt 241 slides smoothly. The belt traveling guide, which rubs against the inside surface of the seamless belt 241, is preferably a member exhibiting a low friction coefficient and is also preferably low heat-conductive one to make it difficult to conduct heat away from the seamless belt 241. Examples of a material for the seamless belt 241 include a polyimide.

A toner image formed of the toner of the present invention is finally transferred to a transfer material P and fixed on the transfer material to perform image formation. Transfer material P, which is a support to hold the toner image, is usually called an image support, a recording material or transfer paper. Specific examples thereof include plain paper and fine-quality paper including light and heavy paper, coated printing paper such as art paper or coated paper, commercially available Japanese paper or postcard paper, plastic film used for OHP and fabric, however, the present invention is not limited thereto.

### EXAMPLES

Embodiments carried out in the present invention will be concretely explained below using examples, however, the present invention is not limited thereto.

### Example 1

### 1. Preparation of Toners of the Present Invention

### 1-1. Preparation of Toner 1 (Kneading•Grinding Method)

The toner constitution described below was placed in a HENSCHEL MIXER (produced Mitsui-Miike Kogyo Co., Ltd.) and mixed with stirring at a blade-circumferential speed of 25 msec for 5 min.

| | |
|---|---|
| Polyester resin | 100 mass parts |
| (condensation product of bisphenol A/ethylene oxide | |
| adduct, terephthalic acid and trimeritic acid, weight | |
| average molecular weight of 20,000) | |
| Colorant (a compound represented by Formula (1) and | shown in Table 1 |
| a compound simultaneously used) | |
| Silanol compound | 0.05 mass part |
| Releasing agent (pentaerythritol tetrastearate) | 6 mass parts |
| Charge controlling agent (boron dibenzylic acid) | 1 mass part |

The mixture was kneaded by a biaxial extrusion kneader, roughly ground by a hammer mill, further ground by a turbo-mill (produced by TURBO KOGYO Co., Ltd.) and was subjected to a fine powder classification treatment by an air classifier employing Coanda effect to obtain colored particles having a volume-based median diameter of 5.5 μm.

Next, to the foregoing colored particles were added external additives described below and subjected to an external treatment in a Henschel mixer to obtain Toner 1.

| | |
|---|---|
| Hexamethylsilane-treated silica (average primary | 0.6 mass part |
| particle size of 12 nm) | |
| n-Octylsilane-treated titanium oxide (average primary | 0.8 mass part |
| particle size of 24 nm) | |

The external treatment in HENSCHEL MIXER was conducted under conditions of a stirring blade circumferential speed of 35 m/sec, a treatment temperature of 35° C. and a treatment time of 15 min.

### 1-2. Preparation of Toners 2-22 (Emulsion Coagulation Method)

### (1) Preparation of Colorant Microparticle Dispersion:

Eleven point five parts by mass of sodium n-dodecylsulfate was placed in 160 parts by mass of deionized water and dissolved with stirring to prepare an aqueous surfactant solution. This aqueous surfactant solution was gradually added with a colorant (a compound represented by Formula (1) and a compound simultaneously used) in the amount listed in Toner No. 2 in Table 1, further gradually added with 0.05 mass part of a silanol compound, and dispersed by using CLEAR MIX W-motion CLM-0.8 (produced by M Technique Co.) to obtain colorant microparticle dispersion 1.

Colorant microparticle 1 contained in the colorant microparticle dispersion 1 exhibited a volume-based median diameter of 98 nm. The volume-based median diameter was measured by using MICROTRAC UPA-150 (produced by HONEYWELL Corp.) under the following condition:

Sample refraction index: 1.59

Sample specific gravity: 1.05 (equivalent converted to spherical particle)

Solvent refraction index: 1.33

Solvent viscosity: 0.797 (30° C.), 1.002 (20° C.)

Zero-point adjustment: prepared by adding deionized water to a measurement cell.

### (2) Preparation of Core Resin Particle 1:

Core resin particle 1 having a multilayer structure was prepared by the process of 1st polymerization, 2nd polymerization and 3rd polymerization steps.

### (a) 1st Polymerization:

Into a reaction vessel fitted with a stiffer, a temperature sensor, a condenser and a nitrogen gas-introducing device was added 4 parts by mass of anionic surfactant (Formula 1) together with 3040 parts by mass of deionized water to prepare an aqueous surfactant solution.

C₁₀H₂₁(OCH₂CH₂)₂SO₃Na Formula 1:

To the foregoing aqueous surfactant solution was added a polymerization initiator solution of 10 parts by weight of potassium persulfate (KPS) dissolved in 400 parts by weight of deionized water and after the temperature was raised to 75° C., a mixed monomer solution comprised of the following compounds was dropwise added to the reaction vessel in 1 hr.

| | |
|---|---|
| Styrene | 532 mass parts |
| n-Butyl acrylate | 200 mass parts |
| Methacrylic acid | 68 mass parts |
| n-Octylmercaptane | 16.4 mass parts |

After completing addition of the foregoing monomer solution, the reaction mixture was heated with stirring at 75° C. for 2 hrs. to undergo polymerization (1st polymerization) to obtain resin particles. The obtained resin particles were designated as particulate resin A1. The weight-average molecular weight of the particulate resin A1 was 16,500.

### (b) 2nd Polymerization:

To a flask fitted with a stirrer was added a mixed monomer solution of compounds describe below and subsequently, 93.8 parts by weight of paraffin wax HNP-57 (produced Nippon Seiro Co., Ltd) as a releasing agent was added and dissolved with heating at 90° C. to prepare a monomer solution.

| | |
|---|---|
| Styrene | 101.1 mass parts |
| n-Butyl acrylate | 62.1 mass parts |
| Methacrylic acid | 12.3 mass parts |
| n-Octylmercaptane | 1.75 mass parts |

An aqueous surfactant solution was prepared by dissolving 3 parts by mass of the foregoing anionic surfactant in 1560 parts by mass of deionized water and heated at 98° C. To this aqueous surfactant solution was added the foregoing particulate resin A1 in an amount of 32.8 parts by mass (equivalent converted to solids), and the paraffin wax-containing monomer solution described above was added and was dispersed for 8 hrs. using a mechanical stirrer having a circulation pass, CLEARMIX (produced by M Technique Co.). There was thus prepared an emulsified particle dispersion comprised of emulsion particles having a dispersion particle size of 340 nm.

Subsequently, to the foregoing emulsified particle dispersion was added a polymerization initiator solution of 6 parts by mass of potassium persulfate dissolved in 200 parts by mass of deionized water. This reaction mixture was heated at 98° C. for 12 hrs. to undergo polymerization (2nd polymerization) to prepare resin particles. The thus prepared resin particles were designated as particulate resin A2. The weight-average molecular weight of the particulate resin A2 was 23,000.

### (c) 3rd Polymerization:

To the particulate resin A2 obtained in the 2nd polymerization step was added a polymerization initiator solution of 5.45 parts by mass of potassium persulfate dissolved in 220 parts by mass of deionized water and a mixed monomer solution composed of the following compounds was dropwise added to the reaction vessel at 80° C. in 1 hr.

| | |
|---|---|
| Styrene | 293.8 mass parts |
| n-Butyl acrylate | 154.1 mass parts |
| n-Octylmercaptane | 7.08 mass parts |

After completing addition, the reaction mixture was heated with stirring for 2 hrs. to undergo polymerization (3rd polymerization). After completing polymerization, the reaction mixture was cooled to 28° C. to obtain core resin particle 1. The weight-average molecular weight of the core resin particle 1 was 26,800.

### (3) Preparation of Shell Resin Particle:

Shell resin particle 1 was prepared similarly to the foregoing core resin particle 1, provided that the composition of the monomer solution used in the 1st polymerization step was changed as below.

| | |
|---|---|
| Styrene | 624 mass parts |
| 2-Ethylhexyl acrylate | 120 mass parts |
| Methacrylic acid | 56 mss parts |
| n-Octylmercaptane | 16.4 mass parts |

### Preparation of Toner 2

Toner 2 was prepared in the following manner.

### (a) Formation of Core:

Into a reaction vessel fitted with a stirrer, a temperature sensor, a condenser and a nitrogen gas introducing device was placed the following composition:

| | |
|---|---|
| Core resin particle | 420.7 mass parts |
| (equivalent converted to solid) | |
| Deionized water | 900 mass parts |
| Colorant particle dispersion 1 | 200 mass parts |

The interior of the reaction vessel was adjusted to 30° C. and the pH was adjusted to 8-11 with an aqueous 5 mol/L sodium hydroxide solution.

Subsequently, further thereto, an aqueous solution of 2 parts by mass of magnesium chloride hexahydrate dissolved in 1000 parts by weight of deionized water was added at 30° C. for 10 min. After allowed to stand for 3 min., the mixture was heated to 65° C. in 60 min. to perform coagulation. Using Multisizer 3 (Coulter Co.), the dispersion was measured as such with respect to coagulated particle size and when coagulated particles reached a volume-based median diameter of 5.5 μm, there was added an aqueous solution of 40.2 parts by mass of sodium chloride dissolved in 1000 parts by mass of deionized water to terminate coagulation.

After terminating coagulation, ripening was conducted at 70° C. for 1 hr. to allow fusion to continue, whereby core 1 was prepared.

The average circularity of the core 1, which was measured by FPIA 2000 (produced by Sysmex Co.), was 0.912.

### (b) Formation of Shell:

Next, to the foregoing solution maintained at 65° C. was added 96 parts by mass of shell resin particle 1. Further thereto, an aqueous solution of 2 parts by mass of magnesium chloride hexahydrate dissolved in 1000 parts by mass of deionized water was added in 10 min. and the reaction mixture was heated to 70° C. and stirred for 1 hr. Thus, the shell resin particle 1 was melted onto the surface of the core 1 and ripening was carried out at 75° C. for 20 min to form a shell.

Thereafter was added an aqueous solution of 40.2 parts by mass of sodium chloride dissolved in 1000 parts by mass to terminate shell formation. The reaction mixture was cooled to 30° C. at a cooling rate of 8° C./min. The colored particles thus formed were filtered off and repeatedly washed with deionized water of 45° C., and dried with hot air of 40° C. to prepare colored particle 2 having a shell on the core surface.

### (c) External Additive Treatment:

The colored particle 2 was added with the following external additives and subjected to an external treatment with stirring in a Henschel mixer to prepare toner 2.

| | |
|---|---|
| Hexamethylsilane-treated silica (average | 0.6 mass parts |
| primary particle size of 12 nm) | |
| n-Octylsilane-treated titanium oxide | 0.8 mass parts |
| (average primary particle size of 24 nm) | |

The external treatment in a Henschel mixer was conducted under conditions of a stirring blade circumferential speed of 35 m/sec, a treatment temperature of 35° C. and a treatment time of 15 min.

### Preparation of Toners 3-19

Toners 3-19 were prepared similarly to the toner 2, except that the colorant (a compound represented by Formula (1) and a compound simultaneously used) was replaced with colorants shown in Toner Nos. 3-19 in Table 1.

Preparation of Toners 20-22 (Preparation of comparative toners)

Tone's 20-22 were prepared similarly to the toner 2, except that the colorant (a compound represented by Formula (1) and a compound simultaneously used) was replaced with colorants shown in Toner Nos. 20-22 in Table 1.

### 1-3. Preparation of Yellow, Magenta, and Black Toners

1-3a. Preparation of Yellow Toner

A yellow toner was prepared similarly to the toner 2, except that the colorant was replaced with C. I. Pigment yellow 74.

1-3b. Preparation of Magenta Toner

A magenta toner was prepared similarly to the toner 2, except that the colorant was replaced with C. I. Pigment red 122.

1-3c. Preparation of Black Toner

A black toner was prepared similarly to the toner 2, except that the colorant was replaced with a carbon black MOGUL L (produced by Cabot Corp.).

### 1-4. Preparation of Developers

Each of the toners 1-22, and yellow, magenta, and black toners was mixed with ferrite carrier particles having silicone covered and exhibiting a volume average particle size of 60 um to prepare developers 1-22, and yellow developer, magenta developer, and black developer, each having a toner content of 6%.

TABLE 1

| | Compound | | | | Simultaneously used compound | | | | Manu- | |
|---|---|---|---|---|---|---|---|---|---|---|
| | represented | | | | Simulta- | | Simulta- | | facturing | |
| Toner | by Formula | Using ratio | Comparative | Using ratio | neously used | Using ratio | neously used | Using ratio | method | |
| No. | (1) | (mass parts) | compound | (mass parts) | compound-1 | (mass parts) | compound-2 | (mass parts) | of toner | Remarks |
| 1 | 1-1 | 4.0 | — | — | Sa-1/3-21 | 1.2 | Sc-1 | 0.8 | *1 | Inv. |
| 2 | 1-4 | 4.2 | — | — | Sb-8/3-24 | 1.1 | Sc-33 | 0.7 | *2 | Inv. |
| 3 | 1-22 | 3.9 | — | — | Sa-80 | 0.9 | Sb-100/3-17 | 1.2 | *2 | Inv. |
| 4 | 1-32 | 4.1 | — | — | Sc-71 | 0.9 | Sa-23/3-16 | 1.0 | *2 | Inv. |
| 5 | 1-42 | 3.8 | — | — | Sa-1/3-21 | 1.2 | Sa-23/3-16 | 1.0 | *2 | Inv. |
| 6 | 1-55 | 3.7 | — | — | Sa-23/3-18 | 1.3 | Sc-49 | 1.0 | *2 | Inv. |
| 7 | 1-1 | 4.0 | — | — | Sa-1/3-21 | 1.2 | Sc-1 | 0.8 | *2 | Inv. |
| 8 | 1-1 | 4.0 | — | — | Sa-26/3-16 | 1.2 | Ad-1 | 0.8 | *2 | Inv. |
| 9 | 1-1 | 4.0 | — | — | Sb-61/3-23 | 1.1 | Sa-26/3-18 | 0.9 | *2 | Inv. |
| 10 | 1-1 | 4.0 | — | — | Sc-1 | 1.0 | Ad-14 | 1.0 | *2 | Inv. |
| 11 | 1-57 | 3.0 | — | — | Sa-1/3-21 | 1.5 | Se-1 | 1.5 | *2 | Inv. |
| 12 | 1-57 | 4.8 | — | — | Sa-1/3-21 | 0.9 | Se-1 | 0.3 | *2 | Inv. |
| 13 | 1-4 | 4.8 | — | — | Sc-1 | 1.2 | — | — | *2 | Inv. |
| 14 | 1-60 | 4.0 | — | — | Sa-23/3-18 | 1.1 | Sb-55/3-20 | 0.9 | *2 | Inv. |
| 15 | 1-68 | 4.1 | — | — | Sb-9/3-26 | 1.1 | Se-61 | 0.8 | *2 | Inv. |
| 16 | 1-74 | 4.2 | — | — | Sa-1/3-21 | 1.1 | Ad-14 | 0.7 | *2 | Inv. |
| 17 | 1-81 | 3.9 | — | — | Ad-30 | 1.2 | Sc-1 | 0.9 | *2 | Inv. |
| 18 | 1-57 | 1.5 | — | — | Sa-26/3-16 | 1.2 | Ad-1 | 0.8 | *2 | Comp. |
| 19 | 1-1 | 6.0 | — | — | — | — | — | — | *2 | Comp. |
| 20 | — | 0.0 | Comparative | 4.0 | Sa-1/3-21 | 1.2 | Sc-1 | 0.8 | *2 | Comp. |
| | | | compound-1 | | | | | | | |
| 21 | — | 0.0 | Comparative | 4.0 | Sa-1/3-21 | 1.2 | Sc-1 | 0.8 | *2 | Comp. |
| | | | compound-2 | | | | | | | |
| 22 | — | 0.0 | Comparative | 4.0 | Sa-1/3-21 | 1.2 | Sc-1 | 0.8 | *2 | Comp. |
| | | | compound-3 | | | | | | | |

*1: Grinding method,
*2: Polymerizing method,
Inv.: Inventive example,
Comp.: Comparative example

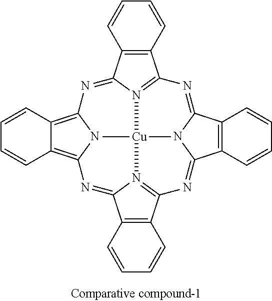

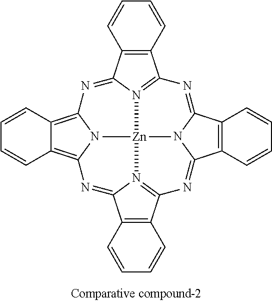

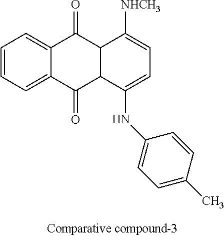

### 2. Evaluation Experiment

Evaluation was carried out by installing, into a commercially available hybrid printer “bizhub Pro C500 (made by Konica Minolta Business Technologies Inc.)” corresponding to a two-component developing type image forming apparatus as shown in FIG. 1, developing devices loaded with each developer.

Also, a belt fixing type fixing device as shown in FIG. 4 was installed to carry out evaluation. Each condition of for example, the surface material of the heating roller and the heating temperature in the aforementioned belt fixing type developing device were set as follows.

Fixing speed: 230 mm/sec

Surface material of heating roller: Polytetrafluoroethylene (PTFE)

Surface temperature of heating roller: 125° C.

Evaluation was carried out on the following items listed below under an environment of a normal temperature and a normal humidity (25° C. and 55% RH) by loading the above prepared toners in turn in the aforementioned evaluation apparatus.

Printing was carried out so that a half-tone image of an image density of 0.4, a white solid image, a black solid image of an image density of 0.8 and a thin line image were formed in each quarter of an A4 size print sheet, under an environment of a normal temperature and a normal humidity (25° C. and 55% RH).

### (Waveform of Cyan Toner)

Using a cyan monochromatic image on the print sheet, a maximum absorption wavelength (λmax), a maximum density (Dm), an image density at 570 nm (D₍₅₇₀₎), and an image density at 530 nm (D₍₅₃₀₎) were measure by using a spectrophotometer CM-700d (produced by Konica Minolta, Inc.).

Also, a ratio was calculated from the values of (D₍₅₇₀₎ and (D₍₅₃₀₎). The results were shown in Table 2.

TABLE 2

| Toner | | | | | |
|---|---|---|---|---|---|
| No. | λmax (nm) | Dm | D₍₅₇₀₎ | D₍₅₇₀₎/D₍₅₃₀₎ | Remarks |
| 1 | 629 | 1.52 | 0.59 | 9.83 | Inventive example |
| 2 | 614 | 1.73 | 0.74 | 10.57 | Inventive example |
| 3 | 625 | 1.84 | 0.67 | 9.52 | Inventive example |
| 4 | 612 | 1.53 | 0.55 | 7.91 | Inventive example |
| 5 | 614 | 1.92 | 0.70 | 9.93 | Inventive example |
| 6 | 610 | 1.51 | 0.55 | 7.81 | Inventive example |
| 7 | 625 | 1.62 | 0.59 | 8.38 | Inventive example |
| 8 | 614 | 1.79 | 0.65 | 9.26 | Inventive example |
| 9 | 622 | 1.64 | 0.59 | 9.72 | Inventive example |
| 10 | 614 | 1.54 | 0.56 | 7.96 | Inventive example |
| 11 | 618 | 1.42 | 0.55 | 7.85 | Inventive example |
| 12 | 619 | 2.21 | 0.80 | 11.43 | Inventive example |
| 13 | 617 | 1.84 | 0.66 | 9.43 | Inventive example |
| 14 | 613 | 1.57 | 0.57 | 8.12 | Inventive example |
| 15 | 629 | 1.64 | 0.59 | 8.48 | Inventive example |
| 16 | 626 | 1.82 | 0.66 | 9.41 | Inventive example |
| 17 | 613 | 1.46 | 0.56 | 7.55 | Inventive example |
| 18 | 610 | 1.18 | 0.43 | 3.72 | Comparative example |
| 19 | 630 | 1.09 | 0.79 | 2.46 | Comparative example |
| 20 | 635 | 0.85 | 0.52 | 3.48 | Comparative example |
| 21 | 653 | 0.87 | 0.48 | 3.25 | Comparative example |
| 22 | 640 | 0.76 | 0.48 | 2.87 | Comparative example |

As is clearly shown in Table 2, a preferable waveform can be obtained by the electrophotographic toner of the present invention, which is important for improvement in color reproducibility.

### <Evaluation of Image>

Reflection images (images on a paper sheet) were formed employing a toner set containing color toners of the present invention using the aforementioned image forming apparatus, and evaluation was carried out according to the method shown below. The adhered amount of the toner was in the range of 0.7±0.05 (mg/cm²) in the evaluation.

### (Evaluation of Chroma of Cyan Toner)

Using toner sets containing a cyan toner of the present invention and a comparative toner, solid images of maximum chroma having a hue angle of 240° in the CIELAB color space and luminosity values of 30, 40 and 50. An image formed by using a comparative toner (namely, toner 19) without using a cyan toner was used as a standard.

A: Improvement in chroma is 20% or more.

B: Improvement in chroma is 15% or more but less than 20%.

C: Improvement in chroma is 10% or more but less than 15%.

D: Improvement in chroma is less than 10%.

### (Evaluation of Color Gamut)

Using each solid image of yellow/magenta/cyan monochrome and R/G/B, enlargement of area was confirmed by measuring the color gamut, in which the area was compared while setting the color gamut of Japan color for printing to 100. The evaluation criteria were, A: area was enlarged by 10% or more, B: area was enlarged by 5-10%, C: area was enlarged by less than 5%, and D: area was not enlarged.

### <Storage Property of Image>

### (Light Resistance)

An image used for the evaluation of chroma of a cyan toner was irradiated with a xenon fade meter for 7 days, followed by evaluating variation of hue of mixed color image before and after the irradiation. The variation of hue was evaluated visually by ten persons on a ten-point scale. The evaluation criteria were as follows. A: the average point of the ten persons was 9-10, B: the average point of the ten persons was 9-8, C: the average point of the ten persons was 8-7, and D: the average point of the ten persons was less than 7. Above A and B meet the sufficiently acceptable level for practical use.

### (Ozone Resistance)

A mixed color image was exposed to ozone for 7 days under a condition of an ozone gas concentration of 5 ppm (25° C. and 60% RH), followed by evaluating variation of hue of the mixed color image before and after ozone exposure. The variation of hue was evaluated visually by ten persons on a ten-point scale. The evaluation criteria were as follows. A: the average point of the ten persons was 9-10, B: the average point of the ten persons was 9-8, C: the average point of the ten persons was 8-7, and D: the average point of the ten persons was less than 7.

### <Transparency>

A transparent image of orange color was formed on a commercially available OHP sheet (made of a polyester film having a thickness of 75 μm) and visible light spectral transmittance was evaluated using “330 type recording spectrophotometer (produced by Hitachi Ltd.)”. Namely, visible light spectral transmittance of the fixed image was measured. Using an OHP sheet on which no toner image was formed was used as a reference, and the difference in spectral transmittance at 590 nm was measured. Thus, the transparency of the OHP image was evaluated. The adhered amount of toner on the OHP sheet was adjusted to be 0.7±0.05 (mg/cm²) in the evaluation.

A: Transmittance is 85% or more.

B: Transparency is 80% or more but less than 85%.

C: Transparency is less than 80%.

When the transparency was evaluated to be high when it is 80% or more.

The results were shown in Table 3.

TABLE 3

| | | | | Color | Storage stability of image | | | |
|---|---|---|---|---|---|---|---|---|
| | | | | reproducibility | Colorant | | | |
| Toner | Evaluation of chroma | | | Evaluation of | remaining | Ozone | | |
| No. | Luminosity 30 | Luminosity 40 | Luminosity 50 | color gamut | ratio | resistance | Transparency | Remarks |
| 1 | B | A | A | B | B | B | B | Inventive example |
| 2 | A | A | A | B | A | A | B | Inventive example |
| 3 | B | A | B | B | B | B | B | Inventive example |
| 4 | A | A | A | A | A | A | B | Inventive example |
| 5 | B | B | B | B | B | B | B | Inventive example |
| 6 | B | A | A | A | B | B | B | Inventive example |
| 7 | A | A | A | A | A | A | A | Inventive example |
| 8 | B | B | A | B | A | A | A | Inventive example |
| 9 | B | A | A | A | A | A | A | Inventive example |
| 10 | B | A | A | A | A | A | A | Inventive example |
| 11 | A | A | A | A | A | A | A | Inventive example |
| 12 | A | A | A | A | A | A | A | Inventive example |
| 13 | B | B | A | B | A | A | B | Inventive example |
| 14 | B | A | A | A | A | A | A | Inventive example |
| 15 | A | A | A | A | A | A | A | Inventive example |
| 16 | B | B | A | A | A | A | A | Inventive example |
| 17 | B | A | A | B | B | A | B | Inventive example |
| 18 | C | C | C | C | B | B | B | Comparative example |
| 19 | D | D | D | C | B | B | B | Comparative example |
| 20 | D | C | C | C | B | B | C | Comparative example |
| 21 | D | D | C | C | B | B | C | Comparative example |
| 22 | D | D | D | C | B | B | C | Comparative example |

As is clearly shown in Table 3, it is understood that, when the electrophotographic toner of the present invention was used, excellent color reproducibility, light resistance and ozone resistance were obtained when each color toner was mixed, and, further, a color reproducing range was enlarged and transparency was improved.

### EXPLANATION OF NUMERALS

1 Photoreceptor (Photoreceptor drum)
4 Developing equipment (Toner cartridge)
6 Cleaning device
7 Intermediate transfer belt
10 Image formation part
24 Fixing device
240 Heating roller
241 Pressurizing belt (seamless belt)
P Transfer material (recording material)

1. An electrophotographic toner, wherein, when a monochromatic image of the electrophotographic toner is formed on a substrate and a reflection absorption spectrum thereof is measured,
the reflection absorption spectrum shows a maximum density within the range of 600-700 nm, and
a maximum density of the reflection absorption spectrum (Dm), a density thereof at 570 nm (D₍₅₇₀₎) and a density thereof at 530 nm (D₍₅₃₀₎) meet the following conditions, Dm, D₍₅₇₀₎ and D₍₅₃₀₎ each being determined by excluding light absorption of the substrate,
1.4≦Dm≦3.5
D₍₅₇₀₎≧0.55
4.5≦D₍₅₇₀₎/D₍₅₃₀₎≦12.

2. The electrophotographic toner of claim 1 comprising a silicon phthalocyanine compound as a colorant.

3. The electrophotographic toner of claim 2, wherein the silicon phthalocyanine compound is a compound represented by Formula (1), 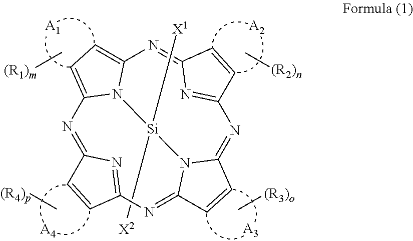
(In the formula, A₁, A₂, A₃ and A₄ each independently represent a 5-6 membered aromatic ring or a 5-6 membered heterocycle. R₁, R₂, R₃ and R₄ each independently represent a hydrogen atom, a halogen atom, an alkyl group, an alkenyl group, an alkynyl group, an aryl group, a heterocycle group, an acyl group, an alkoxycarbonyl group, an aryloxycarbonyl group, a carbamoyl group, a carboxy group or a salt thereof, a sulfonyl carbamoyl group, an acylcarbamoyl group, a sulfamoylcarbamoyl group, a carbazoyl group, an oxalyl group, an oxamoyl group, a cyano group, a thiocarbamoyl group, a hydroxy group, an alkoxy group, an aryl oxy group, a heterocycleoxy group, an acyloxy group, a carbonyloxy group, a carbamoyloxy group, a sulfonyloxy group, an amino group, an amino group, an acylamino group, a sulfonamide group, an ureido group, a thioureido group, an imido group, a carbonylamino group, a sulfamoylamino group, a semicarbazide group, a thiosemicarbazide group, a hydrazino group, an ammonio group, an oxamoilamino group, a sulfonylureido group, an acylureido group, an acylsulfamoylamino group, a nitro group, a mercapto group, a thio group, a sulfonyl group, a sulfinyl group, a sulfo group or a salt thereof, a sulfamoyl group, an acylsulfamoyl group, a sulfonylsulfamoyl group and a salt thereof, or a group containing a phosphoric acid amide or a phosphoric acid ester structure. m, n, o and p each represent an integer of 1-4. X¹ and X² each independently represent an ether linkage, a halogen atom, a hydroxy group, an alkyl group, an alkynyl group, an alkoxy group, a siloxy group, an aryl group, an aryloxy group, an acyloxy group, a carbamoyloxy group, or a sulfamoyloxy group.

4. The electrophotographic toner of claim 2 comprising at least two colorants, wherein
one of the colorants is a silicon phthalocyanine compound represented by above Formula (1).

5. A toner set for electrophotography comprising the electrophotographic toner of claim 1.
